(19) United States
(12) Patent Application Publication
(10) Pub. No.: US 2005/0131757 A1
(43) Pub. Date: Jun. 16, 2005

(54) System for permission-based communication and exchange of information

(75) Inventors: Paul Augustine Chan, Sydney (AU); Fredrick Swaab, Sydney (AU)

Correspondence Address: BROOKS KUSHMAN P.C., 1000 TOWN CENTER, TWENTY-SECOND FLOOR, SOUTHFIELD, MI, 48075, US

(73) Assignee: Pureprofile. Com Inc, Wilmington New Castle County, DE (US)

(21) Appl. No.: 10/504,839

(22) PCT Filed: Feb. 19, 2003
(86) PCT No.: PCT/AU03/00203

(30) Foreign Application Priority Data
Feb. 19, 2002 (AU) PS 0632
Aug. 12, 2002 (AU) 2002950706

(51) Int. Cl. G06F 17/60

(52) U.S. Cl. 705/14

(57) ABSTRACT

A method and system for permission-based communication and exchange of information by means of a neutral and unified database in which consumers remain anonymous. The method involves receiving and storing consumer information corresponding to a number of individual consumers via a consumer information receiver, the consumer information including both consumer-identifying information and consumer profile information for each consumer. The method also involves receiving a profile information search request which specifies at least one consumer profile criterion. The method also involves searching the consumer database to identify selected records which match the consumer profile criterion in order to obtain a search result. The method also involves providing the search result to the requestor via a search result provider, and wherein the search result does not include any consumer-identifying information.

### FIELD OF THE INVENTION

The present invention relates to a system for permission-based communication and exchange of information and, in particular relates to a method and system for permission-based communication and exchange of information by means of a neutral and unified database in which the consumers remain anonymous.

### BACKGROUND

For many years, businesses have spent very large amounts of time and money on obtaining accurate data regarding consumer interest and spending patterns. Entire industries such as the market research and advertising industries have evolved to gauge and increase consumer interest in products and services offered by various businesses. Each year, billions of dollars are spent on market research and advertising in an attempt to effectively and efficiently market and sell products and services to customers.

In order to achieve targeted marketing and advertising and make improvements to the same, consumer interest and spending patterns had to be measured and analysed. The collection, analysis and interpretation of consumer data on a large scale first began in the 1950s when the earliest computers with the capacity to manage and assimilate huge amounts of consumer data were developed. However, consumer data was very difficult and expensive to collect and required the participation and cooperation of consumers on a non-anonymous basis. The collection and analysis of consumer data improved and customer lists based on demographics, spending patterns, and other information were generated, exchanged and sold by various businesses. Often this resulted in consumers being inundated and annoyed with advertising and marketing messages and even direct sales solicitations by phone, mail or other means. In addition, the statistical analyses of the data did not yield scientifically significant results that could be used to achieve more effective and efficient advertising and marketing.

With the development and increasing popularity of the internet and the explosion of computer usage throughout the world, it has been easier in order to obtain mass quantities of marketing and advertising data from a variety of consumers. It has also become easier to provide targeted marketing, advertising, coupons, sales or bonus offers, etc. directly to consumers. The consumers interaction with such marketing and advertising messages such as banner ads can be tracked in order to obtain data including click through rates, time spent on any given web page, whether consumers viewed all portions of a message and ultimately purchased, whether consumers responded to all questions asked including consumer profile information, etc. Based on this data, more targeted advertising and marketing information is provided to the consumer, for example, as described in U.S. Pat. No. 5,948,061.

However, the collection and use of such data and targeted advertising raises very series concerns about privacy and the usage or sale of such personal consumer data. In addition, such consumer data is often inaccurate or biased due to the method of collection of consumer data or the incentives offered consumers to provide opinions, comments and feedback concerning various products and advertising or marketing campaigns. Furthermore, many internet users and consumers have become habituated to the various internet and computer marketing and advertising messages such that these messages are ignored and become virtually useless.

For example, U.S. Pat. No. 5,855,008 describes a method of buying and selling the attention of consumers via the internet. Although the consumer may be able to control whether or not their particular information is released or sold, the consumers are paid to view advertisements presented via the internet, suggesting that the statistical reliability and accuracy of the data is poor because the user's motivation to view each advertisement or marketing message is only money. Also, the number of advertisements that a consumer must view with such methods is so great that the consumer quickly loses motivation to respond and participate with such processes.

The marketplace is currently witnessing a shift in power from the vendor to buyer. With a proliferation of products and services, the marketplace is moving away from product centric focus to one of customer centric. As a direct consequence a well documented business strategy has emerged that recognises the need to identify and understand the customer and their needs. It is a business strategy often referred to as Customer Relationship Management (CRM). It focuses on customer retention and leverages technologies and business processes to understand the customer, not as a broad demographic group but as individuals in theory, by learning more about customer behaviour, business is better able to more accurately target messages to individuals or individual accounts.

The reality however is that customers do not want to be managed, they do not want to have relationships with thousands of independent companies and they certainly do not want these business to hold vast amount of personal information on proprietary databases.

The above-described conventional methods have failed to provide a marketing tool for consumers to anonymously and effectively market themselves to businesses the consumers are interested in and manage relationships with businesses, without having to worry about privacy concerns or being overwhelmed by undesired marketing and advertising that are not relevant to the particular consumer's interests.

Furthermore, with the proliferation of internet search engines, a market has arisen in which advertisers pay to be listed as one of the first few websites listed in the search results produced for a particular “keyword.” Statistics show that most internet users do not look beyond the first three or four search results, and companies have begun to pay premium fees to be listed in these first few places. In most cases, the search engine earns its fee when a user clicks through to the advertiser's web site from the search engine site.

Although some advertisers are prepared to pay premium fees for these click-throughs, they do not know any information about the user visiting their site. They are unable to contact the user, receive feedback from the user about their site or product, or send other promotional information the user. The advertiser is therefore paying for the attention of an unknown person who may not be a member of the advertiser's optimum target market.

### DISCLOSURE OF INVENTION

In order to seek to overcome the problems described above, the inventors have implemented a model that empowers the consumer and allows consumers to control their relationships with individual businesses (Business Relationship Management). A neutral database where the system of the present invention acts as the intermediary and the honest broker, creating the framework for exchange. Consumers manage their own information and through a permissioning system, permit businesses and third parties to communicate and maintain a dialogue with them, in return for relevance and value.

In this way the preferred embodiments of present invention provide a method for effectively and efficiently capturing accurate consumer data that is statistically reliable and using the consumer data in a manner to provide increasingly targeted marketing and advertising information that is desired by consumers and businesses, while overcoming the privacy and intrusion concerns of consumers.

In addition, preferred embodiments of the present invention provide methods and systems for allowing consumers to anonymously and voluntarily market themselves to businesses in order to obtain only desired business solicitations in the form of advertising and marketing requests while allowing businesses to generate much more effective targeted marketing and advertising campaigns and pay only when results are achieved rather than paying and hoping results are achieved.

In addition, preferred embodiments of the present invention provide methods and systems for allowing consumers to voluntarily have the keywords they enter into search engines, automatically added to their profile. The present invention further allows businesses to target promotions to consumers based upon the keywords in their profile.

According to one aspect of the present invention there is disclosed a method for permission-based information exchange, the method comprising the steps of:
(a) receiving consumer information corresponding to a plurality of individual consumers via a consumer information receiver, the consumer information comprising both consumer-identifying information and consumer profile information for each consumer;
(b) storing the consumer-identifying information in consumer-identifying records in a consumer database;
(c) storing the consumer profile information in consumer profile records in the consumer database;
(d) receiving a profile information search request from a requestor via a search request receiver, wherein the search request specifies at least one consumer profile criterion;
(e) searching the consumer database to identify selected consumer profile records containing consumer profile information which match the consumer profile criterion in order to obtain a search result; and
(f) providing the search result to the requestor via a search result provider, wherein the search result does not include any consumer-identifying information.

Preferably, the selected consumer profile records each correspond to an individual selected consumer, and wherein the method further comprises the steps of:
(g) receiving promotional information from a promoter via a promotional information receiver; and
(h) providing the promotional information to the selected consumers via a promotional information provider;
wherein consumer-identifying information is not provided to the promoter.

Preferably, the method further comprises the steps of:
(i) receiving consumer response information corresponding to the promotional information via a consumer response receiver in order to obtain a response result; and
(j) providing the response result to the promoter via a response result provider, and wherein the response result does not contain any consumer-identifying information.

Preferably, each promoter has a promoter financial account and wherein the step of receiving promotional information from the promoter further comprises debiting the promoter financial account by a promotion fee.

Preferably, the promotion fee comprises either monetary or non-monetary consideration.

Preferably, each consumer has a consumer financial account and wherein the step of receiving consumer response information corresponding to the promotional information further comprises the steps of:
(i) identifying a consumer financial account corresponding to a received consumer response;
(ii) crediting that consumer financial account with a consumer response fee; and
(iii) repeating steps (i) and (ii) for each received consumer response.

Preferably, each promoter has a promoter financial account and wherein the step of receiving consumer response information corresponding to the promotional information further comprises the steps of:
(iv) identifying a promoter financial account corresponding to the promotional information; and
(v) debiting the promoter financial account by a promotion response fee.

Preferably, the consumer response fee comprises one or both of monetary and non-monetary consideration.

Preferably, the method further comprises the additional steps of:
(i) receiving a consumer-supplied redemption request for a value;
(ii) debiting the consumer financial account by the value; and
(iii) providing the value to a consumer-nominated destination.

Preferably, the consumer-nominated destination comprises one or more of:
(i) an SMS sending program;
(ii) a financial institution account;
(iii) a third-party goods/service provider;
(iv) a third-party goods/service voucher provider;
(v) a third-party cash provider;
(vi) an SMS sending program financial account;
(vii) a third-party goods/service provider financial account;
(viii) a third-party goods/service voucher provider financial account; or
(ix) a third-party cash provider financial account.

Preferably, one or more of the consumer information receiver, the promotional information provider and the consumer response receiver comprise one or more of:
(i) a consumer interface;
(ii) an email program;
(iii) a short message service (SMS) program;
(iv) an electronic data interchange (EDI) program;
(v) a wireless application protocol (WAP) program; or
(vi) other electronic information transmission means.

Preferably, the consumer information receiver is an EDI program taking the form of an application program which is adapted to receive third-party-supplied consumer profile information from third party application programs.

Preferably, the consumer interface performs the steps of:
(i) receiving consumer-identifying information from a consumer and storing that information in a consumer-identifying record; and
(iii) receiving consumer profile information from a consumer and storing that information in a consumer profile record.

Preferably, the consumer interface performs the step of receiving consumer-identifying information from a consumer by:
(a) displaying a consumer-identifying information questionnaire having a plurality of information receiving fields; and
(b) receiving the consumer-identifying information via the information receiving fields.

Preferably, the consumer interface performs the step of receiving the consumer profile information from a consumer by:
(a) displaying a first plurality of consumer profile questions each having a predetermined number of selectable answers; and
(b) receiving consumer-supplied selections of those selectable answers to form the consumer profile information.

Preferably, the consumer interface performs the further step of receiving updated consumer profile information from a consumer by:
(a) displaying a second plurality of consumer profile questions each having a predetermined number of selectable answers and wherein the second plurality of consumer profile questions differ from the first plurality of consumer profile questions; and
(b) receiving consumer-supplied selections of those selectable answers to form the updated consumer profile information.

Preferably, at least one of the first plurality of consumer profile questions has a relevance period and wherein the method comprises the additional step of seeking from a consumer replacement answers to those consumer profile questions for which the relevance period has expired.

Preferably, the consumer provides the consumer information either as an individual person or as a representative of a business.

Preferably, the consumer is a representative of a business and the consumer information is information relating to the identify, characteristics and preferences of the business.

Preferably, the consumer-identifying information comprises any information about an individual consumer whose identity is apparent, or can reasonably be ascertained, from the information or opinion.

Preferably, the consumer-identifying information comprises one or more of a consumer's:
(i) name;
(ii) address;
(iii) phone number,
(iv) fax number;
(v) email address;
(vi) workplace name;
(vii) date of birth; or
(viii) financial account information.

Preferably, the consumer profile information comprises any information relating to demographic, sociographic, lifestyle, financial, purchasing, returning and other characteristics or preferences of a consumer.

Preferably, the profile information comprises consumer-supplied profile information and third-party-supplied profile information.

Preferably, the consumer-supplied profile information comprises information relating to one or more of a consumer's
(a) gender;
(b) languages;
(c) purchasing habits;
(d) internet usage;
(e) telephone usage;
(f) accommodation type;
(g) shopping preferences;
(h) marital status;
(i) parental status;
(j) pet ownership status;
(k) vehicle ownership status;
(l) home ownership status;
(m) entertainment preferences;
(n) travel preferences;
(o) sports interests;
(p) investment; or
(q) employment status.

Preferably, the consumer profile information further comprises permission information and preference information.

Preferably, the permission information comprises information which defines one or more of:
(i) which items of consumer profile information a consumer is willing to make available to third parties;
(ii) consideration a consumer is willing to accept to make those items of consumer profile information available to third parties;
(iii) a frequency at which a consumer is willing to make those items of consumer profile information available to third parties; and
(iv) a period of time during which a consumer is willing to make those items of consumer profile information available to third parties.

Preferably, the preference information comprises information which defines one or more of:
(i) businesses or types of businesses the consumer is willing to receive promotional information from;
(ii) products, services or types of products or services the consumer is willing to receive promotional information about;
(iii) consideration a consumer is willing to accept to receive that promotional information;
(iv) consideration a consumer is willing to accept to respond to that promotional information;
(v) frequency at which a consumer is willing to receive that promotional information;
(vi) period of time during which a consumer is willing to receive that promotional information;
(vii) format in which a consumer is willing to receive that promotional information;
(viii) delivery channel by which a consumer is willing to receive that promotional information;
(ix) businesses or types of businesses the consumer is not willing to receive promotional information from; and
(x) products, services or types of products or services the consumer is not willing to receive promotional information about.

Preferably, the consumer-supplied profile information further comprises a relationship indicia.

Preferably, the relationship indicia comprises a relatively unique indicia which is associated with one or more of the following:
(i) a business;
(ii) a product;
(iii) a service;
(iv) a promotional campaign; and
(v) a consumer.

Preferably, the relationship indicia takes the form of a combination of a plurality of alphanumeric characters.

Preferably, the relationship indicia takes the form of a Pure Code as described herein.

Preferably, each relationship indicia is controlled by a particular business.

Preferably, the third-party-supplied profile information comprises information relating to one or more of a consumer's:
(a) credit score;
(b) credit card purchases;
(c) number of frequent flyer miles or redemptions;
(d) travel tickets purchased;
(e) web surfing activities;
(f) television watching habits;
(g) radio watching habits;
(h) newspaper reading habits;
(i) magazine watching habits;
(j) mobile phone usage;
(k) internet transactions;
(l) point of sale purchases;
(m) received and paid bills;
(n) retail point of sale (POS) transactions;
(o) loyalty card purchases;
(p) bank account information;
(q) share trading activities;
(r) superannuation fund information;
(s) mobile phone location;
(t) intelligence quotient (IQ) test results;
(u) personality test results;
(v) newsletters;
(w) resume information;
(x) internet purchasing behaviour; and
(y) keyword searches.

Preferably, the consumer database comprises either a single database or a plurality of databases.

Preferably, when the consumer database is a single database, the step of storing the consumer-identifying information in consumer-identifying records in the consumer database comprises storing the consumer-identifying information in a form which inhibits searching.

Preferably, the step of storing the consumer-identifying information in a form which inhibits searching comprises storing the consumer-identifying information in encrypted form.

Preferably, when the consumer database is a plurality of consumer databases the consumer databases are linked databases.

Preferably, each consumer-identifying record has a corresponding consumer profile record and wherein each corresponding pair of records stores a common consumer-identifying indicia which is unique to that consumer.

Preferably, one or more of the search request receiver, the search result provider, the promotional information receiver, and the response result information provider comprise one or more of:
(i) a business interface;
(ii) an email program;
(iii) a short message service (SMS) program;
(iv) an EDI program;
(v) a wireless application protocol (WAP) program; or
(vi) other electronic information transmission means.

Preferably, when the search request receiver comprises the business interface, the interface performs the step of receiving a profile information search request from a requestor by:
(a) displaying a plurality of selectable consumer profile criteria; and
(b) receiving requestor-supplied selections of those selectable criteria to form the profile information search request.

Preferably, at least some of the selectable consumer profile criteria correspond to the selectable answers to the consumer profile questions displayed by the consumer interface.

Preferably, the selectable consumer profile criteria corresponds to a relationship indicia controlled by the requestor.

Preferably, the search result comprises one or more of:
(i) the number of consumer profile records which matched the search request; and
(ii) the cost of sending promotional information to all of the consumers whose consumer profile records matched the search request.

Preferably, the promotional information comprises:
(i) displayable promotional information; and
(ii) at least one promotional question having at least one predetermined selectable promotional answer.

Preferably, the displayable promotional information comprises any one of:
(i) advertisement information;
(ii) business-supplied invoices;
(iii) business-supplied correspondence; and
(iv) any form of digitally displayable media.

Preferably, the advertisement information comprises one or more of:
(i) still images;
(ii) video clips;
(iii) audio grabs;
(iv) text; and
(v) numbers.

Preferably, the predetermined selectable promotional answers comprise the consumer response information corresponding to the promotional material.

Preferably, when the promotional information receiver comprises a business interface, the step of receiving promotional information from a promoter via the promotional information receiver comprises:
(i) displaying a promotional information receiving screen;
(ii) receiving promoter-supplied displayable promotional information;
(ii) receiving at least one promoter-supplied promotional question having at least one predetermined selectable promotional answer; and
(iv) storing the displayable promotional information and the at least one promotional question in a business database.

In one form, the steps performed by the requester are performed via a requestor representative.

In another form, the steps performed by the promoter are performed via a promoter representative.

According to another aspect of the present invention there is disclosed a system for permission-based communication and exchange of information comprising:
(a) a consumer information receiver adapted to:
   (i) receive consumer information from a plurality of individual consumers, the consumer information comprising both consumer-identifying information and consumer profile information for each consumer; and
   (ii) provide the consumer information to the consumer database;
(b) a consumer database adapted to:
   (i) receive the consumer-identifying information from the consumer information receiver and store the consumer-identifying information in consumer-identifying records; and
   (ii) receive the consumer profile information from the consumer information receiver and store the consumer profile information in consumer profile records; and
(c) a consumer database searcher adapted to:
   (i) receive a profile information search request from a requestor via a search request receiver, wherein the search request specifies at least one consumer profile criterion;
   (ii) search the consumer database to identify selected consumer profile records containing consumer profile information which match the search request in order to obtain a search result; and
   (iii) provide the search result to the requestor via the search result provider, wherein the search result does not include any consumer-identifying information.

Preferably, the selected consumer profile records each correspond to an individual selected consumer, and wherein the system further comprises:
(d) a promotional information receiver adapted to receive promotional information from a promoter; and
(e) a promotional information provider adapted to provide the promotional information to the selected consumers;
wherein the promotional information provider is further adapted not to provide consumer-identifying information to the promoter.

Preferably, the system further comprises:
(f) a consumer response receiver adapted to receive consumer response information corresponding to the promotional information and to generate a response result; and
(g) response result provider adapted to provide the response result to the promoter, wherein the response result does not contain any consumer-identifying information.

According to a further aspect of the present invention there is disclosed a method for conducting a transaction between an anonymous consumer and a business, the method comprising the steps of:
(a) receiving consumer information corresponding to a plurality of consumers via a consumer information receiver, the consumer information including consumer financial account information for at least one consumer;
(b) assigning a relatively unique consumer-identifying indicia to the consumer information;
(c) storing the consumer information and the consumer-identifying indicia in a consumer record in a consumer database;
(d) receiving a transaction request from a business via a transaction processor, the transaction request including a supplied consumer-identifying indicia;
(e) searching the consumer database to identify a selected consumer record storing a consumer-identifying indicia which matches the supplied consumer-identifying indicia;
(f) extracting consumer financial account information from the selected consumer record; and
(g) providing the consumer financial account information to the transaction processor whereupon the transaction processor performs the step of processing the transaction request, and wherein consumer-identifying information is not provided to the business.

According to an additional aspect of the present invention there is disclosed a method for permission-based information exchange using a search interface, an interface monitor and a consumer database, the search interface comprising a search result display and a search field adapted to receive one or more keywords, the consumer database comprising a plurality of consumer profile records adapted to store consumer profile information and the method comprising the steps of:
(a) providing the search interface to a new consumer;
(b) receiving a new keyword from the new consumer via the search field;
(c) displaying one or more search results together with a selectable region on the search result display, the selectable region being adapted to be selected by the new consumer;
(d) detecting, using the interface monitor, a selection by the new consumer of the selectable region;
(e) creating, in response to the selection of the selectable region, a new consumer profile record in the consumer database, the new consumer profile record being adapted to store at least the new keyword; and
(f) storing the new keyword in the new consumer profile record.

Preferably, the new consumer profile record is further adapted to store consumer profile information, and the method includes the additional steps of:
(g) receiving consumer profile information about the new consumer via a consumer information receiver; and
(h) storing the new consumer profile information in the new consumer profile record in the consumer database.

Preferably, the consumer database further comprises a plurality of consumer-identifying records corresponding to the plurality of consumer profile records and wherein the method includes the additional steps of:
(i) creating, in the consumer database, a new consumer-identifying record corresponding to the new consumer profile record;
(j) receiving new consumer-identifying information about the new consumer via the consumer information receiver; and
(k) storing the new consumer-identifying information in the new consumer-identifying record in the consumer database.

Preferably, the new consumer-identifying information comprises one or more of the consumer's:
(i) mobile phone number; and
(ii) email address.

Preferably, the method further comprises the additional steps of:
(l) monitoring the search interface, using the interface monitor, in order to detect when the consumer enters a further keyword in the search field of the search interface;
(m) receiving the further keyword from the consumer via the search field; and
(n) storing the further keyword in the new consumer profile record.

Preferably, the search interface comprises an interface of a search engine adapted to search information stored in a plurality of networked computers.

Preferably, the selectable region displayed on the search result display has the new keyword superimposed thereon.

Preferably, the selectable region displays an invitation.

Preferably, the invitation is adapted to invite the new consumer to do one or more of the following:
(1) be paid to receive messages about at least one of the new keyword and the further keyword; and
(2) provide personal information about the new consumer to the consumer database.

Preferably, the new keyword comprises one or more keywords.

Preferably, the selectable region displayed on the search result display comprises one or more of:
(i) one or more still images;
(ii) one or more moving images;
(iii) text;
(iv) hyperlinks; and
(v) numbers.

Preferably, the method further comprises the additional steps of:
(o) receiving a profile information search request from a requestor via a search request receiver, wherein the search request specifies at least one consumer profile criterion;
(p) searching the consumer profile records in the consumer database to identify selected consumer profile records containing consumer profile information which match the search request in order to obtain a search result; and
(q) providing the search result to the requester via a search result provider, wherein the search result does not include any consumer-identifying information.

Preferably, the consumer profile criterion includes a keyword criterion.

Preferably, the selected consumer profile records each correspond to an individual selected consumer, and wherein the method further comprises the steps of:
(r) receiving promotional information from a promoter via a promotional information receiver; and
(s) providing the promotional information to the selected consumers via a promotional information provider;
   wherein consumer-identifying information is not provided to the promoter.

Preferably, the method further comprises the steps of:
(t) receiving consumer response information corresponding to the promotional information via a consumer response receiver in order to obtain a response result; and
(u) providing the response result to the promoter via a response result provider, wherein the response result does not contain any consumer-identifying information.

Preferably, each promoter has a promoter financial account and wherein the step of receiving promotional information from the promoter further comprises debiting the promoter financial account by a promotion fee.

Preferably, the promotion fee comprises either monetary or non-monetary consideration.

Preferably, each consumer has a consumer financial account and wherein the step of receiving consumer response information corresponding to the promotional material further comprises the steps of:
(i) identifying a consumer financial account corresponding to a received consumer response;
(ii) crediting that consumer financial account with a consumer response fee; and
(iii) repeating steps (i) and (ii) for each received consumer response.

Preferably, the method further comprises the additional steps of:
(i) receiving a consumer-supplied redemption request for a value;
(ii) debiting the consumer financial account by the value; and
(iii) providing the value to a consumer-nominated destination.

Preferably, the consumer-nominated destination comprises one or more of:
(i) an SMS sending program;
(ii) a financial institution account;
(iii) a third-party goods/service provider;
(iv) a third-party goods/service voucher provider,
(v) a third-party cash provider;
(vi) an SMS sending program financial account;
(vii) a third-party goods/service provider financial account;
(viii) a third-party goods/service voucher provider financial account; or
(ix) a third-party cash provider financial account.

According to yet another aspect of the present invention there is disclosed a system for permission-based communication and exchange of information comprising:
(i) a search interface;
(ii) a consumer profile database; and
(ii) an interface monitor;
   wherein the search interface comprises a search field and a search result display and is adapted to:
(a) receive a new keyword from a new consumer via the search field; and
(b) display one or more search results together with a selectable region on the search result display, the selectable region being adapted to be selected by the consumer;
   wherein the interface monitor is adapted to:
(a) detect a selection by the new consumer of the selectable region on the search result display;
(b) create a new consumer profile record in the consumer database in response to the selection of the selectable region, the new consumer profile record being adapted to store at least the keyword; and
(c) store the keyword in the new consumer profile record.

Preferably, the new consumer profile record is further adapted to store consumer profile information, and the system further comprises a consumer information receiver adapted to:
(a) receive consumer profile information about the new consumer; and
(b) store the new consumer profile information in the new consumer profile record in the consumer database.

Preferably, the consumer information receiver is further adapted to:
(c) create a new consumer-identifying record in the new consumer database corresponding to the new consumer profile record;
(d) receive consumer-identifying information about the new consumer; and
(d) store the new consumer-identifying information in the new consumer-identifying record in the consumer database.

Preferably, the interface monitor is further adapted to:
(a) monitor the search interface in order to detect when the new consumer enters a further keyword in the search field of the search interface;
(b) receive the further keyword from the new consumer via the search field; and
(c) store the keyword in the new consumer profile record.

Preferably, the search interface comprises an interface of a search engine adapted to search information stored in a plurality of networked computers.

Preferably, the selectable region displayed on the search result display has the new keyword superimposed thereon.

Preferably, the selectable region displays an invitation.

Preferably, the invitation is adapted to invite the consumer to do one or more of the following:
(1) be paid to receive messages about the new keyword; and
(2) provide personal information regarding the new consumer to the consumer database.

Preferably, the new keyword comprises one or more keywords.

Preferably, the selectable region displayed on the search result display comprises one or more of:
(i) one or more still images;
(ii) one or more moving images;
(iii) text;
(iv) hyperlinks; and
(v) numbers.

Preferably, the consumer database is adapted to store a plurality of corresponding pairs of consumer profile records and consumer-identifying records, and wherein the system further comprises a search request receiver and a search result provider, the search request receiver being adapted to:
(a) receive a profile information search request from a requester, wherein the search request specifies at least one consumer profile criterion; and
(b) search the consumer profile records in the consumer database to identify selected consumer profile records containing consumer profile information which match the search request in order to obtain a search result,
   and wherein the search result provider is adapted to provide the search result to the requester,
   wherein the search result does not include any consumer-identifying information.

Preferably, the consumer profile criterion includes a keyword criterion.

According to an additional aspect of the present invention there is disclosed a method for permission-based information exchange using a search interface, an interface monitor and a consumer database, the search interface comprising a search field adapted to receive one or more keywords, the consumer database comprising an existing consumer profile record adapted to store consumer profile information about an existing consumer, and the method comprising the steps of:
(a) monitoring the search interface, using the interface monitor, in order to detect when the existing consumer enters a further keyword in the search field of the search interface;
(b) receiving the further keyword from the existing consumer via the search field; and
(c) storing the further keyword in the existing consumer profile record in the consumer database.

Preferably, the consumer database further comprises an existing consumer-identifying record corresponding to the existing consumer profile record.

Preferably, the search interface comprises an interface of a search engine adapted to search information stored in a plurality of networked computers.

Preferably, the further keyword comprises one or more keywords.

Preferably, the consumer database comprises a plurality of pairs of consumer-identifying records and consumer profile records, and the method further includes the additional steps of:
(d) receiving a profile information search request from a requestor via a search request receiver, wherein the search request specifies at least one consumer profile criterion;
(e) searching the consumer profile records in the consumer database to identify selected consumer profile records containing consumer profile information which match the search request in order to obtain a search result; and
(f) providing the search result to the requester via a search result provider, wherein the search result does not include any consumer-identifying information.

Preferably, the consumer profile criterion includes a keyword criterion.

Preferably, at least one of the selected consumer profile records corresponds to an individual selected consumer, and wherein the method further comprises the steps of:
(g) receiving promotional information from a promoter via a promotional information receiver, and
(h) providing the promotional information to the selected consumer via a promotional information provider;
   wherein consumer-identifying information about the selected consumer is not provided to the promoter.

Preferably, the method further comprising the steps of:
(i) receiving consumer response information corresponding to the promotional information via a consumer response receiver in order to obtain a response result; and
(j) providing the response result to the promoter via a response result provider, wherein the response result does not contain any consumer-identifying information.

Preferably, each promoter has a promoter financial account and wherein the step of receiving promotional information from the promoter further comprises debiting the promoter financial account by a promotion fee.

Preferably, the promotion fee comprises either monetary or non-monetary consideration.

Preferably, each consumer has a consumer financial account and wherein the step of receiving consumer response information corresponding to the promotional material further comprises the steps of:
(k) identifying a consumer financial account corresponding to a received consumer response;
(l) crediting that consumer financial account with a consumer response fee; and
(m) repeating steps (k) and (l) for each received consumer response.

Preferably, the method further comprises the additional steps of:
(i) receiving a consumer-supplied redemption request for a value;
(ii) debiting the consumer financial account by the value; and
(iii) providing the value to a consumer-nominated destination.

Preferably, the consumer-nominated destination comprises one or more of:
(i) an SMS sending program;
(ii) a financial institution account;
(iii) a third-party goods/service provider;
(iv) a third-party goods/service voucher provider;
(v) a third-party cash provider;
(vi) an SMS sending program financial account;
(vii) a third-party goods/service provider financial account;
(viii) a third-party goods/service voucher provider financial account; or
(ix) a third-party cash provider financial account.

According to another aspect of the present invention there is disclosed a system for permission-based communication and exchange of information comprising:
(i) a consumer profile database comprising an existing consumer profile record adapted to store consumer profile information about an existing consumer;
(ii) a search interface comprising a search field; and
(iii) an interface monitor;
wherein the interface monitor is adapted to:
(a) monitor the search interface in order to detect when the existing consumer enters a further keyword in the search field of the search interface; and
(b) provide the further keyword to the consumer database, and wherein the consumer database is adapted to:
(a) receive the further keyword from the interface monitor; and
(b) store the further keyword in the existing consumer profile record.

Preferably, the search interface comprises an interface of a search engine adapted to search information stored in a plurality of networked computers.

Preferably, the further keyword comprises one or more keywords.

Preferably, the consumer database is adapted to store a plurality of corresponding pairs of consumer profile records and consumer-identifying records, and wherein the system further comprises a search request receiver and a search result provider, the search request receiver being adapted to:
(a) receive a profile information search request from a requester, wherein the search request specifies at least one consumer profile criterion; and
(b) search the consumer profile records in the consumer database to identify selected consumer profile records containing consumer profile information which match the consumer profile criterion in order to obtain a search result,
   and wherein the search result provider is adapted to provide the search result to the requester,
   wherein the search result does not include any consumer-identifying information.

Preferably, the consumer profile criterion comprises a keyword criterion.

According to a further aspect of the present invention there is disclosed a method for permission-based information exchange using a consumer database and a promotional information database,

the consumer database storing both consumer-identifying information and consumer profile information about a plurality of consumers,

the promotional information database storing a plurality of sets of consumer profile criteria, each set having a corresponding item of promotional information, the criteria being indicative of the types of consumers to whom each item of promotional information should be sent,

the method comprising the steps of:

in the consumer database:
(a) receiving updated consumer profile information about a particular consumer; and
(b) storing the particular consumer's updated consumer profile information;

in the promotional information database:
(c) searching the sets of consumer profile criteria, and, if a particular set of consumer profile criteria matches the profile information of the particular consumer, then the method comprises the additional steps of:
(d) providing the item of promotional information corresponding to the particular consumer profile criteria to the particular consumer.

Preferably, the method further comprises the steps of:
(i) receiving consumer response information corresponding to the item of promotional information via a consumer response receiver in order to obtain a response result; and
(j) providing the response result to the promoter via a response result provider, and wherein the response result does not contain any consumer-identifying information.

Preferably, each promoter has a promoter financial account and wherein the step of receiving consumer response information corresponding to the item of promotional information further comprises the steps of:
(i) identifying a promoter financial account corresponding to the promotional information; and
(ii) debiting the promoter financial account by a promotion response fee.

Preferably, each promoter has a promoter financial account and wherein the step of providing the item of promotional information corresponding to the particular consumer profile criteria to the particular consumer further comprises the steps of:
(i) identifying a promoter financial account corresponding to the item of promotional information; and
(ii) debiting the promoter financial account by a promotion fee.

Preferably, the updated consumer profile information comprises one or more of:
(i) a keyword entered by a consumer into a search engine;
(ii) an answer to a consumer profile question;
(iii) consumer response information corresponding to an item of promotional information; and
(iv) third-party-supplied profile information.

Preferably, the third-party-supplied profile information comprises information relating to one or more of a consumer's:
(a) credit score;
(b) credit card purchases;
(c) number of frequent flyer miles or redemptions;
(d) travel tickets purchased;
(e) web surfing activities;
(f) television watching habits;
(g) radio watching habits;
(h) newspaper reading habits;
(i) magazine watching habits;
(j) mobile phone usage;
(k) internet transactions;
(l) point of sale purchases;
(m) received and paid bills;
(n) retail point of sale (POS) transactions;
(o) loyalty card purchases;
(p) bank account information;
(q) share trading activities;
(r) superannuation fund information;
(s) mobile phone location;
(t) intelligence quotient (IQ) test results;
(u) personality test results;
(v) newsletters;
(w) resume information;
(x) internet purchasing behaviour; and
(y) keyword searches.

Preferably, the step of providing the item of promotional information corresponding to the particular consumer profile criteria to the particular consumer comprises providing the item of promotional information via one or more of:
(i) a digital consumer interface (computer);
(ii) an email program;
(iii) a short message service (SMS) program;
(iv) a multimedia message service (mms) system;
(v) world wide web;
(vi) postal mail;
(vii) digital/interactive television;
(viii) digital/interactive billboards;
(ix) public terminal kiosks;
(x) pay phones;
(xi) an electronic data interchange (EDI) program;
(xii) a wireless application protocol (WAP) program; or
(xiii) other information transmission means.

According to yet another aspect of the present invention there is disclosed a method for permission-based information exchange, the method comprising the steps of:
(a) capturing consumer information corresponding to a plurality of individual consumers, the consumer information comprising both consumer-identifying information and consumer-descriptive information for each consumer,
(b) storing the consumer-identifying information in consumer-identifying records in a consumer database;
(c) storing the consumer-descriptive information in consumer description records in the consumer database;
(d) receiving a descriptive information search request from a requestor via a search request receiver, wherein the search request specifies at least one consumer description criterion;
(e) searching the consumer database to identify selected consumer description records containing consumer-descriptive information which match the consumer description criterion in order to obtain a search result; and
(f) providing the search result to the requestor via a search result provider, wherein the search result does not include any consumer-identifying information.

Preferably, the step of capturing consumer information comprises capturing the consumer information from an existing database.

Preferably, the selected consumer description records each correspond to an individual selected consumer, and wherein the method further comprises the steps of:
(g) receiving promotional information from a promoter via a promotional information receiver; and
(h) providing the promotional information to the selected consumers via a promotional information provider;
wherein consumer-identifying information is not provided to the promoter.

Preferably, the method further comprises the steps of:
(i) receiving consumer response information corresponding to the promotional information via a consumer response receiver in order to obtain a response result; and
(j) providing the response result to the promoter via a response result provider, and wherein the response result does not contain any consumer-identifying information.

Preferably, the method further comprises the step of updating the consumer-descriptive information in the consumer database with consumer response information received from individual consumers.

The consumer profile module and the business module are preferably maintained and operated by an independent, disinterested third party that does not own or cannot sell, license or otherwise distribute the consumer profiles or information contained in the consumer profile module. That is, any consumer that has created a consumer profile owns their consumer profile and can modify, update, delete or otherwise control their own consumer profile. The consumer profile module preferably is adapted to assign and control numbers or other identifying indicia for each profile to prevent any external identification of a consumer via his or her profile. This ensures consumer anonymity and security of the consumer profile information, while also ensuring the integrity and objectivity of the consumer data given the fact that the website operator and controller of information exchange is an independent third party not affiliated with the businesses or the consumers.

In the method according to this preferred embodiment of the present invention, it is preferable that the businesses are allowed to access the consumer profile information in the consumer profile module for free and that the businesses must pay to send requests to consumers and to receive consumer responses to the requests of the businesses. The payment made by businesses for sending and receiving responses to the requests is preferably shared by the consumers and by the website provider. The price for access by the businesses and the fee to be paid to the website owner/operator and the consumers who receive and response to business requests may be determined by the website owner/operator or the consumer or both. In one embodiment, the businesses only pay for the responses they receive, rather than for both sending the promotional information and for receiving the responses. A number of other combinations of revenue model are also envisaged.

The method described above also may include the step of allowing businesses to conduct queries and searches of the consumer profile module and to create target marketing, advertising and consumer requests for presentation to consumers via the business module. However, the businesses are prevented by the owner/operator of the website from having direct contact with consumers and from learning the identity or personal information of the consumers unless the consumer specifically authorises the release of personal information within the framework of the system. It is possible for consumers to request that their identity or personal information be revealed to selected businesses via the business module. In addition, consumers may choose to make purchases of various products and/or services advertised in the business requests presented to consumers via the business module. The consumers may choose to maintain their anonymity and make the purchase anonymously via the website or may choose to make the purchases directly from the business that has provided the business request.

In the event that a business pays to send business requests to consumers and a consumer fails to reply to the business requests, the fee paid by the business is preferably returned by the website operator/owner to the business.

In one embodiment, when a consumer adds a relationship indicia related to a business to their profile information, this suggests that they would like to receive promotional information from the business and, in that situation, the business does not need to pay the consumer to send them that information.

In order to preserve the confidentiality and integrity of the consumer information contained in the consumer profile module, the method described above preferably includes the step of encrypting the consumer information contained in the consumer profile module.

In this way, the businesses cannot access, change, or delete the consumer information contained in the consumer profile and cannot discover the identity or personal information of any of the consumers.

The businesses can choose to create promotional information such as questionnaires, surveys, requests, inquiries, media or other types of information gathering tools for presentation to consumers that have provided information to the consumer profile. The businesses may upload and deliver such information gathering requests and also may deliver advertising, marketing, and other information through the website for the purposes of transmitting requests to consumers in exchange for the payment of a fee. This prevents direct contact by a business to a consumer, allows consumers to maintain their anonymity and selectively respond to only those businesses that are of interest to them, and prevents boredom and habituation of the consumer caused in conventional methods whereby the consumer is paid to view and respond to as many banner ads as possible. The businesses also enjoy more accurate consumer information and data, and pay only for requests that are responded to thereby providing a much better return on investment and allowing them to create more and more effective and targeted advertising and marketing campaigns and create and manage relationships based upon their responses.

In addition, other preferred embodiments of the present invention provide systems and apparatuses for performing the methods described above.

Further, additional preferred embodiments include computer and machine readable media, computer software and machine executable instructions for causing a machine or computer to perform the steps of the various methods described above with respect to the other preferred embodiments of the present invention.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

In order that the present invention may be more clearly understood, preferred forms will be described with reference to the following drawings and examples.

### BRIEF DESCRIPTION OF THE DRAWINGS

FIG. 1 is a schematic diagram illustrating the hardware of a system embodiment of the invention;

FIG. 2 is a schematic diagram illustrating the main elements of a preferred embodiment of a server computer according to the invention;

FIG. 3 is a schematic diagram illustrating the interaction between the software and consumer database in the server computer with the consumer computer and the business computer;

FIGS. 4 and 5 are flow diagrams illustrating the steps involved in a method embodiment of the invention;

FIG. 6 is a screen dump of an example website home page according to the invention;

FIG. 7 is a screen dump of an example “How it works” page according to the invention;

FIG. 8 is a screen dump of an example registration page according to the invention;

FIGS. 9 and 10 are screen dumps of example profile questionnaire pages according to the invention;

FIGS. 11A to 11C are printouts of an example. profile questionnaire according to the invention;

FIG. 12 is a conceptual block diagram of the consumer-identifying information records and the consumer profile information records according to the invention;

FIG. 13 is a conceptual block diagram illustrating the structure of the pages of a business web site according to the invention;

FIG. 14 is a screen dump of an example “Target markets introduction” page according to the invention;

FIG. 15 is a screen dump of an example “Create new target markets” page according to the invention;

FIG. 16 is a screen dump of an example “Add criteria” page according to the invention;

FIG. 17 is a screen dump of an example “Target market naming” page according to the invention;

FIG. 18 is a screen dump of an example “View all target markets” page according to the invention;

FIG. 19 is a screen dump of an example “Target market summary” page according to the invention;

FIG. 20 is a conceptual block diagram illustrating the structure of the pages of a campaign building web site according to the invention;

FIG. 21 is a screen dump of an example “Campaign introduction” page according to the Invention;

FIG. 22 is a screen dump of an example “Create campaign” page according to the invention;

FIG. 23 is a screen dump of an example “Campaign builder” page according to the invention;

FIG. 24 is a screen dump of an example “Campaign name edit” page according to the invention;

FIG. 25 is a screen dump of an example “Select target markets” page according to the invention;

FIG. 26 is a screen dump of an example “Select response groups” page according to the invention;

FIG. 27 is a screen dump of an example “Upload media” page according to the invention;

FIG. 28 is a screen dump of an example “Write questions” page according to the invention;

FIG. 29 is a screen dump of an example “Campaign builder” page according to the invention;

FIG. 30 is a screen dump of an example email “Preview campaign” page according to the invention;

FIG. 31 is a screen dump of an example “Write messages” page according to the invention;

FIG. 32 is a screen dump of an example SMS “Preview campaign” page according to the invention;

FIG. 33 is a screen dump of an example message notification email according to the invention;

FIG. 34 is a screen dump of an example personalised home page according to the invention;

FIG. 35 is a screen dump of an example “View new email messages” page according to the invention;

FIG. 36 is a screen dump of an example “Campaign reports overview” page according to the invention;

FIG. 37 is a screen dump of an example “Campaign report details” page according to the invention;

FIG. 38 is a screen dump of an example “Response group” page according to the invention;

FIG. 39 is a screen dump of an example “Consumer account” page according to the invention;

FIG. 40 is a screen dump of an example “Fees received” page according to the invention;

FIG. 41 is a screen dump of an example “Fees paid out” page according to the invention;

FIG. 42 is a screen dump of an example “Send SMS message” page according to the invention;

FIG. 43 is a screen dump of an example “Sent SMS history” page according to the invention;

FIG. 44 is a screen dump of an example “Payout to bank account” page according to the invention;

FIG. 45 is a screen dump of an example “Wishlist voucher” page according to the invention;

FIG. 46 is a screen dump of an example “Accounts introduction” page according to the invention;

FIG. 47 is a screen dump of an example “Account summary” page according to the invention;

FIG. 48 is a screen dump of an example “Transaction listing” page according to the invention;

FIG. 49 is a screen dump of an example “Deposit funds” page according to the invention;

FIG. 50 is a screen dump of an example “Deposit slip” page according to the invention;

FIG. 51 is a screen dump of an example “Request refund” page according to the invention;

FIGS. 52 and 53 are a conceptual diagrams illustrating the fourth to seventh aspects of the present invention;

FIGS. 54 and 55 are conceptual flow diagrams, illustrating the interaction of the interface monitor, the search interface and the consumer database in the fourth to seventh aspects of the present invention;

FIG. 56 is a screen dump of an example search interface;

FIG. 57 is a screen dump of an example consumer interface illustrating the way in which existing consumers may opt in to have their keywords tracked by the interface monitor;

FIG. 58 is a screen dump of an example of another section of the consumer interface illustrating the way in which existing consumers may manage and control the keywords that have been automatically saved in their profile records;

FIG. 59 is a screen dump of a further example consumer interface illustrating the way in which existing consumers may opt in to have their keywords tracked by the interface monitor;

FIG. 60 is a screen dump of a monitored search engine; and

FIG. 61 is an updated version of the search engine of FIG. 56.

### DETAILED DESCRIPTION OF INVENTION

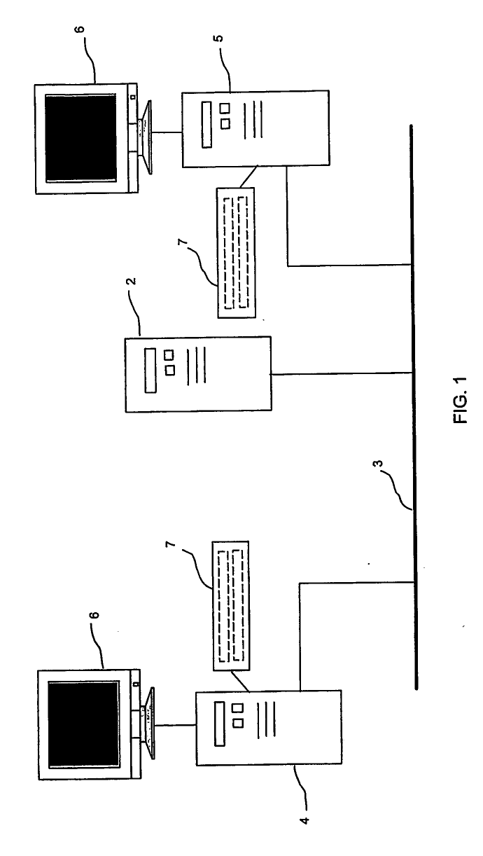

Referring to FIG. 1, there is shown the hardware elements of a preferred embodiment of the anonymous information exchange system 1 of the present invention. The system includes a server computer 2 which is adapted to communicate with a consumer computer 4 and a business computer 5 via a network 3 such as the internet. The consumer computer has a monitor 6, keyboard 7 and browser software (not shown), as does the business computer. In use, the server computer 2 provides browser compatible pages to the network 3, which the consumer and business computers access and view using their browser software.

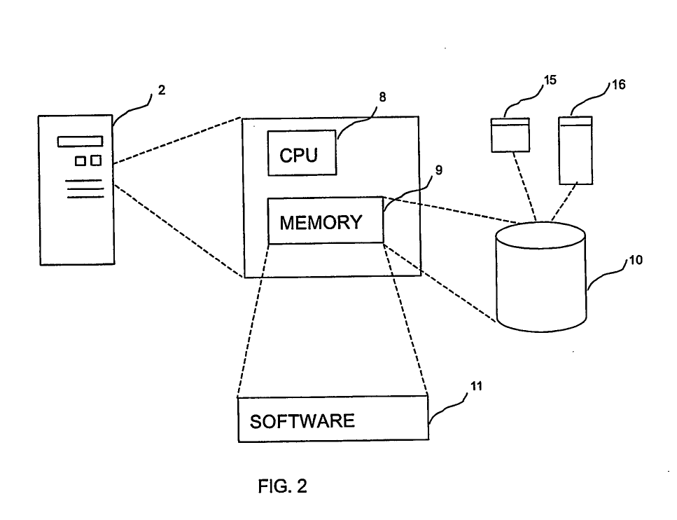

Referring to FIG. 2, the server computer 2 has a central processing unit (CPU) 8 and a memory 9. Stored within the memory are a consumer database 10 and a number of software programs 11. The consumer database 10 is designed to store both consumer-identifying records 15 and consumer profile records 16. Although illustrated as one computer, the server computer 2 may take the form of a number of computers each serving part of the various functions of the server computer.

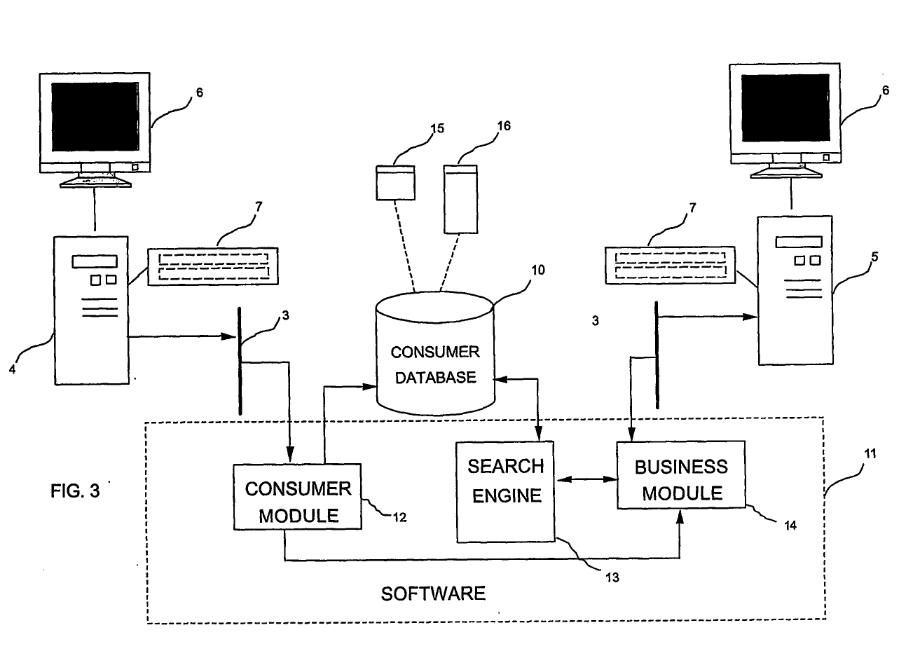

As shown in FIG. 3, the software programs 11 in the server computer include a consumer module 12, a search engine 13 and a business module 14.

The consumer module 12 is adapted to communicate with the consumer database 10 and to receive consumer information from a consumer sent via the consumer computer 4 and the network 3. The consumer information includes both consumer-identifying information and consumer profile information. The consumer module is also adapted to provide the consumer-identifying information and the consumer profile information to the consumer database 10.

The consumer database 10 is adapted to communicate with both the consumer module and the search engine 13. The database is designed to receive the consumer-identifying information from the consumer module 12 and store it in one of the consumer-identifying records 15. It also receives the consumer profile information from the consumer module 12 and stores it in one of the consumer profile records 16.

The business module 14 is adapted to communicate with both the search engine and the business computer 5. It is designed to receive profile information search requests from a requester via the business computer 5 and the network 3. The search request specifies at least one consumer profile criterion which indicates the particular characteristics the requester is looking for in a consumer. Those characteristics are structured to mirror the profile information provided by the consumer.

The search engine 13 is adapted to communicate with both the consumer database 10 and the business module 14. It is designed to receive a profile information search request from the business module and search the consumer database to identify selected consumer profile records containing consumer profile information which match the search request and to thereby obtain a search result. It also provides the search result to the business module 14 which, in turn provides it to the business computer 5 via the network. In order to keep the consumer's identity anonymous, the search result does not include any consumer-identifying information.

The business module 14 also functions as a promotional information receiver. In this capacity it is adapted to receive promotional information from a promoter via the business computer 5 and the network 3.

The consumer module 12 is also designed to act as a promotional information provider which is adapted to provide the promotional information to the selected consumers which were located in the search engine's search. When performing this function, the system is further adapted not to provide consumer-identifying information to the promoter, thus keeping the selected consumers' identity confidential.

The consumer module 12 also performs the role of a consumer response receiver which is adapted to receive consumer response information corresponding to the promotional information. This response information is received from consumers via the consumer computer 4 and the network 3. When it receives such response information the consumer module 12 generates a response result.

In this embodiment, the business module 14 also performs the role of a response result provider which is adapted to receive the response result from the consumer module 12 and provide it to the promoter via the business computer 5 and the network. in order to keep the consumers anonymous, the response result does not contain any consumer-identifying information.

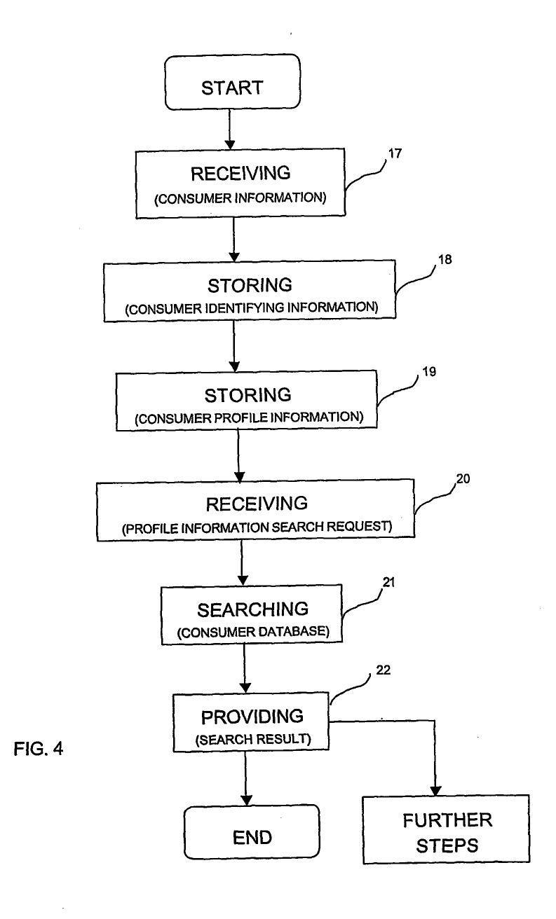

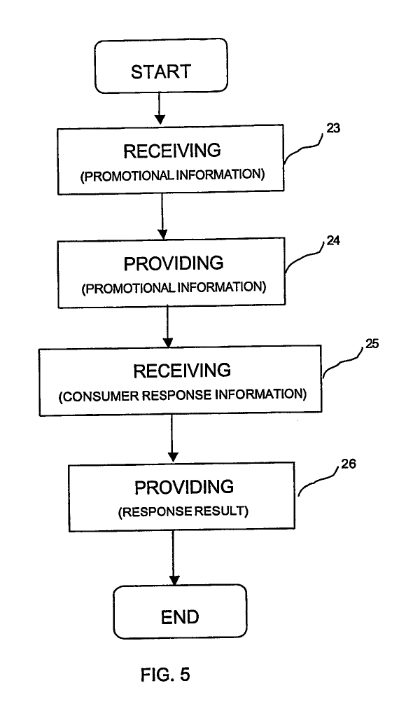

The above-described system is preferably used in accordance with a method embodiment of the invention illustrated in FIGS. 4 and 5.

Turning firstly to FIG. 4, the preferred method for exchanging information with anonymous consumers, involves a number of steps. The first step involves receiving 17 consumer information corresponding to a number of individual consumers via a consumer information receiver. In this embodiment the consumer information receiver takes the form of the consumer module 12 in communication with the consumer computer 4 via the network 3. The consumer information includes both consumer-identifying information and consumer profile information for each consumer.

The next step involves storing 18 the consumer-identifying information in consumer-identifying records 15 in the consumer database 10.

The next step involves storing 19 the consumer profile information in consumer profile records 16 in the consumer database 10.

The next step involves receiving 20 a profile information search request from a requestor via a search request receiver. In the preferred embodiment, the search request receiver takes the form of the business module 14 in communication with the business computer 5 via the network 3. The search request specifies at least one consumer profile criterion.

The next step involves the search engine 13 searching 21 the consumer database 10 to identify selected consumer profile records containing consumer profile information which match the search request in order to obtain a search result.

The next step involves providing 22 the search result to the requester via a search result provider which in this embodiment takes the form of the business module 14 in communication with the business computer 5 via the network. It is important to note that the search result does not include any consumer-identifying information, so as to keep the consumer's identity secret.

In this embodiment, the selected consumer profile records each correspond to an individual selected consumer, and the method includes a number of additional steps shown in FIG. 5. The first step involves receiving 23 promotional information from a promoter via a promotional information receiver. In this embodiment the promotional information receiver takes the form of the business module in communication with the business computer 5 via the network.

The next step involves providing 24 the promotional information to the selected consumers via a promotional information provider. In this embodiment, the promotional information provider takes the form of the consumer module 12 in communication with the consumer computer 4 via the network 3. When the promotional information is sent to the consumers, the corresponding consumer-identifying information is not provided to the promoter, so the consumer's identity is not disclosed to the promoter.

The next step involves receiving 25 consumer response information corresponding to the promotional information via consumer response receiver in order to obtain a response result. In this embodiment, the consumer response receiver takes the form of the consumer module 12 in communication with the consumer computer 4 via the network 3.

The next step involves providing 26 the response result to the promoter via a response result provider. In this embodiment, the response result provider takes the form of the business module 14 in communication with the business computer 5 via the network. The response result does not contain any consumer-identifying information, so the consumer's identity remains secret.

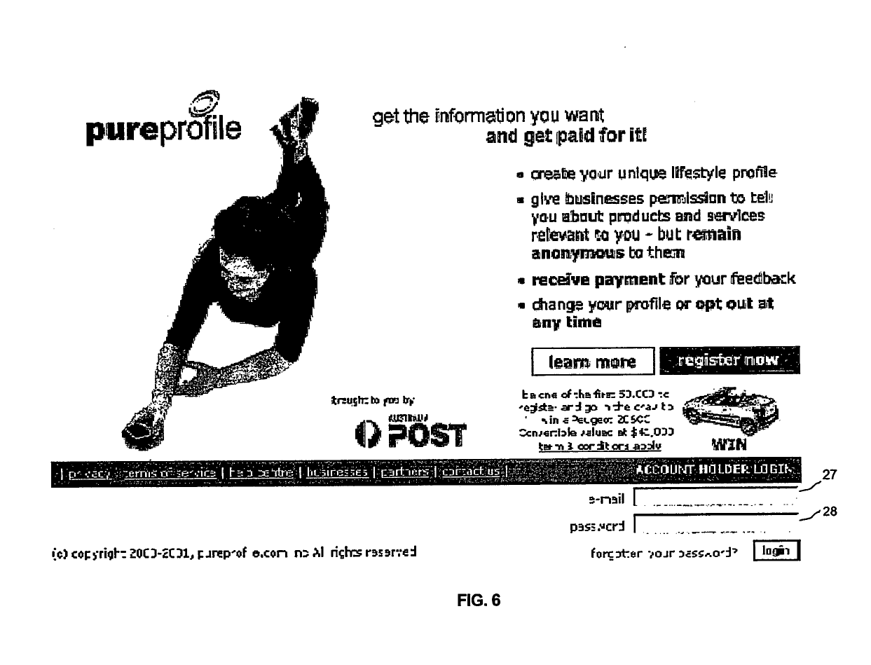

As mentioned above, in the preferred embodiment, the step of receiving 17 consumer information is achieved using a consumer module 12. The consumer module 12 includes a web server so that a consumer may provide consumer information to the module via an internet website. FIG. 6 shows an example home page of such a website. That home page allows a consumer to log into the system using a user ID (which in this case is their email address) and a password provided via a user ID field 27 and a password field 28.

In this and the following website screen shots, the word “pureprofile” is used. This is the trade mark the applicant has applied to the present invention. At present the pureprofile website is accessible via the pureprofile.com.au URL.

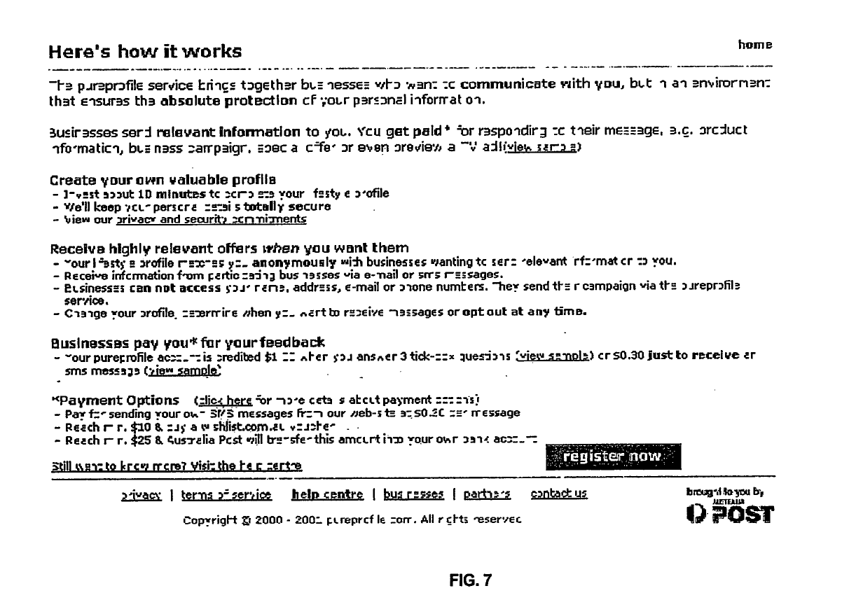

FIG. 7 shows an example “How it works” page on the website which explains how the system works from a consumer's perspective.

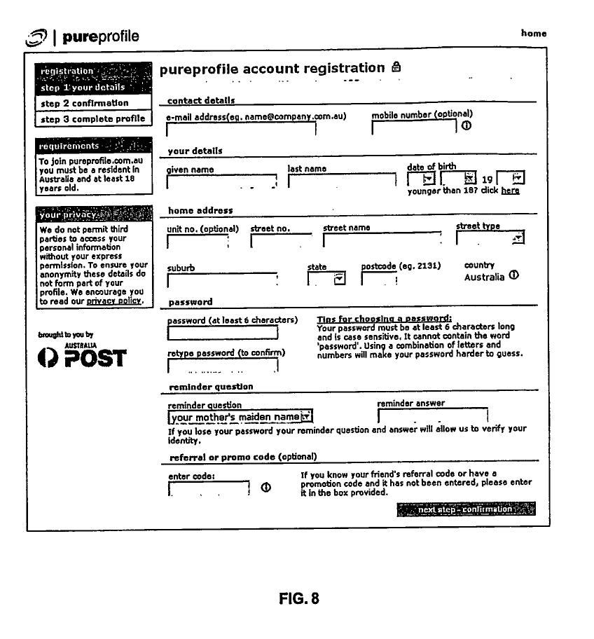

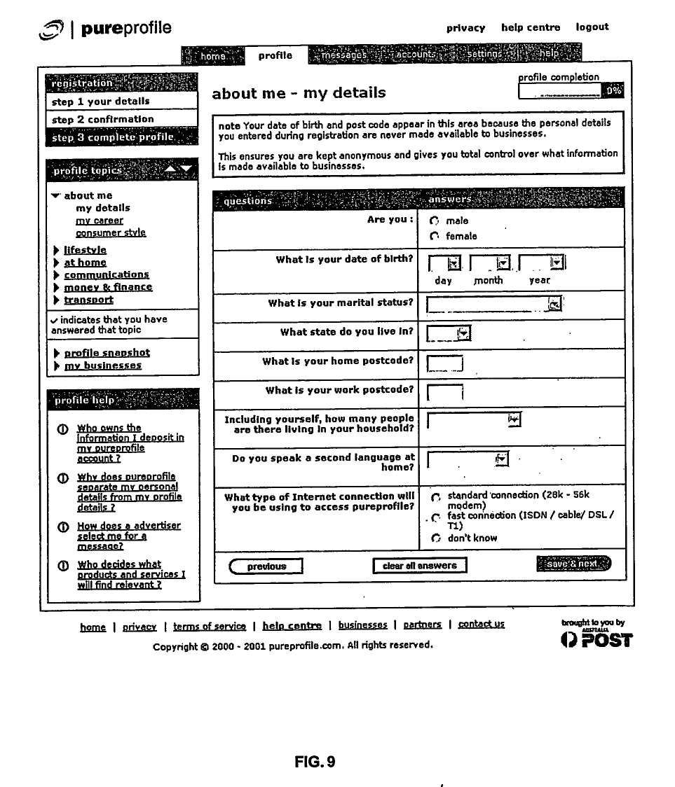

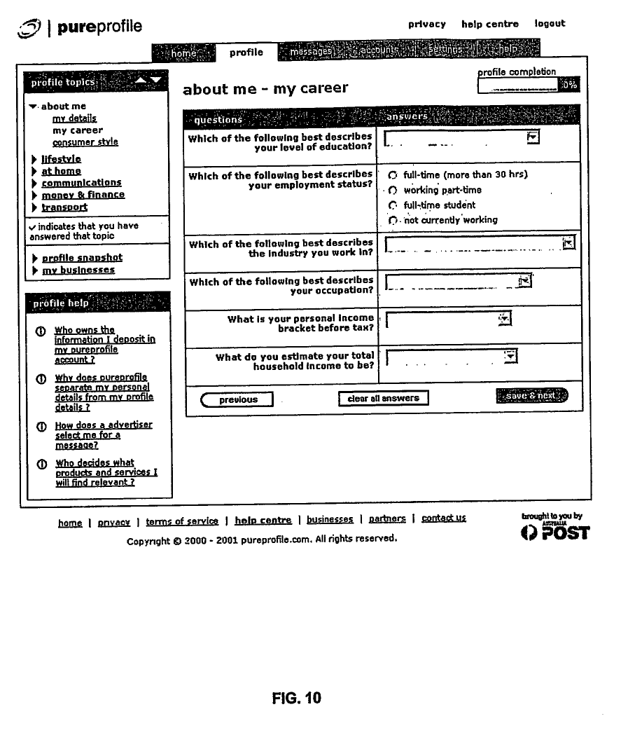

The consumer information includes both consumer identity information and consumer profile information. The consumer identity information is received by the consumer profile via the registration page shown in FIG. 8. The consumer profile information is received by the consumer profile via a set of profile questionnaire pages shown in FIGS. 9 and 10.

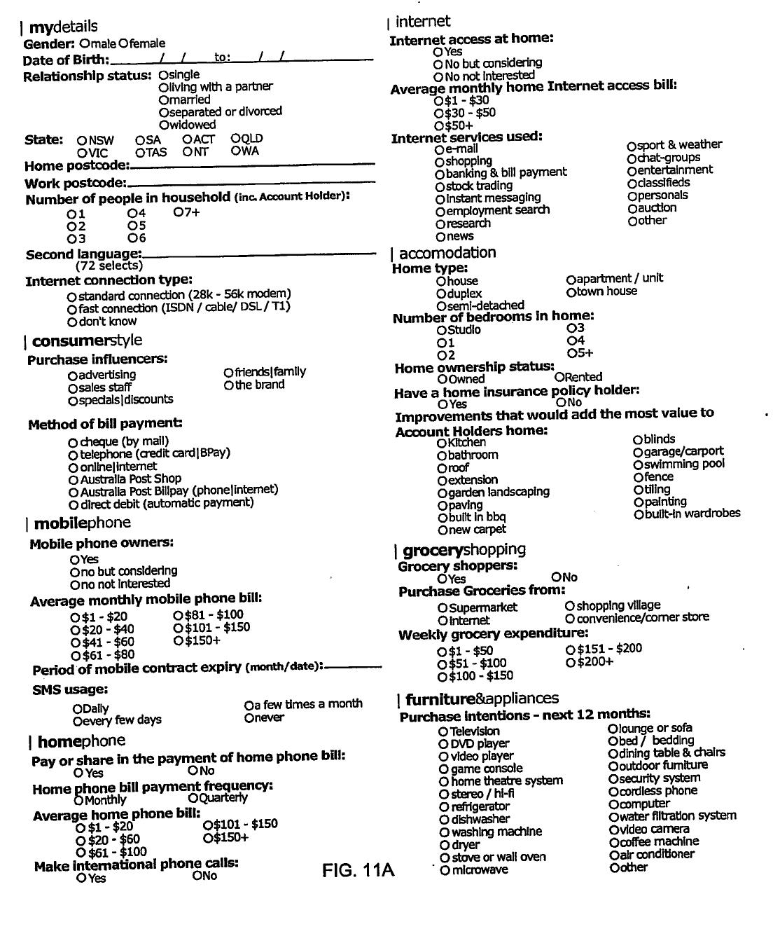

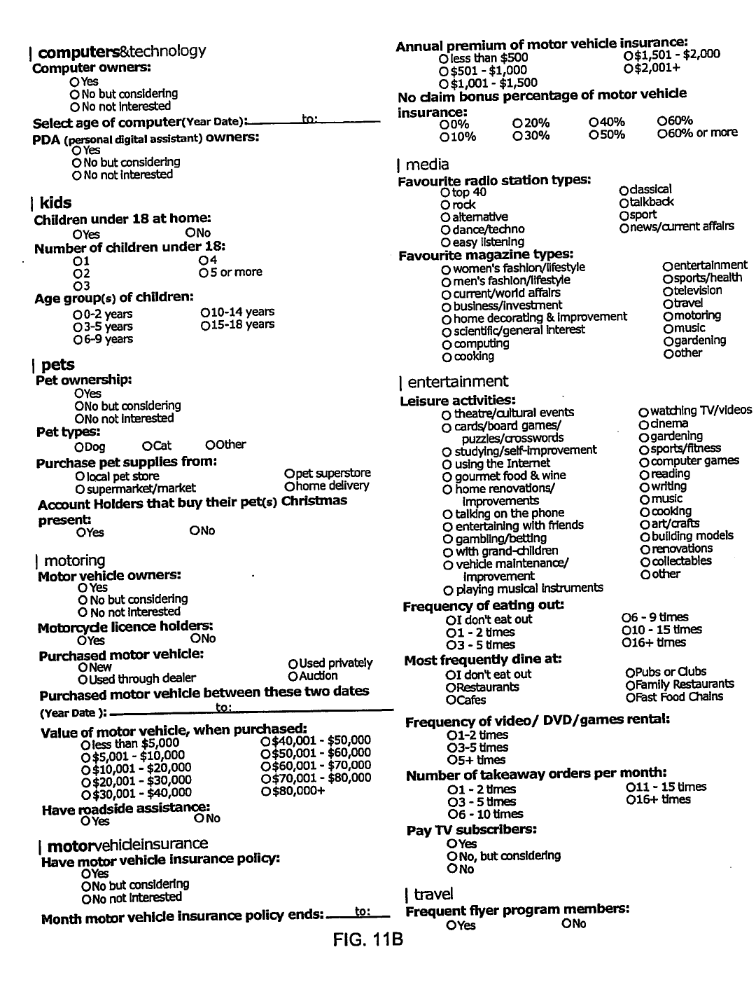

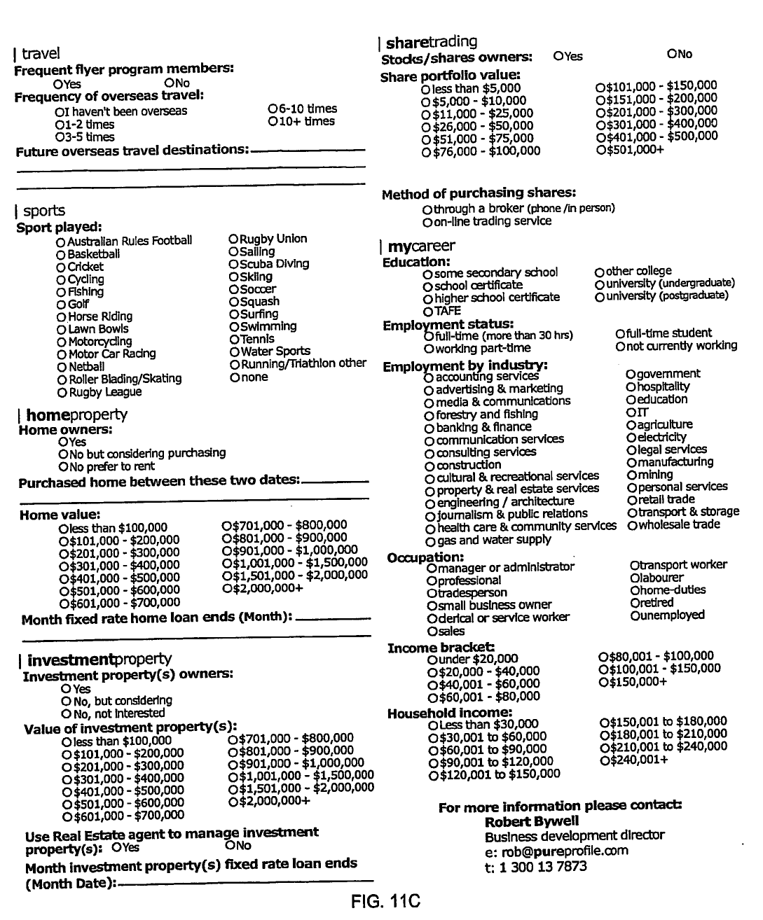

The profile information may include any information relating to the demographic, sociographic, lifestyle, financial, purchasing, returning and other characteristics or preferences of a consumer. FIGS. 11A to 11C show one example of a profile questionnaire which may be used to receive consumer profile information from a consumer.

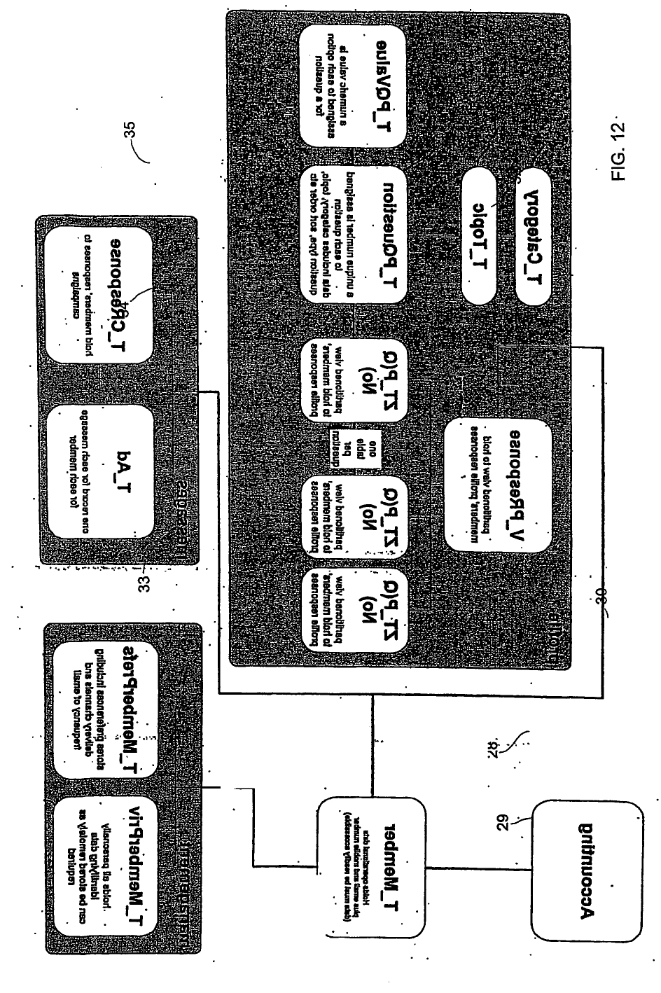

Once the consumer information has been received the consumer module 12 then performs the step of storing 18 the consumer-identifying information in consumer-identifying records 15 and storing 19 the consumer profile information in consumer profile records 16 in the database. In order to keep the consumer-identifying information anonymous, but allow the consumer profile information to be searched by the search engine, the two sets of information are stored in separate tables of a database and the consumer-identifying information is stored in encrypted form. FIG. 12 shows a conceptual diagram illustrating this arrangement.

Referring to FIG. 12 there is shown a consumer-identifying record 28 which stores consumer-identifying information 29 and consumer preference/permission information 30. The consumer-identifying information 29 may be any information about an individual consumer whose identity is apparent, or can reasonably be ascertained, from the information or opinion. In this preferred embodiment, in order to maintain the security of this information, the consumer-identifying information is encrypted using industry standard encryption techniques.

In one embodiment the consumer database 10 may consist of two separate database, one to store the consumer-identifying information 29 and the other to store the consumer profile information.

The preference information 30 stored In the consumer-identifying record 28 enables the consumer to control their own information. For example, the preference information may indicate which pieces of a consumer's profile information that consumer is willing to make available to third parties. It may also define the reward a consumer is willing to accept to make some or all of that consumer's profile information available to third parties. It may further define one or more businesses, products or services about which a consumer is not willing to receive promotional information. The combinations of possible permission/preference information are very broad. From defining the manner in which the consumer prefers to receive information right up to defining the type and quantity of promotional material the consumer is willing to receive from a particular business or set of businesses within a certain time period, and the reward the consumer is willing to receive to view and respond to that information. In this way the consumer is in complete control, not only of their identifying information, but also in respect of their profile information and the contact/relationships they are willing to engage in with promoters or businesses and also the parameters of those relationships. The present system provides a unified permissioning framework which keeps the consumer in control of the relationship and the information flow.

Continuing on with FIG. 12, the consumer database 10 also stores consumer profile records 31. These records store consumer profile information which takes the form of question information 32 and response information 33. Each question which the consumer answered in the profile questionnaire described above has a corresponding response. The questions are divided into categories 34 and topics 35 to assist in the ready searching of the database. Each question has a limited number of selectable answers, each of which is assigned a value 36. The combination of question information 32 and response information 33 make up the consumer-supplied profile information stored in the consumer database 10.

Returning to FIG. 4, the step of receiving 20 a profile information search request occurs when a requester, such as a business, wants to locate a target market to send promotional information to. In the preferred embodiment, the business module 14 (FIG. 5) includes a web server so that a business/requestor may use a business web site to specify profile criteria that they want their target market to have. For example, a particular business may want to target those consumers who own their own home, have a household income of $60,000 to $90,000 and who are intending on buying a washing machine in the next 12 months. Of course, the business/requestor might choose to access the business web site via an intermediary or representative such as an advertising agency or the like.

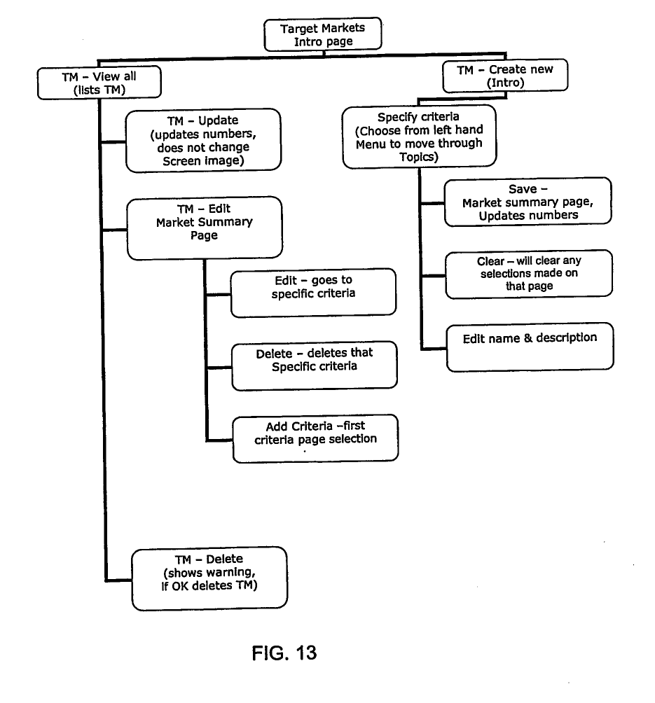

FIG. 13 shows a block diagram illustrating the structure of the preferred embodiment of such a web site.

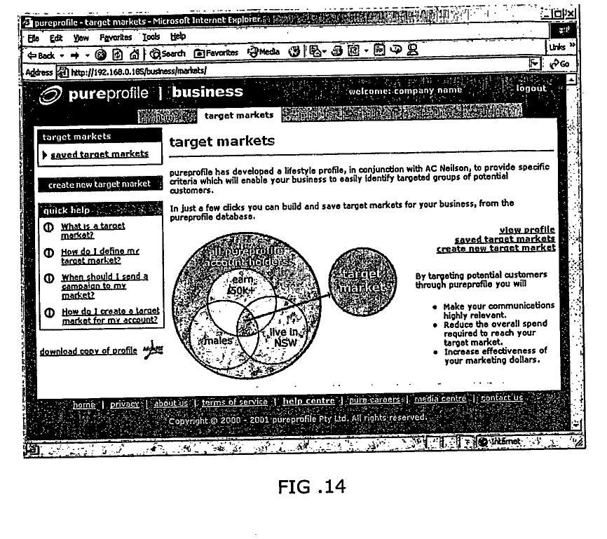

FIG. 14 shows a target markets introduction page which explains how the requestor can specify one or more profile criterion to generate a target market of consumers to whom they can then send promotional information.

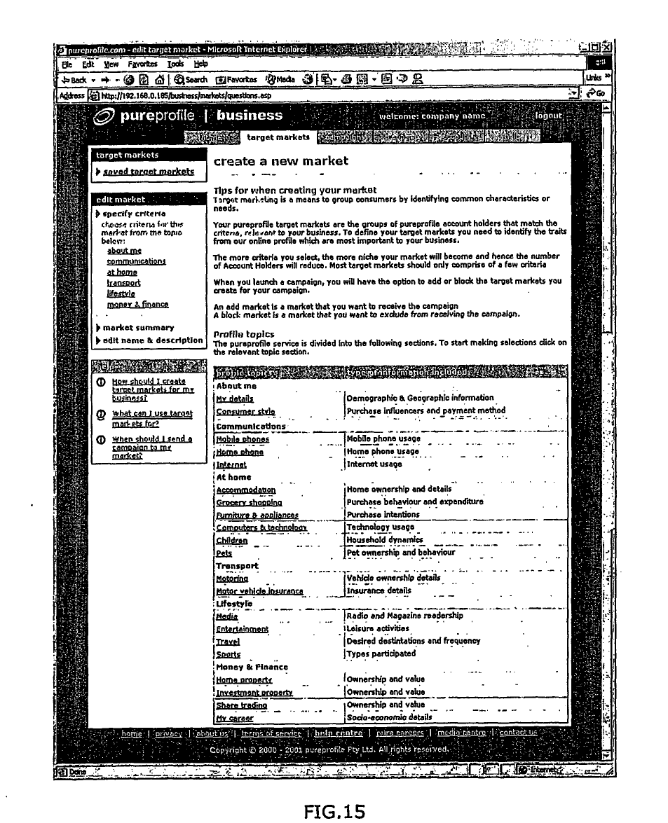

FIG. 15 shows a create new target markets page which allows a requestor to create a new target market.

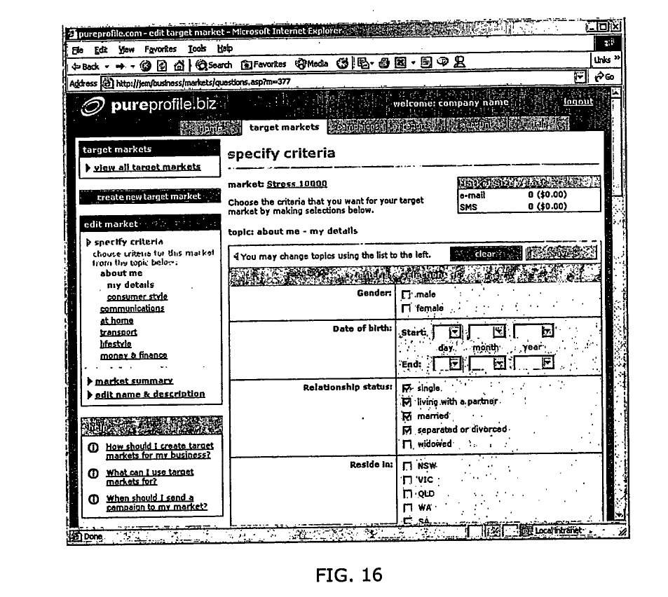

FIG. 16 shows an add criteria page which allows a requestor to add new criteria to an existing target market. As the requestor specifies further profile criteria, the search engine 13 automatically performs the step of searching 21 the consumer database 10 to identify those selected consumer profile records 16 which match the supplied criteria and to generate a search result 36. The business module 14 then performs the step of providing 22 the search result 36 to the requester via the business web site. An example of a search result 36 is shown in FIG. 16. This result indicates both the number of consumers whose profile records match the profile criteria of the search request, and the cost to the requestor of sending promotional information to all of those consumers by either email or SMS.

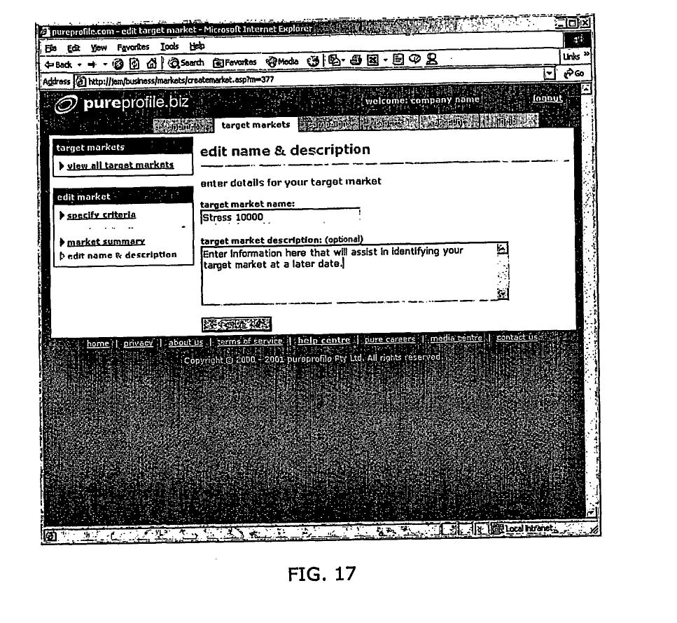

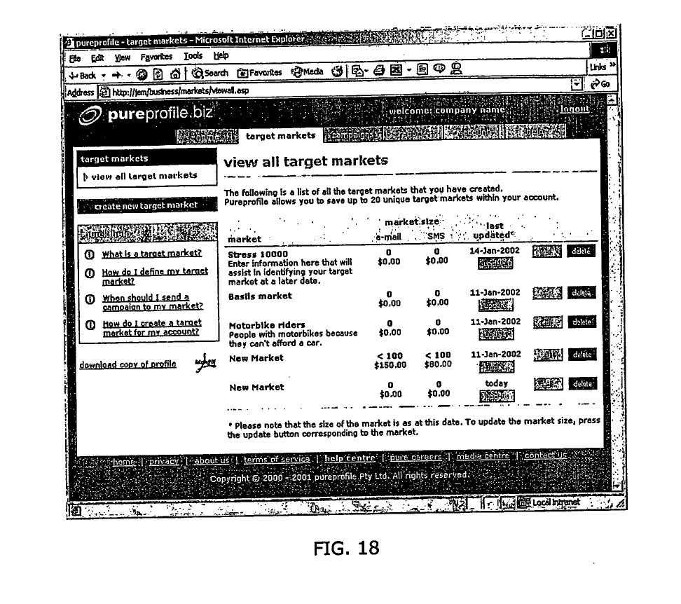

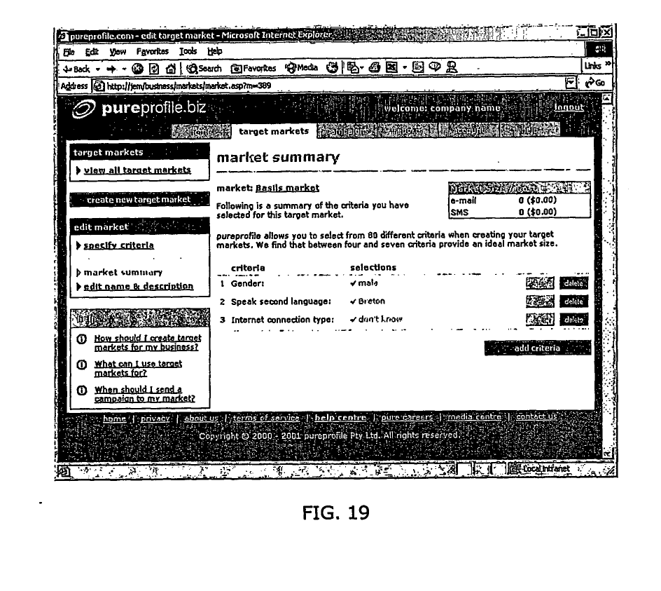

Once the criteria have been selected, the requestor can assign a name to the target market using the target market naming page shown in FIG. 17. When the requestor has specified a number of target markets, they can see their entire list of target markets using the “View all target markets” page shown in FIG. 18. The requestor can then select any target market and view its summary on the “Target market summary” page shown in FIG. 19.

Once a requestor has selected an appropriate target market, they can then use the business module to generate a campaign to send promotional information to the consumers in that target market.

In one embodiment, the campaign is sent to the target market once the requestor has identified the target market. In another embodiment the requestor can set up an automatic campaign, ready to be sent out to those consumers which satisfy certain criteria. The requestor can set up the criteria and, when a new consumer is added to the database or when an existing user's information is updated, the set of criteria corresponding to the automatic campaign is searched. If the consumer's profile matches that set of criteria, then the campaign is triggered and the consumer is sent the corresponding promotional information.

In addition, certain pieces of information in a consumer's profile may only be relevant for a certain period of time. For example, a question may indicate the large appliances which a consumer may be interested in buying in the next six months. After that six month period, that information will no longer be relevant. In one embodiment at least some of the questions in a consumer's profile have a relevance period associated with them. Once this period expires, the system notifies the consumer that they need to update their profile. This notification may take the form of a brief note at the end of the next piece of promotional information sent to the consumer. Alternatively, a notification may appear when they next log in to their profile. A number of alternative notification methods are also envisaged.

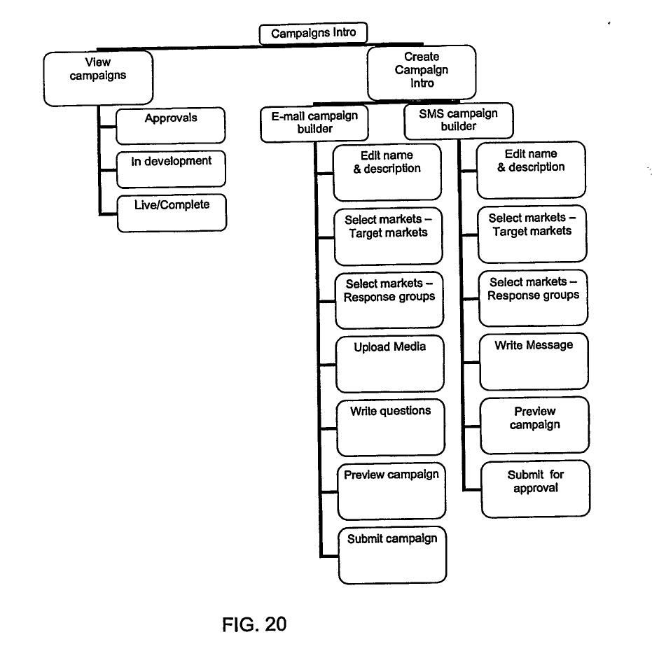

Returning to FIG. 5, the step of receiving 23 such promotional information is again performed via an internet website. FIG. 20 shows a block diagram illustrating the structure of the preferred embodiment of such a web site.

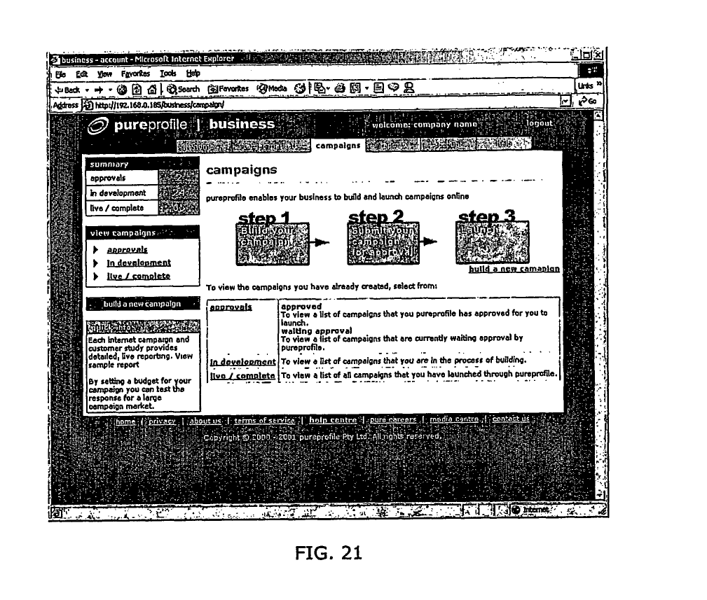

In this preferred embodiment, the web site includes a campaign introduction page, as shown in FIG. 21, which explains how a business/promoter can upload promotional information to the website and send it to the consumers located in their target market search without knowing the identity of those consumers.

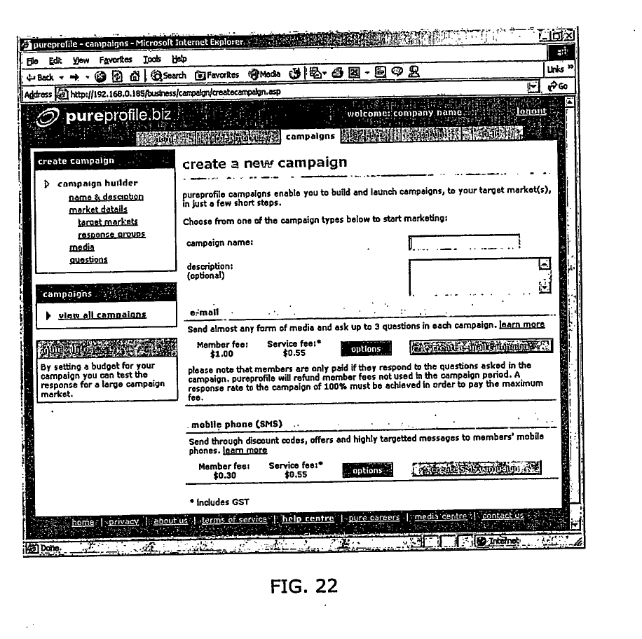

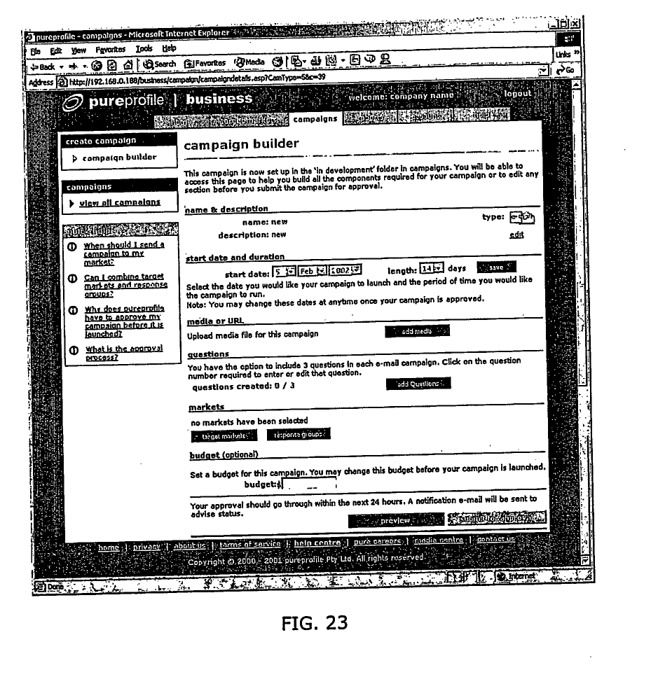

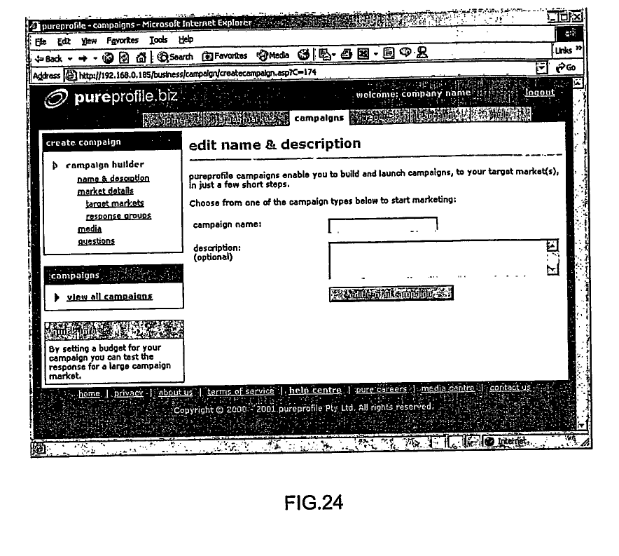

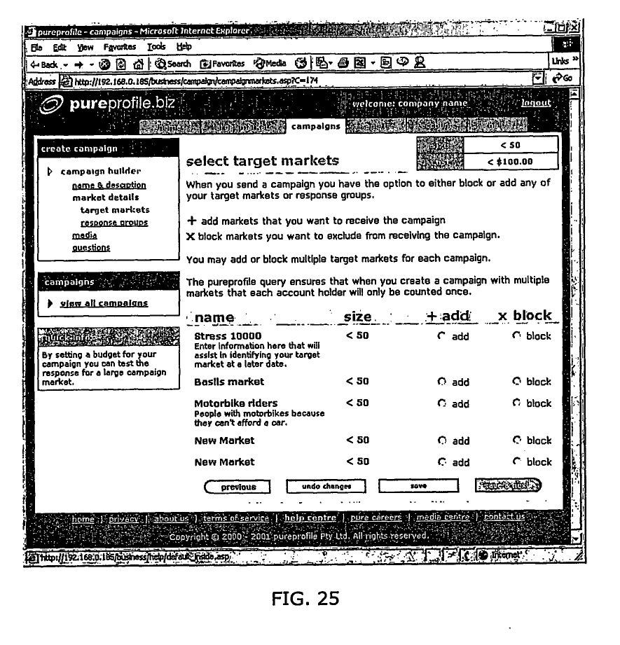

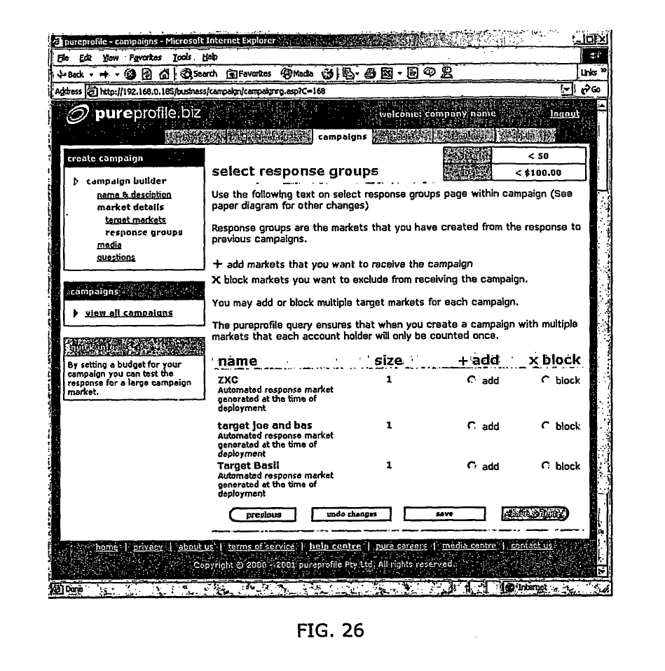

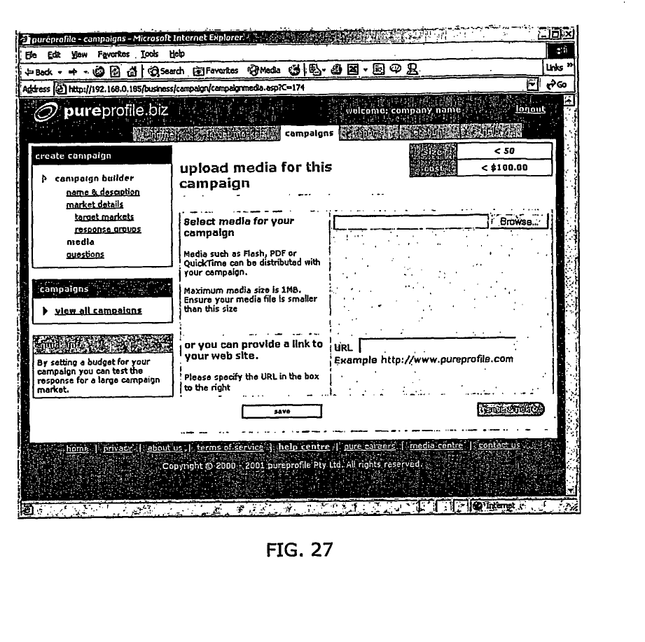

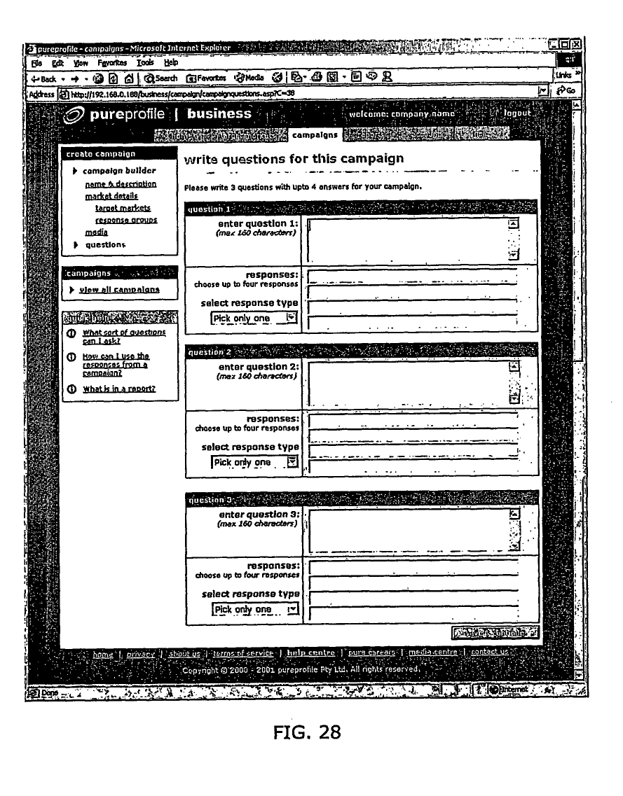

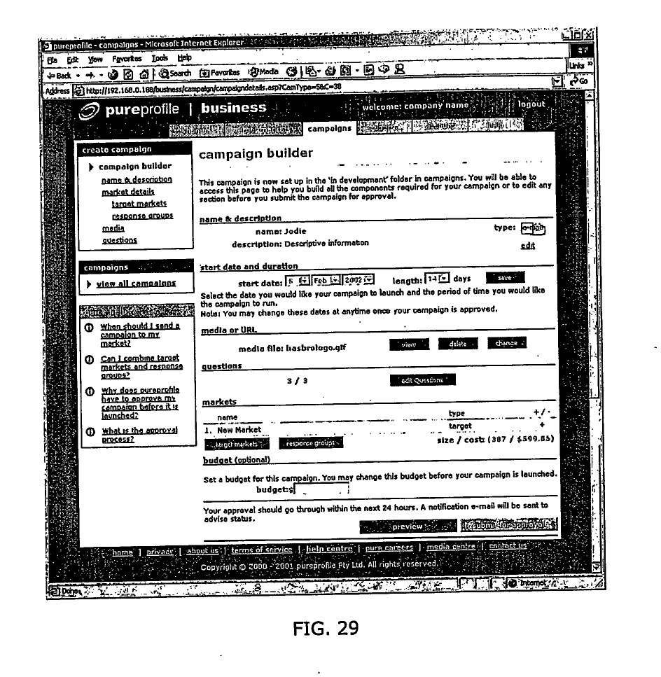

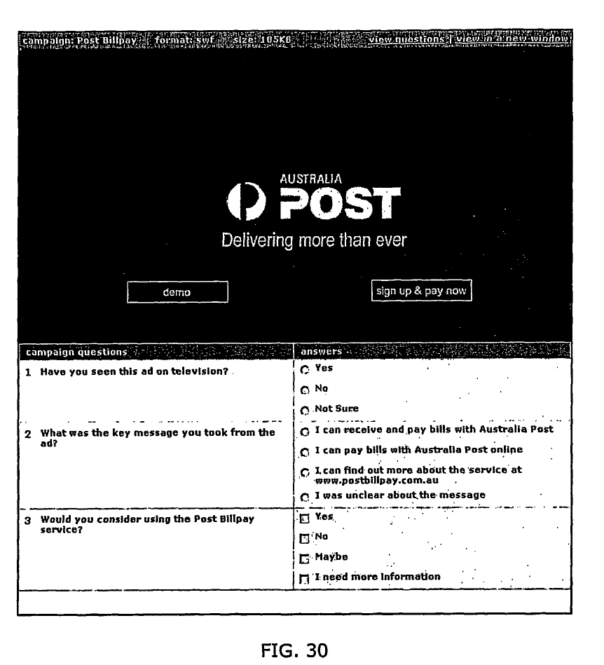

The web site enables a consumer to build an email campaign or an SMS campaign. Both campaigns begin with a “Create campaign” page shown in FIG. 22. in order to create an email campaign the business module 14 then serves a number of pages to the business computer 5 via the network 3. In the preferred embodiment, these pages include a “Campaign builder” page (FIG. 23), a “Campaign name edit” page (FIG. 24), a “Select target markets” page (FIG. 25), a “Select response groups” page (FIG. 26), an “Upload media” page (FIG. 27), a “Write questions” page (FIG. 28) and a “Campaign builder” page (FIG. 29). At the end of the process, the business/promoter will have produced promotional information, such as that shown in the “Preview campaign” page of FIG. 30. As seen in that figure, the promotional information includes both displayable promotional information and a number of promotional questions, each having a number of selectable promotional answers.

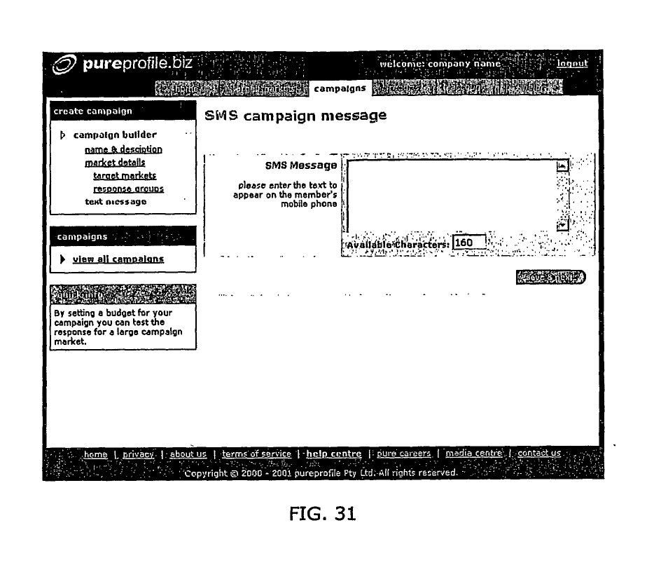

In order to create an SMS campaign the business module 14 then serves a number of pages to the business computer 5 via the network 3. In the preferred embodiment, these pages include a “Campaign builder” page (similar to that of FIG. 23), a “Campaign name edit” page (similar to that of FIG. 24), a “Select target markets” page (similar to that of FIG. 25), a “Select response groups” page (similar to that of FIG. 26) and “Write message” page (FIG. 31).

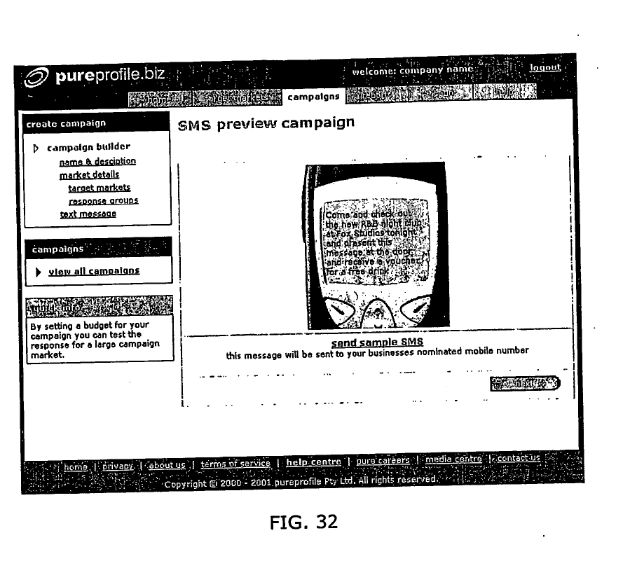

At the end of the process, the business/promoter will have produced promotional information, such as that shown in the “Preview campaign” page of FIG. 32.

Returning to FIG. 5, the step of providing 24 the promotional information to the consumer may be performed in a number of ways. When the promotional information is an SMS message, the system identifies the consumer's mobile phone number in the consumer's identifying information record 15 and sends the information to them using an appropriate SMS program.

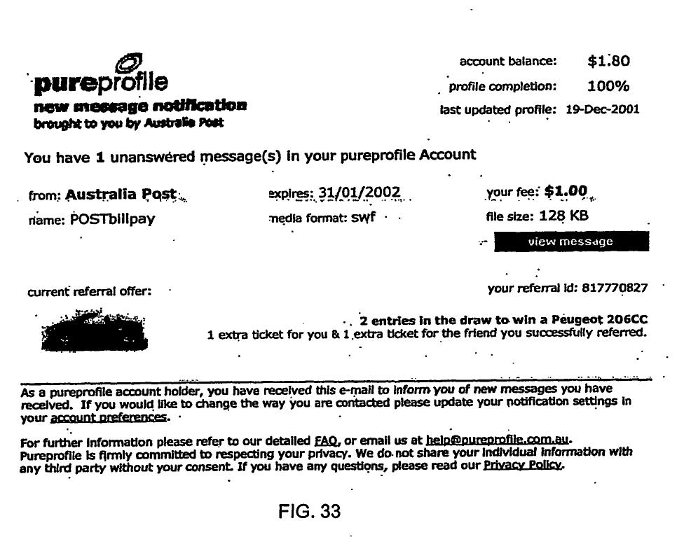

When the promotional information is an email, the entire promotional information may be sent via email. However, in the preferred embodiment, the system sends the consumer a message notification email such as that shown in FIG. 33 which directs the consumer to log into the website to view and respond to the promotional information.

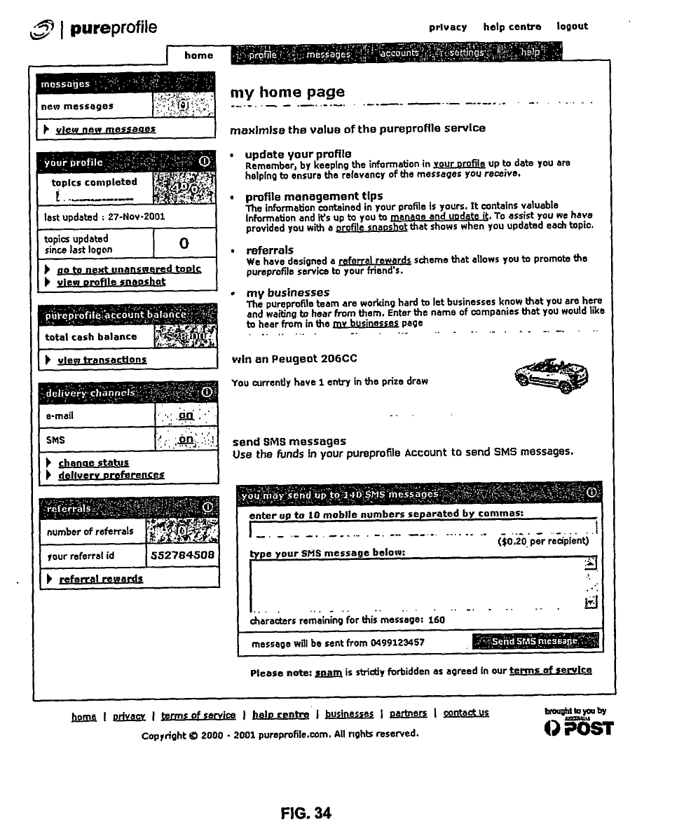

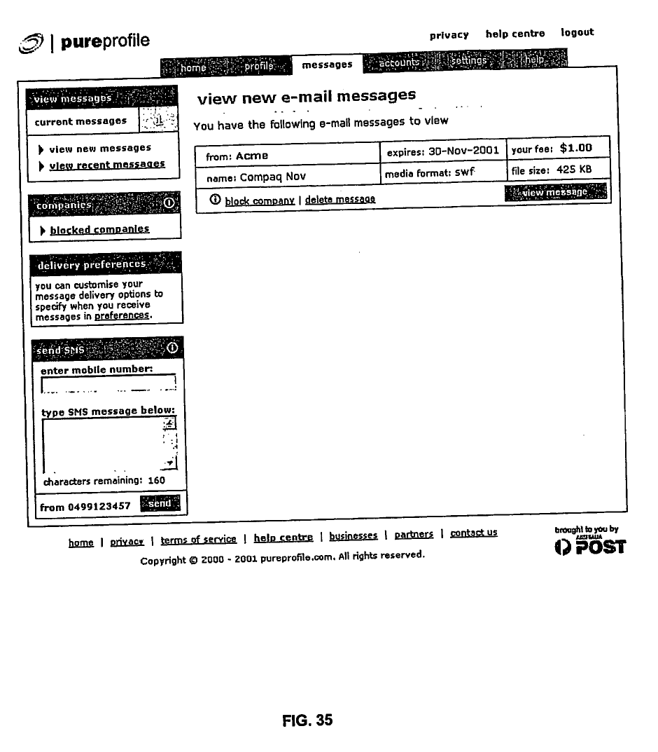

When the consumer logs into the web site, via the home page shown in FIG. 6, they are presented with a personalised home page (FIG. 34). By selecting the “view new messages” option in the top left hand corner, they are then provided with a “view new email messages” page (FIG. 35). Once they select a new email, it is displayed to them (like FIG. 30) and they can answer the questions posed by the promotional information, thereby providing consumer response information.

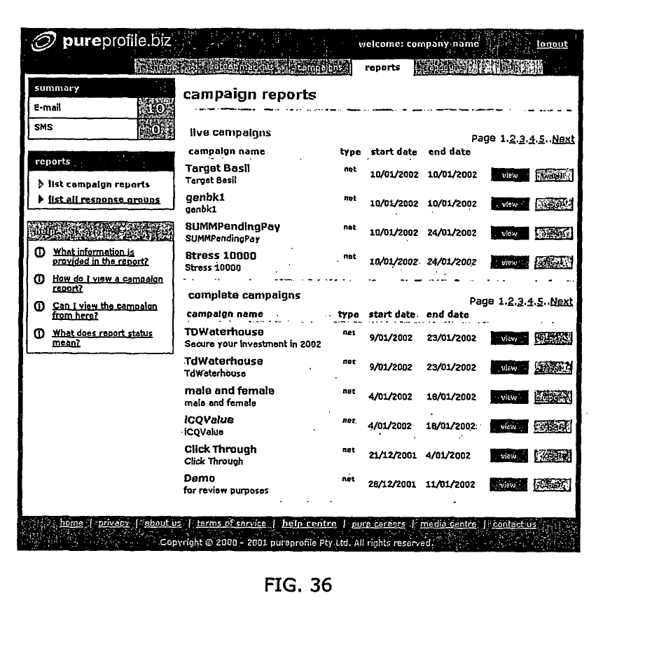

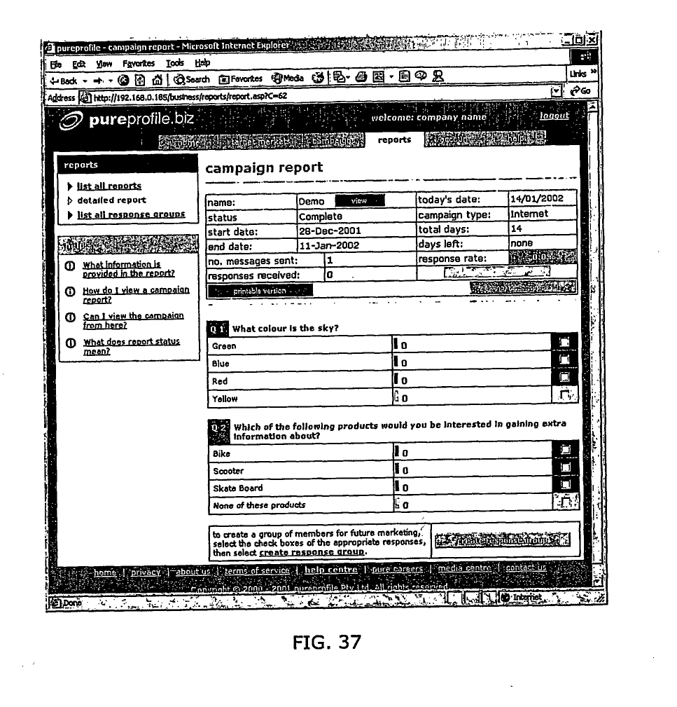

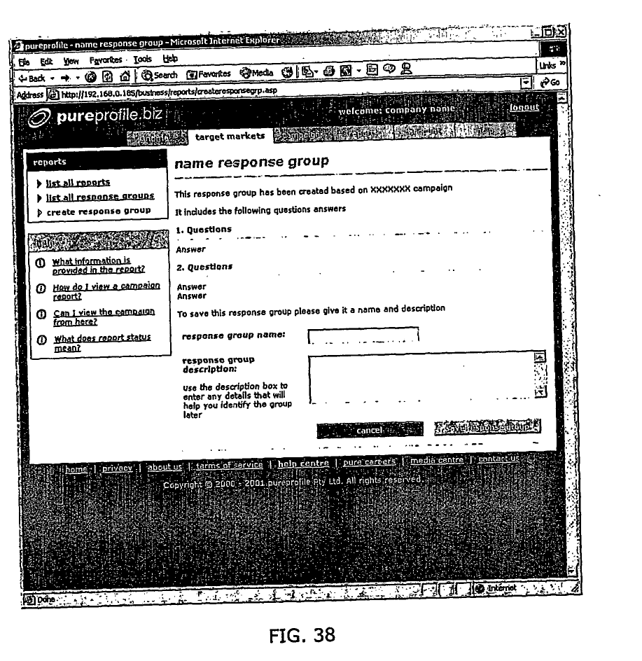

Once the consumer module 12 performs the step of receiving 25 the consumer response information, it passes that information to the business module which then performs the step of providing 26 the response result to the promoter via the business computer 5 connected to the network 3. The business module does this by providing an internet web site having a number of pages. These pages include a “Campaign reports overview” page (FIG. 36) and a “Campaign report details” page (FIG. 37). In this way, the promoter can see the number of consumers who responded to the promotional material and a summary of responses they gave to the questions asked. The site also includes a “Response group” page (FIG. 38) which allows the promoter to assign a name to the group of consumers who gave a particular response to a particular question or questions. In this way, when sending further promotional material, the promoter can target that particular response group with further promotional information which may be particularly useful or appealing to those consumers.

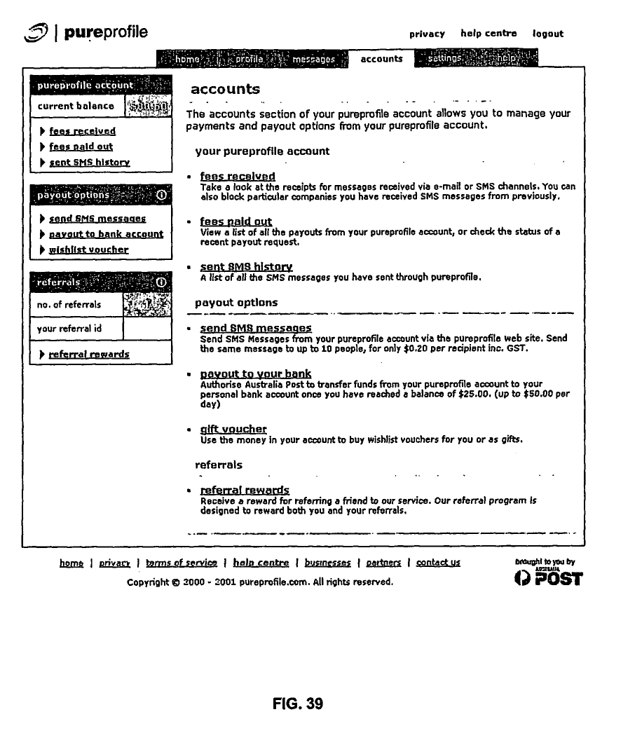

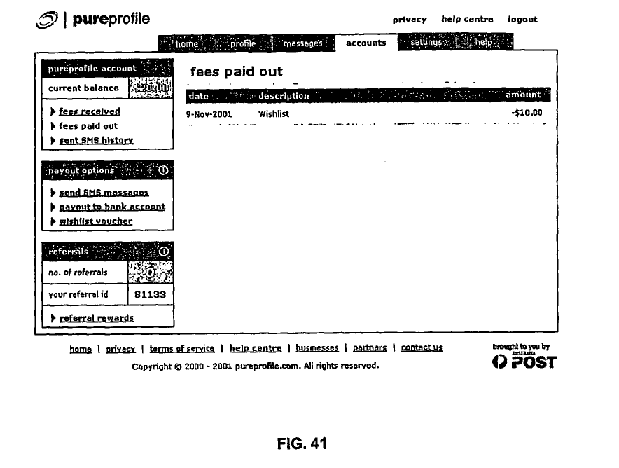

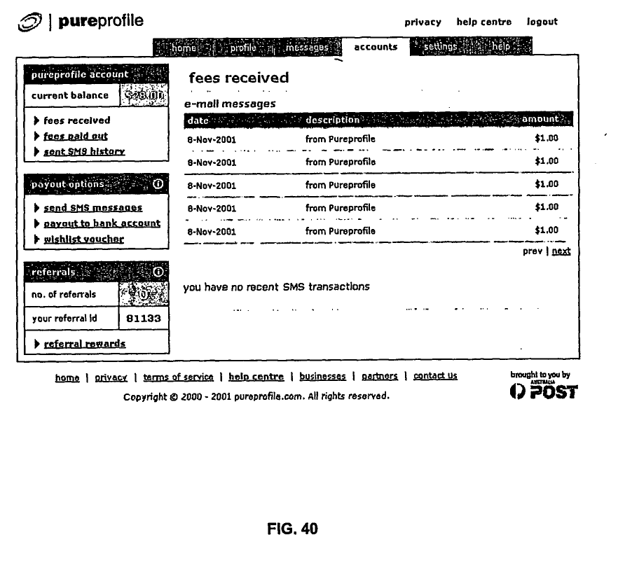

In the preferred embodiment, consumers are paid to respond to promotional information (in the case of an email) and to receive promotional information (in the case of an SMS message). Although in the preferred embodiment the payment takes the form of a monetary amount credited to the consumer's account, a variety of other means of rewarding a consumer are also envisaged. The consumer module 12 enables consumers to view and manage their consumer financial accounts using a number of pages. These pages include a “Consumer account” page (FIG. 39), a “Fees received” page (FIG. 40) and a “Fees paid out” page (FIG. 41).

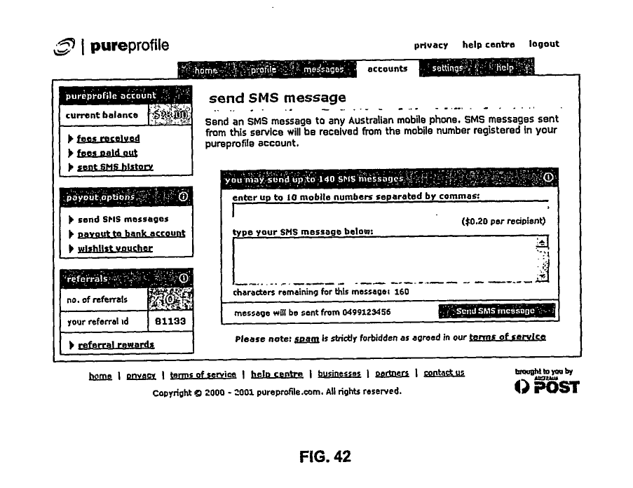

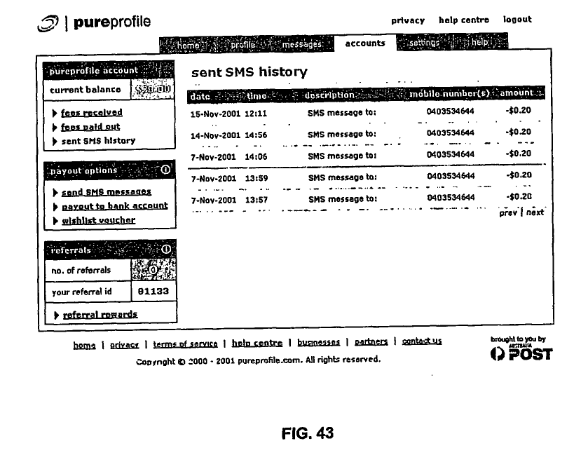

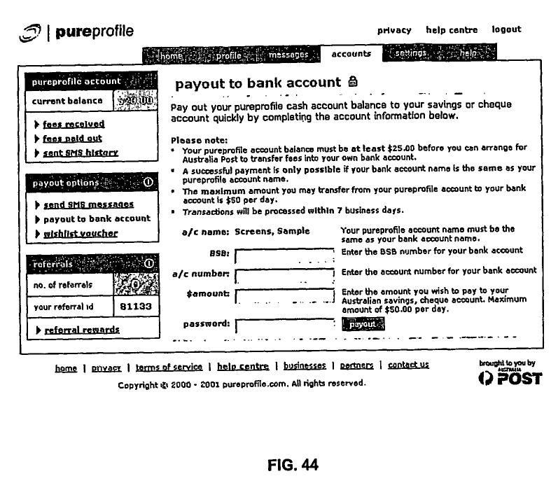

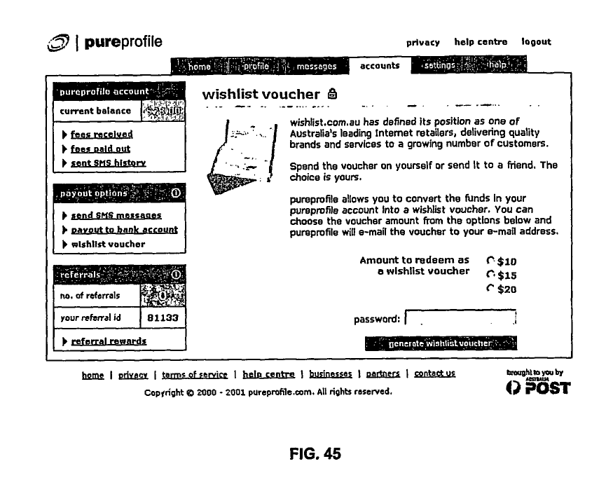

The consumer is able to redeem their rewards/payments in a variety of ways. One way is to send SMS messages via the system, each SMS message costing a small amount (such as $0.20 each) which is debited from their account. This is done using the “Send SMS message” page (FIG. 42) and the “Sent SMS history” page (FIG. 43). The consumer may have their money paid out to a bank account using the “Payout to bank account” page (FIG. 44) or may exchange it for a voucher via the “Wishlist voucher” page (FIG. 45). The consumer may have the amount credited to a petrol station account to allow them to effectively receive petrol at a reduced cost. In such a system, the petrol station may issue a stored value card to the consumer which is debited each time they get petrol. A variety of other redemption possibilities are also envisaged such as redeeming funds for payment of services, or donating the consideration to charity.

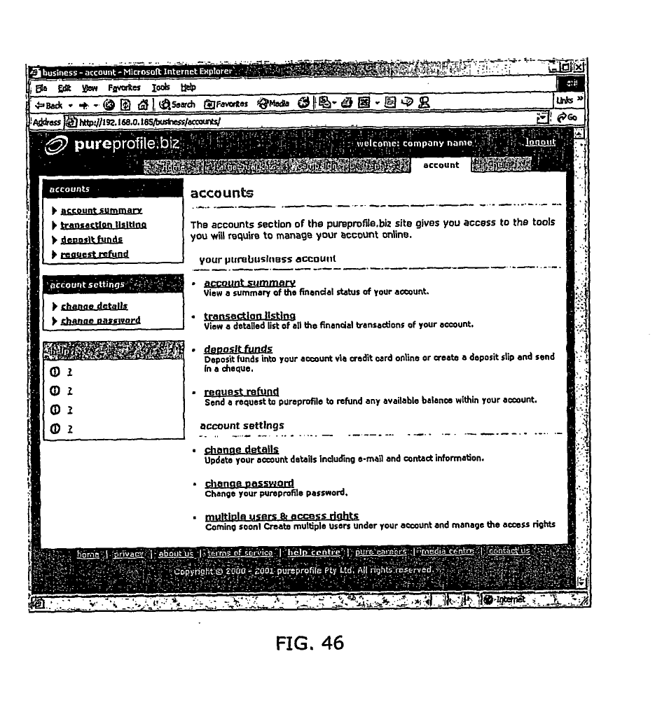

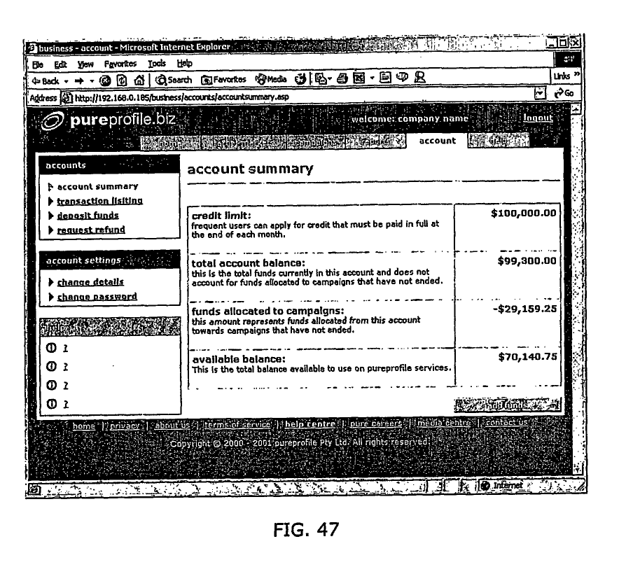

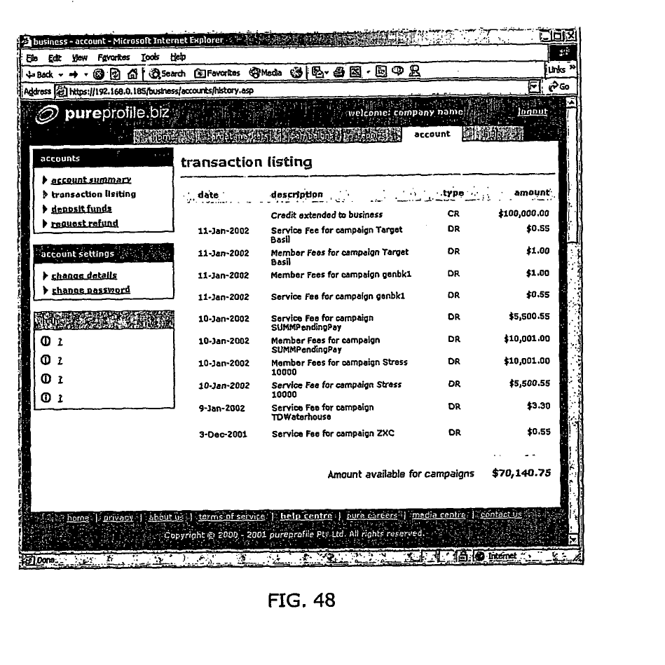

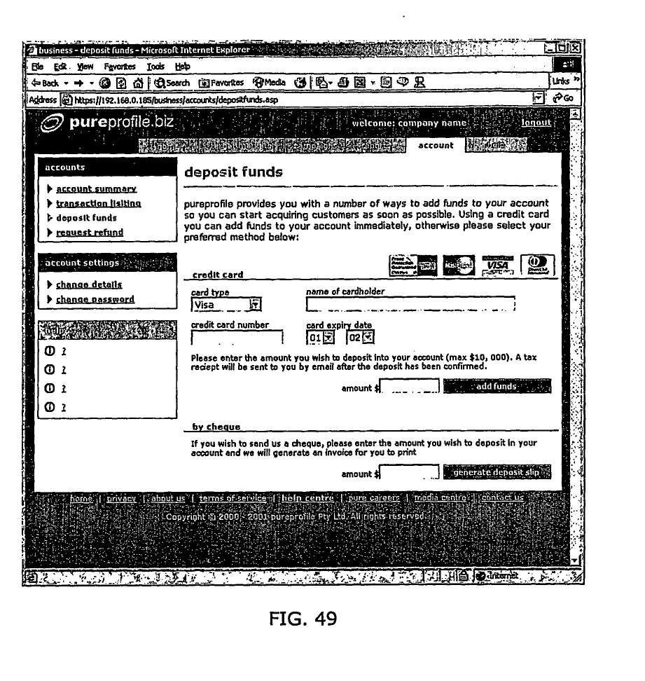

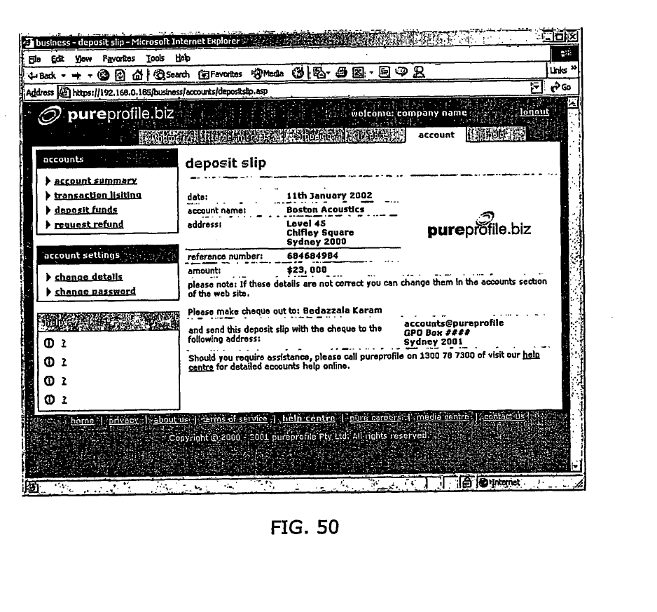

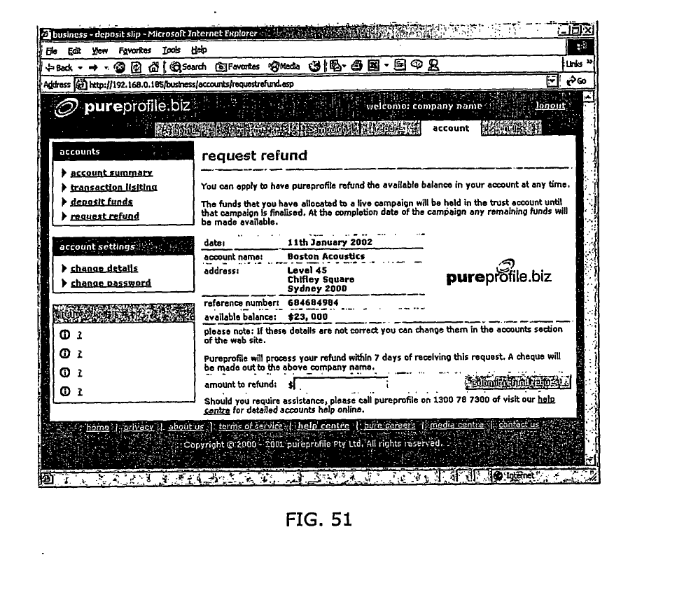

In a similar way, the business module 14 allows businesses to keep track of their spending on promotional campaigns via a set of business account pages. These pages include an “Accounts introduction” page (FIG. 46), an “Account summary” page (FIG. 47), a “Transaction listing” page (FIG. 48), a “Deposit funds” page (FIG. 49), a “Deposit slip” page (FIG. 50) and a “Request refund” page (FIG. 51).

In implementing the system, the inventors have set the following functional and non-functional requirements for their preferred embodiment. The following discussion is meant to be used merely as an example of one implementation of the system and references to “must” should be interpreted as “preferably.” Each of the following sections divides functionality into Tasks, Data and Rules.

Functional Requirements:

General

All users must be able to perform the following tasks:

G.T.1. View privacy policy
G.T.2. View terms of use
G.T.3. View F.A.Q.
G.T.4. View contact us
G.T.5. View about us
   Member
   Registration
   During the registration process all member must be able to perform the following tasks:
M.REG.T.1. View registration data
M.REG.T.2. Save registration data
M.REG.T.3. Update registration data
M.REG.T.4. Delete registration data
   Data

Data displayed or gathered during the registration process.

M.REG.D.1.

Fields
Country
Email Address
Rate to view an email
(Initially this will be read only and have a default value of $1.0)
Rate to view an SMS
(Initially this will be read only and have a default value of $0.50)
Password
Address 1
Address 2
State
City
Given Name
Postcode
Reminder Answer
Reminder Question
Street Number
Suburb
Surname
Connection speed
Credit Card Number

Business Rules
The member registration process must conform to the following requirements:
M.REG.R.1. Only after a member has successfully registered will they have access to all the sites functionality.
M.REG.R.2. Notified securely of their logon and password. Is sending an Email containing both logon and password considered secure?
M.REG.R.3. All data entered in the registration process cannot be queried by business.
M.REG.R.4. Check for invalid data.
M.REG.R.5. A user can only register once. Checking the following parameters:
   Account details
   Email Address
   Mailing address
   Mobile number
M.REG.R.6. Notified if their registration data has been modified.
M.REG.R.7. Notified securely of their activation code. Secondary level of security
   SMS and/or Email services must be activated separately.
   Activation medium must be identical to delivery medium
      Example
      The activation process of SMS will require the activation code to be sent via SMS.
M.REG.R.8. Log all modification to registration data. Data stored will include
   IP address
   Member ID
   Time modified.
   What was changed.
      Profile
      Members must be able to perform the following tasks with their profile.
M.PROF.T.1. Save their response to a specific profile question.
M.PROF.T.2. Modify their response to a specific profile question.
M.PROF.T.3. View the profile questions with their responses populated.
M.PROF.T.4. Undo their last changes to a profile question (before changes have been written to the DB)
   Data

Data displayed or gathered while profiling

M.PROF.D.1.

Fields
Question
Secondary question information
Question response

A detailed description of all possible questions can be obtained from profilequestions.doc
Business Rules
A profile must conform to the following requirements:
M.PROF.R.1. Answering profile questions is optional (This rule does apply to member preferences; this is dealt with in preferences)
M.PROF.R.2. A profile question will not have a default value.
M.PROF.R.3. It must be possible to return a profile question to its initial state.
M.PROF.R.4. A profile question can be either single response or multiple responses. In each case, the responses are selected from a defined list of responses.
   Ads
   Members must be able to perform the following tasks on an ad
M.ADS.T.1. View the contents/media of an advertisement
M.ADS.T.2. View all questions associated with an advertisement
M.ADS.T.3. Respond to all questions that make up an advertisement
M.ADS.T.4. View a summary of all unread advertisements
M.ADS.T.5. View a summary of all read advertisements
M.ADS.T.6. Forward an Ad
   Data

Data displayed or gathered while viewing an AD

M.ADS.D.1.

Fields
Advertiser (company name)
Amount earned for viewing the ad
Size of the ad
Media Type

Business Rules
An ad must conform to the following requirements:
M.ADS.R.1. The initial release must allow an advertisement to incorporate media of type jpg, gif, pdf or swf. Incorporating other media types will be considered in the next release)
M.ADS.R.2. If an advertisement has either
   Expired
   The maximum number of responses has been received
   Has a state other than live
      It will not be displayed in either the unread or read list of adverts.
M.ADS.R.3. Advertisements will be viewable in a browser.
M.ADS.R.4. Must not allow a member to respond to an ad more than once.
M.ADS.R.5. After responding to an ad the members account must be credited the amount indicated by the advertisement
M.ADS.R.6. Must watch the full length of a multimedia ad or five seconds of a static ad before being able to answer the questions.
   Information Request
   A member must be able to perform the following tasks on an information Request.
   Purecodes

Pure Codes are identifying codes which may be attached to any good, service, company or business name so that it can be used by consumers for information retrieval. The Pure Code may also be used by the promoter (who owns the code) as a profiling criteria. The promoter may use the Pure Code as a database management tool to reach their customers or potential customers with campaigns.

A member must be able to perform the following tasks on a Pure Code.

M.PN.T.1. Search for public Pure Codes based on business name or keyword.
M.PN.T.2. View a summary of all their Pure Codes.
M.PN.T.3. Deregister (unlink) an interest in any Pure Code.
M.PN.T.4. Register (link) an interest in any Pure Code (public or private).
M.PN.T.5. Add a Pure Code via email
M.PN.T.6. Add a Pure Code via an SMS
   Data

Data displayed or gathered while viewing a Pure Code

M.PN.D.1.

Fields
Pure Code
Company/Organisation the Pure Code belongs to
Description

Business Rules
Pure Code must conform to the following requirements:
M.PN.R.1. A member cannot search for private Pure Codes.
M.PN.R.2. A member can only include a private Pure Code to their profile if they specify its unique code.
M.PN.R.3. A member cannot include the same Pure Code more than once. (it can be unlinked and then linked)
M.PN.R.4. A member can only have up to 25 Pure Code registered at any one time.
   Accounts
   A member must be able to perform the following tasks on their accounts.
M.ACT.T.1. View a monthly history of their transactions
M.ACT.T.2. View their accounts details
M.ACT.T.3. View the last five (5) transactions.
M.ACT.T.4. Modify their payment options
M.ACT.T.5. Payout to a nominated bank account
M.ACT.T.6. Payout to a nominated charity
M.ACT.T.7. Payout to a nominated service provider
   Data

Data displayed or gathered while viewing their personal account

M.ACT.D.1.

Fields
Current Balance
Available Balance
Payment Option
Account Status
Name of the organisation the transaction will be paid by ‘Company Name’
Amount earned per transaction

Business Rules
An account must conform to the following requirements:
M.ACT.R.1. An account will have the following state
   Approved: operational
   The member can begin to transfer monies into a nominated account.
   Unapproved: non-operation
   The member may begin to accumulate monies. Monies cannot be transferred/cashed out
M.ACT.R.2. Payment Option will be read only. Initially transferring monies into a nominated personal bank, credit card account will be the only option available.
   NB: The ability to modify the members' payment option will solely depend on management developing the necessary partnerships.
M.ACT.R.3. The name registered with Pureprofile must match the name on the nominated account.
   Preferences
   A member must be able to perform the following tasks with their preferences
M.PREF.T.1. View preferences
M.PREF.T.2. Modify preferences
M.PREF.T.3. Save preferences
   Data

Data displayed or gathered with regards to preferences

M.PREF.D.1.

Fields
Bandwidth Used
Email message received in HTML only
Email message received in TEXT only
Receive SMS advertisements
SMS preference times
Receive Email advertisements
Receive Flash media
Maximum size of email advertisement
SMS Channel
Internet Channel
Interactive TV Channel
Postal
Telephone

Business Rules
The preferences must conform to the following requirements:
M.PREF.R.1. Cannot be manually queried by Business
M.PREF.R.2. Application automatically applies the preference data to filter appropriate campaign member
   Miscellaneous
   A member must be able to perform the following tasks.
M.MISC.T.1. Delete (themselves) unique member
M.MISC.T.2. Block advertisements from a nominated business
   SMS Messaging
   A member must be able to perform the following tasks.
1. Send an SMS message
   Business Rules
1. A sufficient account balance is required before a member will be allowed to send an SMS message.
2. Each SMS sent by a member will charged at a rate of 0.20 cents.
3. The cost of sending an SMS will be automatically deducted from the members' available balance.
   Data
   NA
   Business Rules
   All member data stored in pureprofile must be deleted.
M.MISC.R.1. Account details will remain archived.
M.MISC.R.2. A member must not receive any adverts from a blocked business.
   Business
   Registration
   During the registration process all business must be able to perform the following tasks:
B.REG.T.1. View registration data
B.REG.T.2. Save registration data
B.REG.T.3. Update registration data
B.REG.T.4. Delete registration data
   Data

Data displayed or gathered during the registration process.

B.REG.D.1.

Fields
Business Name
Industry
Street Number
Street Address
Suburb
City
Country
State
Post Code
Email Address
Give Name
Family Name
Position
Password

Business Rules
The registration process must conform to the following requirements:
B.REG.R.1. Only after a business has successfully registered will they have access all the sites functionality.
B.REG.R.2. Businesses will need to be notified securely of their logon and password.
B.REG.R.3. A business will not be able to deploy a campaign until Pureprofile has verified their identity.
B.REG.R.4. Check for invalid data
B.REG.R.5. A business can only register once.
   Target Markets
   A business must be able to perform the following tasks with a Target (profile) Market:
B.TARG.T.1. Save a target market
B.TARG.T.2. Edit an existing target market
B.TARG.T.3. Delete an existing target market.
B.TARG.T.4. View a summary list of their target markets
B.TARG.T.5. View the target market criteria
   Data

Data displayed or gathered in relation with target markets.

B.TARG.D.1.

Fields
Size
Cost
Name
Description
Profile questions
Profile response

Business Rules
Target markets must conform to the following requirements:
B.TARG.R.1. A one to one relationship must exist between the each profile question response displayed on the member side and to the profile question response combination displayed on the business side.
B.TARG.R.2. A member must match all criteria selected in a target market
B.TARG.R.3. A member must only be counted once
B.TARG.R.4. Target (profile) markets are based on the responses members have saved to their profile.
   Response Groups
   A business must be able to perform the following tasks with a Response Group
B.RESP.T.1. Save a response group
B.RESP.T.2. Delete a response group
B.RESP.T.3. View a summary of responses
   Data

Data displayed or gathered while viewing the response groups.

B.RESP.D.1.

Fields
Name
Size
Cost
Lasted updated

Business Rules
Response groups must conform to the following requirements:
B.RESP.R.1. Once the response group is created it becomes read only.
B.RESP.R.2. Response groups will be based on a members specific campaign response
   Internet Campaign
   A business must be able to perform the following tasks with a campaign
B.CAMP.T.1. Save a campaign
B.CAMP.T.2. Edit a campaign
B.CAMP.T.3. Delete a campaign
B.CAMP.T.4. View a campaign
B.CAMP.T.5. View a preview of the campaign. (media, questions and responses)
B.CAMP.T.6. Add or block profile markets
B.CAMP.T.7. Add or block response groups
B.CAMP.T.8. Add or block Pure Code groups
B.CAMP.T.9. Upload media
B.CAMP.T.10. View uploaded media
B.CAMP.T.11. Add campaign questions
B.CAMP.T.12. Modify campaign questions
B.CAMP.T.13. Add campaign question responses
B.CAMP.T.14. Modify campaign question responses
B.CAMP.T.15. Select the type of response i.e. check boxes or radio buttons
B.CAMP.T.16. Modify the type of response i.e. check boxes or radio buttons
B.CAMP.T.17. Deploy campaign
   Data

Data displayed or gathered in a campaign

B.CAMP.D.1.

Fields
Start Date
End Date
Maximum budget of the campaign
Questions
Responses
Name
Description

Business Rules
A campaign must conform to the following requirements:
B.CAMP.R.1. A campaign can only have the following states.
   Unavailable: Business is in the process of creating a campaign and has not executed the campaign.
   Ready: Business has executed the campaign and the campaign is awaiting Pureprofile approval.
   Approved: Has been approved by Pureprofile and has not been sent to its intended target market
   Rejected: Campaign has note met Pureprofile standards and has been sent back to the campaign creator.
   Live: Campaign has been sent to the intended target market
   Revise: Campaign has initial been rejected and has been resubmitted by business for approval.
B.CAMP.R.2. Uploaded media can be no larger than 2 MB
B.CAMP.R.3. Can only upload media of type jpg, gif, pdf, swf, mov, mpg or a URL
B.CAMP.R.4. Contains a maximum of 3 questions
B.CAMP.R.5. Contains a maximum of 4 responses per campaign question
B.CAMP.R.6. A campaign can be deployed without media.
B.CAMP.R.7. An assigned pureprofile employee will manually change the state of a campaign.
B.CAMP.R.8. Only when the campaign has progressed to a ‘live’ state It will be deployed to its registered members.
B.CAMP.R.9. Campaign questions can only be radio button or check boxes
B.CAMP.R.10. Adding markets in a campaign. An example will be used to illustrate the concept.
   Assume we have 3 markets
   M1
   M2
   M3
   The process of adding M1 and M3 will mean that the final list of targeted members will belong to either M1 or M3. it will also include members that belong to M2 so long as they also belong to M1 or M3.
B.CAMP.R.11. Blocking markets in a campaign. An example will used to illustrate the concept.
   Assume we have 3 markets
   M1
   M2
   M3
   The process of blocking M1 and adding M2 will mean that the final list of targeted members will not belong to M1. Irrespective if they also belong to M2. Therefore members that belong to M2 and not M1 will be selected.
B.CAMP.R.12. Neither Add or Block
   If the markets have not been selected they will not be included in the final list of members that belong to a campaign. However, a member that belongs to a add market can also belong to a market that has not been selected.
B.CAMP.R.13. Irrelevant if we are adding or blocking markets, response groups or Pure Codes. A member must only be counted once.
B.CAMP.R.14. A campaign can be deployed to members who belong to either of the following logical groups.
   Response groups
   Pure codes
   Target markets
B.CAMP.R.15. A campaign cannot run for a period greater than 2 weeks.
B.CAMP.R.16. A campaign cannot be deployed unless it satisfies all of the following criteria
   Has at least one question
   Has a start and end date
B.CAMP.R.17. While compiling a campaign a business must have access to all of its response groups, target (profile) markets and Pure Code groups
B.CAMP.R.18. A partially completed campaign can be saved.
B.CAMP.R.19. It will only be possible to modify the campaign attributes if it is in either unavailable or revise state. All other states will make the campaign read only.
B.CAMP.R.20. There are two (2) types of campaigns
   Set and forget
      Allows the business to enter the standard campaign parameters. This must include duration, maximum amount chargeable to business and the maximum members that will receive the campaign.
      Steps are as follows
         1. Deploy too existing members; after which the remainder of the campaign funds are used to,
         2. Deploy to new members that match the campaign criteria.
   Immediate
      Allows the business to create a campaign and deploy immediately it to all members that match the campaign criteria
B.CAMP.R.21. Campaign End Date must be greater than Start Date
B.CAMP.R.22. Campaign budget is not a mandatory field. If the budget is not specified by the business the maximum budget is set to the calculated cost of the campaign. Otherwise the value entered would be the budget utilized by the application. Either way this value is locked in once the business has submitted the campaign.
B.CAMP.R.23. The maximum number of people the campaign can be deployed to will be determined by the campaign budget.
B.CAMP.R.24. Previewing a campaign must display the following data.
   Questions
   Responses
   Media
B.CAMP.R.25. Campaign Start Date must be greater than or equal to the current date.
   Reports

Response

A business must be able to perform the following tasks on a report.

B.REP.T.1. View the report
B.REP.T.2. View a summary of available reports
B.REP.T.3. Print the report
   Data

Data displayed in the report

B.REP.D.1.

Fields
Campaign Name
Total size of the campaign market
Cost to date this equates to the cost of all the members who have
respond to the campaign
Date the campaign was executed (deployed)
End date of the campaign
Total numbers of members who have respond to the campaign
Campaign state

Business Rules
A report must conform to the following requirements:
B.REP.R.1. Contain the campaign questions.
B.REP.R.2. Contain the total number of responses for each question response. This must be presented both numerically and as a percentage.
B.REP.R.3. Contain the total number of responses to the campaign
B.REP.R.4. Display the report numerically
B.REP.R.5. Display the report graphically
B.REP.R.6. Contain campaign responses
B.REP.R.7. The state of the campaign can be mapped to the requirement B.CAMP.R.1
   Pure code
   A business must be able to perform the following tasks on Pure Codes.
B.PN.T.1. View a list or Pure Codes
B.PN.T.2. Create a Pure Code.
B.PN.T.3. Edit the details of an existing Pure Code
B.PN.T.4. Delete an existing Pure Code
   Data

Data displayed or gathered for a Pure Code

B.PN.D.1.

Fields
The number of members registered to a specific Pure Code
Status (Private or Public)
Name
Unique Pure code
Description
Keywords

Business Rules
A Pure Code must conform to the following requirements:
B.PN.R.1. Unique
B.PN.R.2. Searchable on company name
B.PN.R.3. Searchable on keywords
B.PN.R.4. Either private or public
B.PN.R.5. Unless the business decides to pay for the right to generate their own Pure Code the Pure Code will be generated by the application
B.PN.R.6. A business may nominate a unique Pure Code.
   Account
   A business must be able to perform the following tasks on accounts.
B.ACC.T.1. View account details
B.ACC.T.2. View history of recent transactions
B.ACC.T.3. View recent (last 5) transactions
B.ACC.T.4. Deposit funds into their account via credit card. (online)
B.ACC.T.5. Deposit funds into their account via BPAY
B.ACC.T.6. Deposit funds into their account via cheque
B.ACC.T.7. Deposit funds into their account via AusPosts Pay@Post service
B.ACC.T.8. View the invoice of the payment transaction
B.ACC.T.9. Print an invoice
   Data

Data displayed or gathered for an account.

B.ACC.D.1.

Fields
Account balance
Outstanding balance
Campaign names
Campaign cost

Business Rules
An account must conform to the following requirements:
B.ACC.D.1. In one embodiment businesses will be charged the minimum fee for each individual message deployed and received by a member.
B.ACC.D.2. In that embodiment only if a member responds to a campaign will the businesses incur the total cost of a member's attention. In an alternative embodiment the business is not charged to send messages to members, it is only charged for those messages to which a member responds. As responses come in, the business' financial account is debited accordingly.
B.ACC.D.3. Depending on the type of campaign businesses will be charged the greater of the two (2)
   Email Campaigns
      30 cents or
      30% of the charge incurred by the member
   SMS Campaigns
      20 cents or
      40% of the charge incurred by the member
B.ACC.D.4. An account transaction can have the following status levels
   Paid
      Once money is received
   Outstanding
      Less than 30 days since payment
   Overdue
      Less than 60 days, greater than 30 days since payment
B.ACC.D.5. Businesses will be able to redeem money not used in a campaign.
B.ACC.D.6. GST will only be payable on the service fee and not the member payment.
B.ACC.D.7. A Biller Code and Reference ID
   The Reference ID must comply with the standards outlined in the BPAY documentation
   Biller Code assigned by BPAY
      Short Message Service
      A business must be able to perform the following tasks on a SMS campaign.
B.SMS.T.1. Add or block profile markets
B.SMS.T.2. Add or block response groups
B.SMS.T.3. Add or block Pure Code groups
B.SMS.T.4. Deploy an SMS campaign
B.SMS.T.5. Enter Message
   Data

Data displayed or gathered for an SMS

B.SMS.D.1.

Fields
Message (includes the question text)
Type of SMS
Start Date
Start Time
End Date
Budget

Business Rules
An SMS must conform to the following requirements:
B.SMS.R.1. A business can only send two (2) types of SMS campaigns
   Campaign
   information Request
B.SMS.R.2. Total message length 160 characters
B.SMS.R.3. A 25-character default message will be sent with each SMS. Message: from pureprofile.com
B.SMS.R.4. The maximum length of the message is 135 characters
B.SMS.R.5. An SMS will only be sent to members who have nominated a preference for this service.
B.SMS.R.6. Member must have a valid mobile number
B.SMS.R.7. A list of messages not received will be sent by the SMSC. This will be used to:
   Eliminate non-existent numbers
   Validate that all messages have been received.
   Finalise cost to business
B.SMS.R.8. SMS campaigns will be sent in real-time.
B.SMS.R.9. SMS information requests must be processed immediately.
B.SMS.R.10. The rate of which business will be charged for a campaign SMS will vary to that charged for an email campaign. On the initial launch the rate will be a flat 90 cents. (50 cents paid to the member, 20 cents the cost of the SMS, 20 cents charged to business)
   A member will not be paid for an information request

Non-Functional Requirements:

Software

The application will be implemented using the following software packages.

Windows 2000 Advanced Server

Visual Basic 6.0/COM/MSMQ

IIS 5

SQL Server 2000

Numbers

Business Volumes and Sizing

Below is a table summarising the average expected volumes on any specific day. This data is based on well-known user surfing habits. (Reference: Nielson Net Ratings).

The application will need to adequately support 500 simultaneous users.

| | User Volumes |
|---|---|
| Period | (Percentage for the day) |
| 1.00 to 2.00 | 13% |
| 2.00 to 3.00 | 9% |
| 3.00 to 4.00 | 6% |
| 4.00 to 5.00 | 4% |
| 5.00 to 6.00 | 4% |
| 6.00 to 7.00 | 9% |
| 7.00 to 8.00 | 16% |
| 8.00 to 9.00 | 24% |
| 9.00 to 10.00 | 31% |
| 10.00 to 11.00 | 38% |
| 11.00 to 12.00 | 39% |
| 12.00 to 13.00 | 39% |
| 13.00 to 14.00 | 39% |
| 14.00 to 15.00 | 41% |
| 15.00 to 16.00 | 42% |
| 16.00 to 17.00 | 43% |
| 17.00 to 18.00 | 44% |
| 18.00 to 19.00 | 43% |
| 19.00 to 20.00 | 43% |
| 20.00 to 21.00 | 45% |
| 21.00 to 22.00 | 47% |
| 22.00 to 23.00 | 41% |
| 23.00 to 24.00 | 32% |

Security
Pureprofile handles confidential personal information therefore security procedures and practices must be complete and thorough. The ability to secure our users data will be widely publicised on our web site.
Data to be protected
Pureprofile will need to secure all data entered. No data will be accessible without basic user authentication (logon and password)
Data labelled sensitive will require additional encryption technology. SSL is the preferred client/server authentication protocol. The use of digital certificates for registered businesses will be considered at a later stage.

Sensitive member data is displayed in the table below. This information will be gathered at the point of registration.

Fields
Country
Email Address
Rate to view an email (initially this will be read only and be
preset to $1.0)
Rate to view an SMS (Initially this will be read only and be
preset to $0.50)
Password
Address 1
Address 2
State
City
Given Name
Postcode
Reminder Answer
Reminder Question
Street Number
Suburb
Surname
Connection speed
Credit Card Number

Sensitive business data displayed in the table below will be gathered at the point of registration.

Fields
Country

Threats to data
Accidental/Deliberate corruption or destruction
The possibility of losing data is real and may have a direct impact on Pureprofiles ability to function commercially.
Nightly backups of the database will mitigate the loss of data. All backups will be stored off site.
Fraud
Maintaining the integrity of database will only be possible if Pureprofile can certify that
A member has only registered once.
A business is identifiable.
   Viruses
   The installation of software and the use of strict procedures will be imposed on the production environment.
   Threats to physical security
   Initially the application will be hosted at a third party location. This exposes our data and I.P. to employees outside our organisation. Management will only consider hosting the application on a site that has a proven record of providing high quality services in a secure environment.
   Auditability
   It is Pureprofiles' intention to allow a third party to audit the companies' security procedures. A quarterly audit will reinforce our commitment to ensuring our users privacy.
   General policies
Members own their personal data. Hence apart form account records which must be kept for a period of 7 years their have the permission and ability to remove all their data from our application.
A business will only be able to access its own information.
A member will only be able to access its own information
Only registered members will be able to access all functionality associated with the member side.
Only registered business will be able to access all functionality associated with the member side.
All data stored on our database, application and web servers must only be accessible to personal with the necessary access privileges.

Search Engine Keyword Capture

A further embodiment of the present invention is described below.

In this embodiment existing consumers having their identity information and profile information stored in the database (“pureprofile Account Holders”) are able to opt-in to allow the system to capture certain search interface activity into their profile records. In this way these existing consumers are able to increase the value of their profile to businesses, by making their profile information even more specific to the consumer's interests.

The service will allow an internet search engine to sell advertisers a direct, yet anonymous (and privacy compliant) connection to specific pureprofile Account Holders who have utilised the internet search engine web site. Keyword searches and category click throughs can be tracked and made available to the internet search engine in the form of aggregated pureprofile target markets.

The internet search engine will then be able to offer access to these valuable target markets exclusively to its clients for the purpose of outbound direct marketing through the pureprofile service. The internet search engine target markets can also be made available through pureprofile.biz, the self service business site of the pureprofile service.

These target markets can be further enhanced by applying them against the existing profiles created by pureprofile Account Holders.

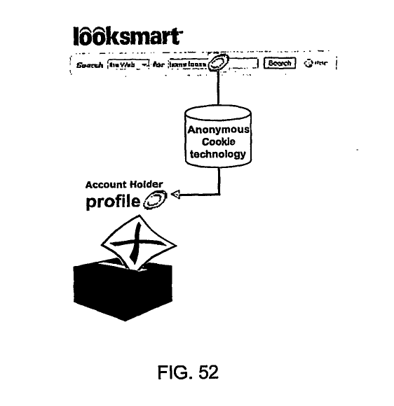

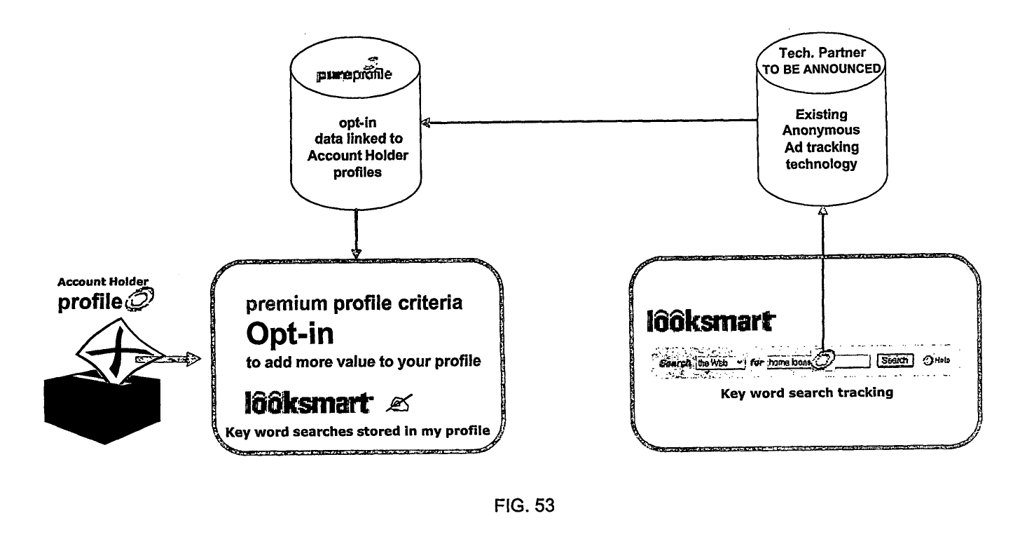

An example of how the system works is described below and with reference to FIGS. 52 and 53.

pureprofile Account Holders select to have their key word searches anonymously tracked through the internet search engine network, through an opt-in tick box within their profile (which can be changed at any time).

The same Account Holder later enters the search words “home loans” on a search interface, such as the internet search engine website interface, as seen in FIG. 52.

This keyword will be added to the Account Holder's profile. The Account Holder is also added to internet search engine's proprietary pureprofile target market called “home loans” which is made up of pureprofile Account Holders who have entered those particular search words.

The internet search engine can offer these target markets to any business through pureprofile.biz, the self service business site of the pureprofile service.

To provide further accuracy and micro targeting, businesses simply select the key words they would like to target with other profile criteria already captured by pureprofile.

For example, a particular target market may be created (and saved) by a NSW based home loans company comprising of:
the key words “home loans” [symbol] plus;
the profile criteria NSW [symbol] and;
between the ages of 21 [symbol] and 45 [symbol] .

The business who created and saved this target market could then send a pureprofile paid campaign automatically or periodically to these pureprofile account holders.

pureprofile and the internet search engine would charge a higher than normal fee to these businesses for their highly targeted campaigns on a per message sent basis.

In addition, consumers who are not yet signed up to the pureprofile service can be invited to become pureprofile members when they use a particular search engine. As soon as they accept the invitation, they are provided with an interface in which they can enter their profile information and, from then on, whenever they search on that search engine, their keywords are added to their profile.

In alternative embodiments, not only can a consumer's keywords be tracked, but their other web surfing habits may also be tracked. For example, the system may register when the consumer visits a particular URL, such as a home loan site. That URL is added to their profile, indicating that the consumer is interested in home loan information. Businesses can then send promotional information to those consumers who visited the particular home loan site without the business receiving any identifying information about the consumer.

An overview of the system is further illustrated in FIG. 52.

In implementing the system, the inventors have set the following functional and non-functional requirements for their preferred embodiment. The following discussion is meant to be used merely as an example of one implementation of the system and references to “must” should be interpreted as “preferably.”

Functionality

Account Holder

Implementing a transparent and easy to maintain solution requires pureprofile to provide the following account holder functionality.

List affiliated tracking sites
Identify the sites that the account holder has nominated to be tracked against.
Create and delete tracking cookies
View and delete recent keyword searches
   Requirements
All account holder activity must be time stamped
An account holder must opt into the keyword tracking solution; the data will be stored in the pureprofile database and can be accessed at anytime by pureprofile Account Holders via the pureprofile consumer website.
Only unique keywords will be assigned to each account holder, if the keyword exists the time stamp will be updated
The keywords inserted into the pureprofile database will reflect the internet search engine keywords or internet search engine keyword reference numbers.*
   Business
   Functionality to create a target market based on keyword entries, this will require businesses to be able to search for and isolate the appropriate account holders.
Search for specific keywords
Create target markets based on one or a number of keyword entries
   Requirements
(a) One or more keyword terms may be used in the definition of the keyword based target markets
(b) Multiple keyword terms will be ‘Or’ when calculating matching account holders
Account holder keywords will correspond to the internet search engine categories and topics
Only if the data can be provided by the internet search engine
   Keyword Monitoring Methodology

The following methodology will allow the pureprofile team to monitor and track pureprofile Account Holders that have opted into our third party tracking solution.

pureprofile logo appearing on the internet search engine

1. Indicates that this current page has been enabled with pureprofile tracking
2. The logo will only be displayed for account holders that have opted-in to capture their activity on the internet search engine site.
   Tracking
3. The pureprofile logo will also be used to transfer the details of the current account holders' activity to pureprofile.
4. Where possible the pureprofile logo will only transfer the keywords to pureprofile on the initial results page. After which a static image may be referenced—as no tracking is required the image may be served from the third party.
5. Only pureprofile account holders who have opted-in to this solution will be monitored.
   Cookies
6. Each individual site that requires tracking will require a unique cookie
7. Each search site cookie will store an encrypted member id and site id. This information will be transferred to pureprofile with each corresponding keyword search.
8. The cookie will expire within 2 months (the date may be modified)
9. Each participating site will be required to host the code required to:
   create the keyword monitoring cookie
   delete the keyword monitoring cookie
The contents (member id) of each cookie will be passed in via the query string
   Authentication
10. all account holder activity will be authenticated against our internal list of valid sites and pages.
   Example

An example of a solution using the methodology outlined above is described in brief.

Third Party Site

The src html property will allow the participating keyword tracking site to seamlessly transfer pureprofile account holder information into the pureprofile application. A possible solution may require the query string to be transferred in the following format.

<img border=“0” width=30 height=30 src=“http:// . . . /tracking.asp?a=1&S=2&keywords=home+loans&category=loans”>

pureprofile

The URL referenced/responsible for tracking pureprofile account holder activity will be primary responsible for inserting the transferred data and serving the pureprofile logo. Basic logic is displayed below.
Step 1: insert Keyword/Navigation Transaction
   Retrieve query string data
   insert data
Step 2: Server Image
   Response.Expires=−1
   Response.ContentType=“image/gif”
   <!--#include virtual=“/images/drk_orange_small.gif”-->
      Cookie Management

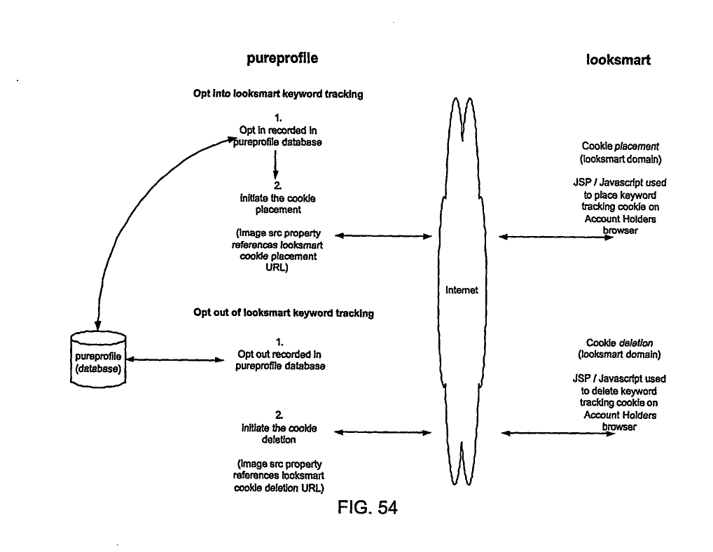

Cookie management ensures that an account holder may place or remove the necessary internet search engine cookie. Utilising the src html tag will allow us to implement the functionality in a seamless fashion. FIG. 54 will highlight the necessary components and flows required for this implementation.

Keyword Management: Account Holder

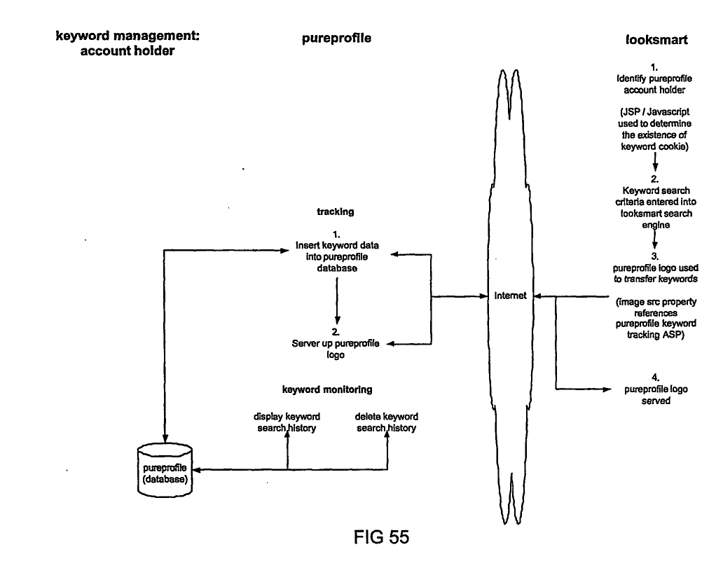

FIG. 55 highlights the major components and process flows required to successfully implement, identify, capture and store keywords entered by pureprofile account holders.

Performance Impact

Application Server

ASP and COM+ components will be required to retrieve (decrypt) the account holder id, site id and page id.
Serving the pureprofile logo.
   Database
Keywords*
   Pureprofile will be required to insert a keyword transaction for each account holder that has performed a keyword search using the internet search engine.
      Internet Search Engine Requirements
      Page Alterations
A pureprofile logo will be displayed on all pages that monitor the pureprofile account holders' keyword searches or navigation
   The pureprofile logo will be displayed only after enabling the internet search engine keyword search tracking mechanism
The execution of client side or server side code can be used to extract or check for the existence of internet search engine-pureprofile cookie
keyword tracking will be passed into a predefined query string name value pair i.e. the pureprofile logo
   http:// . . . /tracking.asp?site=“siteid”&keyword=“key”& page id=“page id”
      Site Parameters
Internet search engine keywords are stored in the query string item “key”
Cookie used to identify the pureprofile account holder.
   Reference Material

http://java.sun.com/docs/books/tutorial/servlets/client-state/cookies.html

Additional Suggestions for Implementation of Preferred Embodiment Account Holder Control

The benefit of providing a pureprofile account holder with additional control over when their keywords will be transferred will be assessed.

A possible solution may involve setting a Boolean flag within the keyword cookie, a true state indicating keyword searches will be transferred to pureprofile.

The action of clicking the pureprofile icon will alternate the status of the cookie. This means if a pureprofile Account Holder does not wish for key words to be tracked, a simple click will turn off the passing of any information to the Account Holders pureprofile Account.

Multiple Account Holders per Computer

A single cookie is created per domain; as such multiple account holders may be sharing a single cookie. Hence, the data collected may not reflect the account holder the cookie is assigned to.

Businesses will be required to select certain profile demographic criteria which will act as a filter, hence reducing the impact of any inconsistent targeting.

Public Computers

A public domain cookie will send through irrelevant information.

Prior to creating a pureprofile tracking cookie the account holder should be warned that they should not create the cookie on a public machine; the cookie created will have an expiration date.

Placing Cookie on Third Party Computer

An individual may log on to the computer of another account holder and opt-in for keyword tracking.

May consider including the account holder's referral no. with each cookie, the information may be displayed in the alt image tag.

Categorise Keyword Searches

Account Holder keyword searches will be categorised into the existing internet search engine keywords and categories. This level of integration will have the following benefits.
Allow businesses registered on the internet search engine to easily target pureprofile account holders with the exact keywords used to retrieve their businesses in the internet search engine.
A one to one mapping between the keywords used by businesses on the internet search engine site and those entered into the pureprofile application.
Most internet search engines do not store profanities, thus eliminating the need for pureprofile to cleanse the keyword searches.

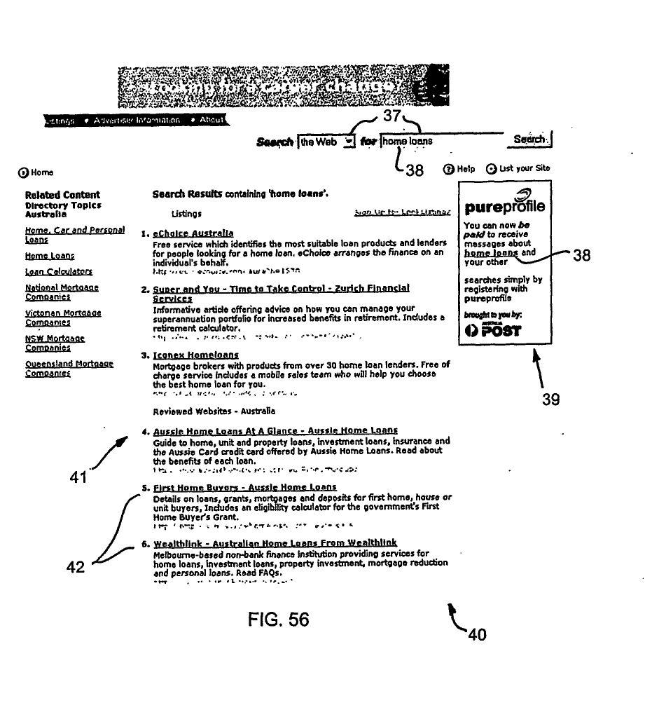

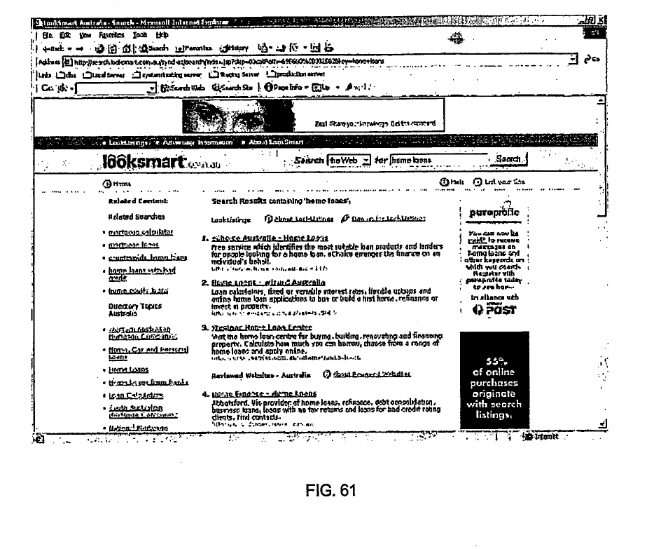

FIG. 56 shows an example search interface 40 having a search field 37 adapted to receive a keyword 38 from a consumer and a selectable region 39 adapted to be selected by the consumer. The search interface 40 also includes a search display 41 for displaying search results 42. An updated example of the search interface is shown in FIG. 61.

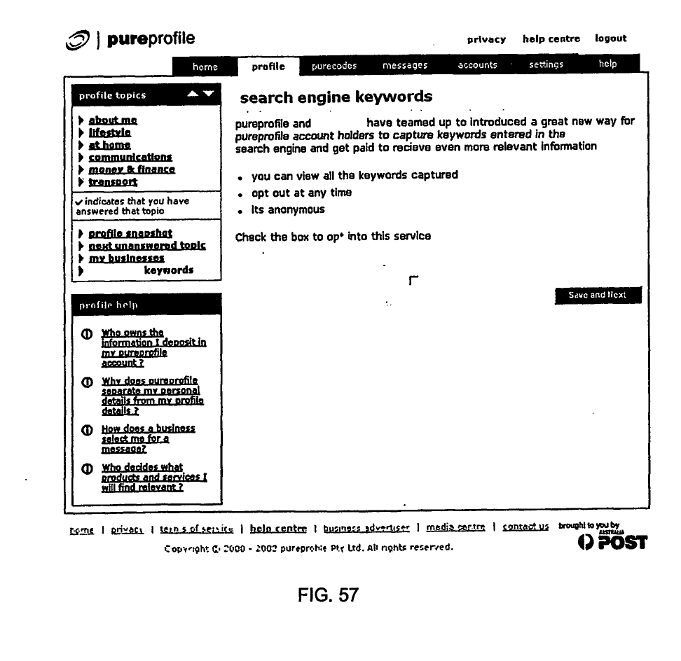

FIG. 57 shows an example consumer interface illustrating the way in which existing consumers may opt in to have their keywords tracked by the interface monitor.

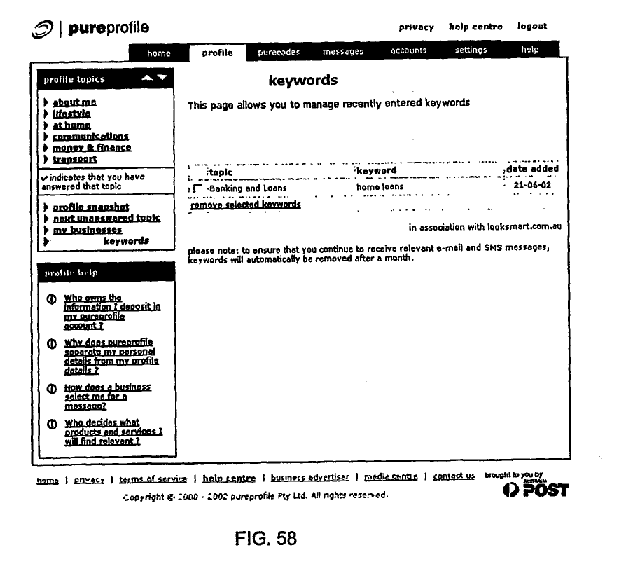

FIG. 58 shows an example of another section of the consumer interface illustrating the way in which existing consumers may manage and control the keywords that have been automatically saved in their profile records.

An alternative description of the keyword tracking aspect of the present invention appears below. This description is intended to supplement that provided above.

Keyword Monitoring Methodology

The following methodology allows the inventors to monitor and track pureprofile Account Holders who have opted into the keyword tracking solution.

Opting in to the Keyword Tracking Solution

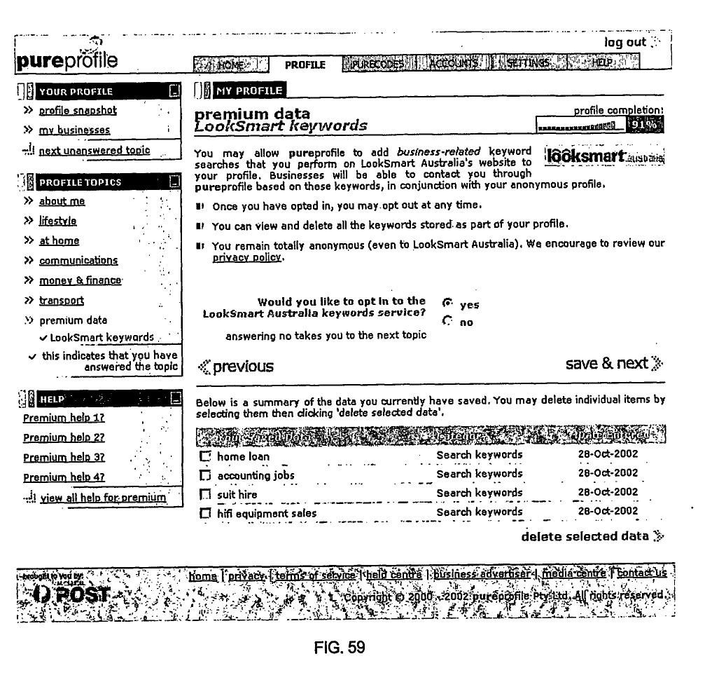

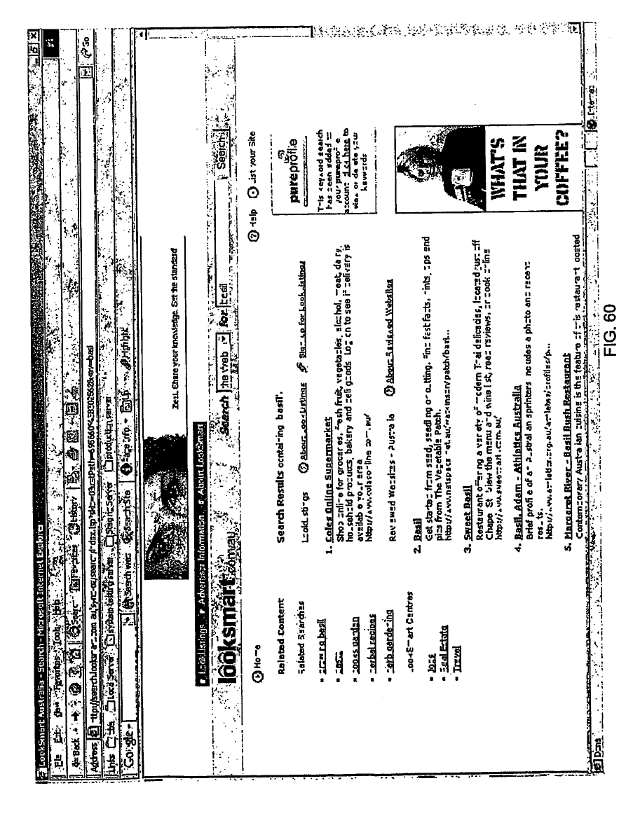

Pureprofile account holders are shown a page explaining the service and asking them if they would like to participate. An example of such a page is shown in FIG. 59. If they voluntarily opt in to the service, a search engine cookie is dropped on to their machine which will allow the search engine to identify the user as a pureprofile account holder when they next perform a search in the search engine.
The search engine server hosts the code required to either modify or create a search engine cookie. The cookie data includes a unique pureprofile account holder ID.
A query string parameter is used to pass the pureprofile account holder ID between pureprofile and the search engine
A query string parameter is used to define the reply path after the search engine has created the cookie.
   Opting Out of the Keyword Tracking Solution
The search engine server hosts the code required to delete all search engine cookies.
The pureprofile site will make a request for this code to be executed when required.
   Identifying Pureprofile Account Holders on the Search Engine Site
The cookie used during the opt-in process is also be used to identify pureprofile account holders using the search engine site.
A pureprofile logo is preferably displayed on all pages that monitor the pureprofile account holders' keyword searches. The logo is preferably not displayed to the members of the public. An example screen dump of a monitored search engine is shown in FIG. 60.
   Passing Keyword Searches from Looksmart to Pureprofile
A background search engine process should send the Account Holder ID and Keyword data to pureprofile on a real time basis. An SSL encrypted HTTP Post to a pureprofile page is the implemented technique.
Only pureprofile account holders who have opted-in to this solution are monitored.
   Use With Existing Databases

In an alternative embodiment, the storage and searching features of the present invention may be used with existing databases such as frequent flyer, user group or credit card databases. By storing the consumer-identifying information separately from the consumer-descriptive information contained in the existing database, businesses can search the database, send promotional information to consumers in the database which meet certain criteria without ever seeing the consumer-identifying information and receive reports of consumer responses. In this way the individuals in such existing databases can remain anonymous and the businesses can market their products to appropriate consumers in those databases.

In a preferred form, when businesses send out promotional information and receive responses from consumers, the consumer-descriptive information is updated with those responses, thereby adding to the criteria that businesses can use to target consumers.

Final Comments

With this anonymous and secure system 1, it is possible to capture and store consumer data in an environment which motivates consumers by providing compensation for responses to businesses selected by the consumer, without fear of having their identity disclosed and provided to businesses. This greatly improves the number and reliability of the consumer responses because consumers feel that it is safe and beneficial to respond because the anonymity and security of consumer responses is preserved and the consumer is compensated monetarily and receives more targeted, desirable information about products/services that that particular consumer is interested in. The consumers also feel another level of comfort and security since they own profile and can modify, update or delete their own profile at any time, while being assured that their personal information will not be revealed to any external party.

Also, businesses, marketing companies and advertisers are able to use the system 1 to freely obtain consumer data, identify target markets and create much more targeted and accurate business Requests for use in the real world and with the system 1. The system 1 also provides the businesses with opportunities to market and sell goods/services to the consumers who provided the anonymous, encrypted consumer information accessed by the businesses. Thus, businesses can easily obtain highly accurate information regarding target markets of consumers who have provided profiles of their demographics, sociographics, buying patters in return for payment of a fee to review and respond to Requests provided by businesses. The businesses are also prevented from circumventing the internet website secure information exchange with consumers and interfering with consumer privacy.

It also provides for economic freedoms in that the website owner/operator or the consumer can determine the costs to the business of the consumer responding to the Requests presented by the business.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for permission-based information exchange, the method comprising the steps of:
(a) receiving consumer information corresponding to a plurality of individual consumers via a consumer information receiver, the consumer information comprising both consumer-identifying information and consumer profile information for each consumer;
(b) storing the consumer-identifying information in consumer-identifying records in a consumer database;
(c) storing the consumer profile information in consumer profile records in the consumer database;
(d) receiving a profile information search request from a requestor via a search request receiver, wherein the search request specifies at least one consumer profile criterion;
(e) searching the consumer database to identify selected consumer profile records containing consumer profile information which match the consumer profile criterion in order to obtain a search result; and
(f) providing the search result to the requestor via a search result provider, wherein the search result does not include any consumer-identifying information.

2. The method of claim 1 wherein the selected consumer profile records each correspond to an individual selected consumer, and wherein the method further comprises the steps of:
(g) receiving promotional information from a promoter via a promotional information receiver; and
(h) providing the promotional information to the selected consumers via a promotional information provider;
wherein consumer-identifying information is not provided to the promoter.

3. The method of claim 2 further comprising the steps of:
(i) receiving consumer response information corresponding to the promotional information via a consumer response receiver in order to obtain a response result; and
(j) providing the response result to the promoter via a response result provider, and wherein the response result does not contain any consumer-identifying information.

4. The method of claim 2 wherein each promoter has a promoter financial account and wherein the step of receiving promotional information from the promoter further comprises debiting the promoter financial account by a promotion fee.

5. The method of claim 4 wherein the promotion fee comprises either monetary or non-monetary consideration.

6. The method of claim 3 wherein each consumer has a consumer financial account and wherein the step of receiving consumer response information corresponding to the promotional information further comprises the steps of:
(i) identifying a consumer financial account corresponding to a received consumer response;
(ii) crediting that consumer financial account with a consumer response fee; and
(iii) repeating steps (i) and (ii) for each received consumer response.

7. The method of claim 6 wherein each promoter has a promoter financial account and wherein the step of receiving consumer response information corresponding to the promotional information further comprises the steps of:
(iv) identifying a promoter financial account corresponding to the promotional information; and
(v) debiting the promoter financial account by a promotion response fee.

8. The method of claim 6 wherein the consumer response fee comprises one or both of monetary and non-monetary consideration.

9. The method of claim 6 further comprising the additional steps of:
(i) receiving a consumer-supplied redemption request for a value;
(ii) debiting the consumer financial account by the value; and
(iii) providing the value to a consumer-nominated destination.

10. The method of claim 9 wherein the consumer-nominated destination comprises one or more of:
(i) an SMS sending program;
(ii) a financial institution account;
(iii) a third-party goods/service provider;
(iv) a third-party goods/service voucher provider;
(v) a third-party cash provider;
(vi) an SMS sending program financial account;
(vii) a third-party goods/service provider financial account;
(viii) a third-party goods/service voucher provider financial account; or
(ix) a third-party cash provider financial account.

11. The method of claim 3 wherein one or more of the consumer information receiver, the promotional information provider and the consumer response receiver comprise one or more of:
(i) a consumer interface;
(ii) an email program;
(iii) a short message service (SMS) program;
(iv) an electronic data interchange (EDI) program;
(v) a wireless application protocol (WAP) program; or
(vi) other electronic information transmission means.

12. The method of claim 11 wherein the consumer information receiver is an EDI program taking the form of an application program which is adapted to receive third-party-supplied consumer profile information from third party application programs.

13. The method of claim 11 wherein the consumer interface performs the steps of:
(i) receiving consumer-identifying information from a consumer and storing that information in a consumer-identifying record; and
(iii) receiving consumer profile information from a consumer and storing that information in a consumer profile record.

14. The method of claim 13 wherein the consumer interface performs the step of receiving consumer-identifying information from a consumer by:
(a) displaying a consumer-identifying information questionnaire having a plurality of information receiving fields; and
(b) receiving the consumer-identifying information via the information receiving fields.

15. The method of claim 13 wherein the consumer interface performs the step of receiving the consumer profile information from a consumer by:
(a) displaying a first plurality of consumer profile questions each having a predetermined number of selectable answers; and
(b) receiving consumer-supplied selections of those selectable answers to form the consumer profile information.

16. The method of claim 15 wherein the consumer interface performs the further step of receiving updated consumer profile information from a consumer by:
(a) displaying a second plurality of consumer profile questions each having a predetermined number of selectable answers and wherein the second plurality of consumer profile questions differ from the first plurality of consumer profile questions; and
(b) receiving consumer-supplied selections of those selectable answers to form the updated consumer profile information.

17. The method of claim 15 wherein at least one of the first plurality of consumer profile questions has a relevance period and wherein the method comprises the additional step of seeking from a consumer replacement answers to those consumer profile questions for which the relevance period has expired.

18. The method of claim 1 wherein the consumer provides the consumer information either as an individual person or as a representative of a business.

19. The method of claim 18 wherein the consumer is a representative of a business and the consumer information is information relating to the identity, characteristics and preferences of the business.

20. The method of claim 1 wherein the consumer-identifying information comprises any information about an individual consumer whose identity is apparent, or can reasonably be ascertained, from the information or opinion.

21. The method of claim 20 wherein the consumer-identifying information comprises one or more of a consumer's:
(i) name;
(ii) address;
(iii) phone number;
(iv) fax number;
(v) email address;
(vi) workplace name;
(vii) date of birth; or
(viii) financial account information.

22. The method of claim 1 wherein the consumer profile information comprises any information relating to demographic, sociographic, lifestyle, financial, purchasing, returning and other characteristics or preferences of a consumer.

23. The method of claim 22 wherein the profile information comprises consumer-supplied profile information and third-party-supplied profile information.

24. The method of claim 23 wherein the consumer-supplied profile information comprises information relating to one or more of a consumer's
(a) gender;
(b) languages;
(c) purchasing habits;
(d) internet usage;
(e) telephone usage;
(f) accommodation type;
(g) shopping preferences;
(h) marital status;
(i) parental status;
(j) pet ownership status;
(k) vehicle ownership status;
(l) home ownership status;
(m) entertainment preferences;
(n) travel preferences;
(o) sports interests;
(p) investment; or
(q) employment status.

25. The method of claim 1 wherein the consumer profile information further comprises permission information and preference information.

26. The method of claim 25 wherein the permission information comprises information which defines one or more of:
(i) which items of consumer profile information a consumer is willing to make available to third parties;
(ii) consideration a consumer is willing to accept to make those items of consumer profile information available to third parties;
(iii) a frequency at which a consumer is willing to make those items of consumer profile information available to third parties; and
(iv) a period of time during which a consumer is willing to make those items of consumer profile information available to third parties.

27. The method of claim 26 wherein the preference information comprises information which defines one or more of:
(i) businesses or types of businesses the consumer is willing to receive promotional information from;
(ii) products, services or types of products or services the consumer is willing to receive promotional information about;
(iii) consideration a consumer is willing to accept to receive that promotional information;
(iv) consideration a consumer is willing to accept to respond to that promotional information;
(v) frequency at which a consumer is willing to receive that promotional information;
(vi) period of time during which a consumer is willing to receive that promotional information;
(vii) format in which a consumer is willing to receive that promotional information;
(viii) delivery channel by which a consumer is willing to receive that promotional information;
(ix) businesses or types of businesses the consumer is not willing to receive promotional information from; and
(x) products, services or types of products or services the consumer is not willing to receive promotional information about.

28. The method of claim 23 wherein the consumer-supplied profile information further comprises a relationship indicia.

29. The method of claim 28 wherein the relationship indicia comprises a relatively unique indicia which is associated with one or more of the following:
(i) a business;
(ii) a product;
(iii) a service;
(iv) a promotional campaign; and
(v) a consumer.

30. The method of claim 28 wherein the relationship indicia takes the form of a combination of a plurality of alphanumeric characters.

31. The method of claim 28 wherein the relationship indicia takes the form of a Pure Code as described herein.

32. The method of claim 28 wherein each relationship indicia is controlled by a particular business.

33. The method of claim 23 wherein the third-party-supplied profile information comprises information relating to one or more of a consumer's:
(a) credit score;
(b) credit card purchases;
(c) number of frequent flyer miles or redemptions;
(d) travel tickets purchased;
(e) web surfing activities;
(f) television watching habits;
(g) radio watching habits;
(h) newspaper reading habits;
(i) magazine watching habits;
(j) mobile phone usage;
(k) internet transactions;
(l) point of sale purchases;
(m) received and paid bills;
(n) retail point of sale (POS) transactions;
(o) loyalty card purchases;
(p) bank account information;
(q) share trading activities;
(r) superannuation fund information;
(s) mobile phone location;
(t) intelligence quotient (IQ) test results;
(u) personality test results;
(v) newsletters;
(w) resume information;
(x) internet purchasing behaviour; and
(y) keyword searches.

34. The method of claim 1 wherein the consumer database comprises either a single database or a plurality of databases.

35. The method of claim 34 wherein when the consumer database is a single database, the step of storing the consumer-identifying information in consumer-identifying records in the consumer database comprises storing the consumer-identifying information in a form which inhibits searching.

36. The method of claim 35 wherein the step of storing the consumer-identifying information in a form which inhibits searching comprises storing the consumer-identifying information in encrypted form.

37. The method of claim 34 wherein when the consumer database is a plurality of consumer databases the consumer databases are linked databases.

38. The method of claim 1 wherein each consumer-identifying record has a corresponding consumer profile record and wherein each corresponding pair of records stores a common consumer-identifying indicia which is unique to that consumer.

39. The method of claim 2 wherein one or more of the search request receiver, the search result provider, the promotional information receiver, and the response result information provider comprise one or more of:
(i) a business interface;
(ii) an email program;
(iii) a short message service (SMS) program;
(iv) an EDI program;
(v) a wireless application protocol (WAP) program; or
(vi) other electronic information transmission means.

40. The method of claim 39 wherein when the search request receiver comprises the business interface, the interface performs the step of receiving a profile information search request from a requestor by:
(a) displaying a plurality of selectable consumer profile criteria; and
(b) receiving requestor-supplied selections of those selectable criteria to form the profile information search request.

41. The method of claim 40 wherein at least some of the selectable consumer profile criteria correspond to the selectable answers to the consumer profile questions displayed by the consumer interface.

42. The method of claim 40 wherein the selectable consumer profile criteria corresponds to a relationship indicia controlled by the requestor.

43. The method of claim 1 wherein the search result comprises one or more of:
(i) the number of consumer profile records which matched the search request; and
(ii) the cost of sending promotional information to all of the consumers whose consumer profile records matched the search request.

44. The method of claim 2 wherein the promotional information comprises:
(i) displayable promotional information; and
(ii) at least one promotional question having at least one predetermined selectable promotional answer.

45. The method of claim 44 wherein the displayable promotional information comprises any one of:
(i) advertisement information;
(ii) business-supplied invoices;
(iii) business-supplied correspondence; and
(iv) any form of digitally displayable media.

46. The method of claim 45 wherein the advertisement information comprises one or more of:
(i) still images;
(ii) video clips;
(iii) audio grabs;
(iv) text; and
(v) numbers.

47. The method of claim 44 wherein the predetermined selectable promotional answers comprise the consumer response information corresponding to the promotional material.

48. The method of claim 39 wherein when the promotional information receiver comprises a business interface, the step of receiving promotional information from a promoter via the promotional information receiver comprises:
(i) displaying a promotional information receiving screen;
(ii) receiving promoter-supplied displayable promotional information;
(ii) receiving at least one promoter-supplied promotional question having at least one predetermined selectable promotional answer; and
(iv) storing the displayable promotional information and the at least one promotional question in a business database.

49. The method of claim 1 wherein the steps performed by the requestor are performed via a requestor representative.

50. The method of claim 2 wherein the steps performed by the promoter are performed via a promoter representative.

51. A system for permission-based communication and exchange of information comprising:
(a) a consumer information receiver adapted to:
(i) receive consumer information from a plurality of individual consumers, the consumer information comprising both consumer-identifying information and consumer profile information for each consumer; and
(ii) provide the consumer information to the consumer database;
(b) a consumer database adapted to:
(i) receive the consumer-identifying information from the consumer information receiver and store the consumer-identifying information in consumer-identifying records; and
(ii) receive the consumer profile information from the consumer information receiver and store the consumer profile information in consumer profile records; and
(c) a consumer database searcher adapted to:
(i) receive a profile information search request from a requestor via a search request receiver, wherein the search request specifies at least one consumer profile criterion;
(ii) search the consumer database to identify selected consumer profile records containing consumer profile information which match the search request in order to obtain a search result; and
(iii) provide the search result to the requestor via the search result provider, wherein the search result does not include any consumer-identifying information.

52. The system of claim 51 wherein the selected consumer profile records each correspond to an individual selected consumer, and wherein the system further comprises:
(d) a promotional information receiver adapted to receive promotional information from a promoter; and
(e) a promotional information provider adapted to provide the promotional information to the selected consumers;
wherein the promotional information provider is further adapted not to provide consumer-identifying information to the promoter.

53. The system of claim 51 further comprising:
(f) a consumer response receiver adapted to receive consumer response information corresponding to the promotional information and to generate a response result; and
(g) response result provider adapted to provide the response result to the promoter, wherein the response result does not contain any consumer-identifying information.

54. A method for conducting a transaction between an anonymous consumer and a business, the method comprising the steps of:
(a) receiving consumer information corresponding to a plurality of consumers via a consumer information receiver, the consumer information including consumer financial account information for at least one consumer;
(b) assigning a relatively unique consumer-identifying indicia to the consumer information;
(c) storing the consumer information and the consumer-identifying indicia in a consumer record in a consumer database;
(d) receiving a transaction request from a business via a transaction processor, the transaction request including a supplied consumer-identifying indicia;
(e) searching the consumer database to identify a selected consumer record storing a consumer-identifying indicia which matches the supplied consumer-identifying indicia;
(f) extracting consumer financial account information from the selected consumer record; and
(g) providing the consumer financial account information to the transaction processor whereupon the transaction processor performs the step of processing the transaction request, and wherein consumer-identifying information is not provided to the business.

55. A method for permission-based information exchange using a search interface, an interface monitor and a consumer database, the search interface comprising a search result display and a search field adapted to receive one or more keywords, the consumer database comprising a plurality of consumer profile records adapted to store consumer profile information and the method comprising the steps of:
(a) providing the search interface to a new consumer;
(b) receiving a new keyword from the new consumer via the search field;
(c) displaying one or more search results together with a selectable region on the search result display, the selectable region being adapted to be selected by the new consumer;
(d) detecting, using the interface monitor, a selection by the new consumer of the selectable region;
(e) creating, in response to the selection of the selectable region, a new consumer profile record in the consumer database, the new consumer profile record being adapted to store at least the new keyword; and
(f) storing the new keyword in the new consumer profile record.

56. The method of claim 55 wherein the new consumer profile record is further adapted to store consumer profile information, and the method includes the additional steps of:
(g) receiving consumer profile information about the new consumer via a consumer information receiver; and
(h) storing the new consumer profile information in the new consumer profile record in the consumer database.

57. The method of claim 55 wherein the consumer database further comprises a plurality of consumer-identifying records corresponding to the plurality of consumer profile records and wherein the method includes the additional steps of:
(i) creating, in the consumer database, a new consumer-identifying record corresponding to the new consumer profile record;
(j) receiving new consumer-identifying information about the new consumer via the consumer information receiver; and
(k) storing the new consumer-identifying information in the new consumer-identifying record in the consumer database.

58. The method of claim 57 wherein the new consumer-identifying information comprises one or more of the consumer's:
(i) mobile phone number; and
(ii) email address.

59. The method of claim 57 wherein the method further comprises the additional steps of:
(l) monitoring the search interface, using the interface monitor, in order to detect when the consumer enters a further keyword in the search field of the search interface;
(m) receiving the further keyword from the consumer via the search field; and
(n) storing the further keyword in the new consumer profile record.

60. The method of claim 55 wherein the search interface comprises an interface of a search engine adapted to search information stored in a plurality of networked computers.

61. The method of claim 55 wherein the selectable region displayed on the search result display has the new keyword superimposed thereon.

62. The method of claim 55 wherein the selectable region displays an invitation.

63. The method of claim 62 wherein the invitation is adapted to invite the new consumer to do one or more of the following:
(1) be paid to receive messages about at least one of the new keyword and the further keyword; and
(2) provide personal information about the new consumer to the consumer database.

64. The method of claim 55 wherein the new keyword comprises one or more keywords.

65. The method of claim 55 wherein the selectable region displayed on the search result display comprises one or more of:
(i) one or more still images;
(ii) one or more moving images;
(iii) text;
(iv) hyperlinks; and
(v) numbers.

66. The method of claim 59 further comprising the additional steps of:
(o) receiving a profile information search request from a requestor via a search request receiver, wherein the search request specifies at least one consumer profile criterion;
(p) searching the consumer profile records in the consumer database to identify selected consumer profile records containing consumer profile information which match the search request in order to obtain a search result; and
(q) providing the search result to the requestor via a search result provider, wherein the search result does not include any consumer-identifying information.

67. The method of claim 66 wherein the consumer profile criterion includes a keyword criterion.

68. The method of claim 66 wherein the selected consumer profile records each correspond to an individual selected consumer, and wherein the method further comprises the steps of:
(r) receiving promotional information from a promoter via a promotional information receiver; and
(s) providing the promotional information to the selected consumers via a promotional information provider;
wherein consumer-identifying information is not provided to the promoter.

69. The method of claim 68 further comprising the steps of:
(t) receiving consumer response information corresponding to the promotional information via a consumer response receiver in order to obtain a response result; and
(u) providing the response result to the promoter via a response result provider, wherein the response result does not contain any consumer-identifying information.

70. The method of claim 68 wherein each promoter has a promoter financial account and wherein the step of receiving promotional information from the promoter further comprises debiting the promoter financial account by a promotion fee.

71. The method of claim 70 wherein the promotion fee comprises either monetary or non-monetary consideration.

72. The method of claim 69 wherein each consumer has a consumer financial account and wherein the step of receiving consumer response information corresponding to the promotional material further comprises the steps of:
(i) identifying a consumer financial account corresponding to a received consumer response;
(ii) crediting that consumer financial account with a consumer response fee; and
(iii) repeating steps (i) and (ii) for each received consumer response.

73. The method of claim 72 further comprising the additional steps of:
(i) receiving a consumer-supplied redemption request for a value;
(ii) debiting the consumer financial account by the value; and
(iii) providing the value to a consumer-nominated destination.

74. The method of claim 73 wherein the consumer-nominated destination comprises one or more of:
(i) an SMS sending program;
(ii) a financial institution account;
(iii) a third-party goods/service provider;
(iv) a third-party goods/service voucher provider;
(v) a third-party cash provider;
(vi) an SMS sending program financial account;
(vii) a third-party goods/service provider financial account;
(viii) a third-party goods/service voucher provider financial account; or
(ix) a third-party cash provider financial account.

75. A system for permission-based communication and exchange of information comprising:
(i) a search interface;
(ii) a consumer profile database; and
(ii) an interface monitor;
wherein the search interface comprises a search field and a search result display and is adapted to:
(a) receive a new keyword from a new consumer via the search field; and
(b) display one or more search results together with a selectable region on the search result display, the selectable region being adapted to be selected by the consumer;
wherein the interface monitor is adapted to:
(a) detect a selection by the new consumer of the selectable region on the search result display;
(b) create a new consumer profile record in the consumer database in response to the selection of the selectable region, the new consumer profile record being adapted to store at least the keyword; and
(c) store the keyword in the new consumer profile record.

76. The system of claim 75 wherein the new consumer profile record is further adapted to store consumer profile information, and the system further comprises a consumer information receiver adapted to:
(a) receive consumer profile information about the new consumer; and
(b) store the new consumer profile information in the new consumer profile record in the consumer database.

77. The system of claim 75 wherein the consumer information receiver is further adapted to:
(c) create a new consumer-identifying record in the new consumer database corresponding to the new consumer profile record;
(d) receive consumer-identifying information about the new consumer; and
(d) store the new consumer-identifying information in the new consumer-identifying record in the consumer database.

78. The system of claim 75 wherein the interface monitor is further adapted to:
(a) monitor the search interface in order to detect when the new consumer enters a further keyword in the search field of the search interface;
(b) receive the further keyword from the new consumer via the search field; and
(c) store the keyword in the new consumer profile record.

79. The system of claim 75 wherein the search interface comprises an interface of a search engine adapted to search information stored in a plurality of networked computers.

80. The system of claim 75 wherein the selectable region displayed on the search result display has the new keyword superimposed thereon.

81. The system of claim 75 wherein the selectable region displays an invitation.

82. The system of claim 81 wherein the invitation is adapted to invite the consumer to do one or more of the following:
(1) be paid to receive messages about the new keyword; and
(2) provide personal information regarding the new consumer to the consumer database.

83. The system of claim 75 wherein the new keyword comprises one or more keywords.

84. The system of claim 75 wherein the selectable region displayed on the search result display comprises one or more of:
(i) one or more still images;
(ii) one or more moving images;
(iii) text;
(iv) hyperlinks; and
(v) numbers.

85. The system of claim 75 wherein the consumer database is adapted to store a plurality of corresponding pairs of consumer profile records and consumer-identifying records, and wherein the system further comprises a search request receiver and a search result provider, the search request receiver being adapted to:
(a) receive a profile information search request from a requestor, wherein the search request specifies at least one consumer profile criterion; and
(b) search the consumer profile records in the consumer database to identify selected consumer profile records containing consumer profile information which match the search request in order to obtain a search result,
and wherein the search result provider is adapted to provide the search result to the requestor,
wherein the search result does not include any consumer-identifying information.

86. The system of claim 75 wherein the consumer profile criterion includes a keyword criterion.

87. A method for permission-based information exchange using a search interface, an interface monitor and a consumer database, the search interface comprising a search field adapted to receive one or more keywords, the consumer database comprising an existing consumer profile record adapted to store consumer profile information about an existing consumer, and the method comprising the steps of:
(a) monitoring the search interface, using the interface monitor, in order to detect when the existing consumer enters a further keyword in the search field of the search interface;
(b) receiving the further keyword from the existing consumer via the search field; and
(c) storing the further keyword in the existing consumer profile record in the consumer database.

88. The method of claim 87 wherein the consumer database further comprises an existing consumer-identifying record corresponding to the existing consumer profile record.

89. The method of claim 87 wherein the search interface comprises an interface of a search engine adapted to search information stored in a plurality of networked computers.

90. The method of claim 87 wherein the further keyword comprises one or more keywords.

91. The method of claim 87 wherein the consumer database comprises a plurality of pairs of consumer-identifying records and consumer profile records, and the method further includes the additional steps of:
(d) receiving a profile information search request from a requestor via a search request receiver, wherein the search request specifies at least one consumer profile criterion;
(e) searching the consumer profile records in the consumer database to identify selected consumer profile records containing consumer profile information which match the search request in order to obtain a search result; and
(f) providing the search result to the requestor via a search result provider, wherein the search result does not include any consumer-identifying information.

92. The method of claim 91 wherein the consumer profile criterion includes a keyword criterion.

93. The method of claim 91 wherein at least one of the selected consumer profile records corresponds to an individual selected consumer, and wherein the method further comprises the steps of:
(g) receiving promotional information from a promoter via a promotional information receiver, and
(h) providing the promotional information to the selected consumer via a promotional information provider;
wherein consumer-identifying information about the selected consumer is not provided to the promoter.

94. The method of claim 91 further comprising the steps of:
(i) receiving consumer response information corresponding to the promotional information via a consumer response receiver in order to obtain a response result; and
(j) providing the response result to the promoter via a response result provider, wherein the response result does not contain any consumer-identifying information.

95. The method of claim 93 wherein each promoter has a promoter financial account and wherein the step of receiving promotional information from the promoter further comprises debiting the promoter financial account by a promotion fee.

96. The method of claim 95 wherein the promotion fee comprises either monetary or non-monetary consideration.

97. The method of claim 93 wherein each consumer has a consumer financial account and wherein the step of receiving consumer response information corresponding to the promotional material further comprises the steps of:
(k) identifying a consumer financial account corresponding to a received consumer response;
(l) crediting that consumer financial account with a consumer response fee; and
(m) repeating steps (k) and (l) for each received consumer response.

98. The method of claim 97 further comprising the additional steps of:
(i) receiving a consumer-supplied redemption request for a value;
(ii) debiting the consumer financial account by the value; and
(iii) providing the value to a consumer-nominated destination.

99. The method of claim 98 wherein the consumer-nominated destination comprises one or more of:
(i) an SMS sending program;
(ii) a financial institution account;
(iii) a third-party goods/service provider;
(iv) a third-party goods/service voucher provider;
(v) a third-party cash provider;
(vi) an SMS sending program financial account;
(vii) a third-party goods/service provider financial account;
(viii) a third-party goods/service voucher provider financial account; or
(ix) a third-party cash provider financial account.

100. A system for permission-based communication and exchange of information comprising:
(i) a consumer profile database comprising an existing consumer profile record adapted to store consumer profile information about an existing consumer;
(ii) a search interface comprising a search field; and
(iii) an interface monitor;
wherein the interface monitor is adapted to:
(a) monitor the search interface in order to detect when the existing consumer enters a further keyword in the search field of the search interface; and
(b) provide the further keyword to the consumer database,
and wherein the consumer database is adapted to:
(a) receive the further keyword from the interface monitor; and
(b) store the further keyword in the existing consumer profile record.

101. The system of claim 100 wherein the search interface comprises an interface of a search engine adapted to search information stored in a plurality of networked computers.

102. The system of claim 100 wherein the further keyword comprises one or more keywords.

103. The system of claim 100 wherein the consumer database is adapted to store a plurality of corresponding pairs of consumer profile records and consumer-identifying records, and wherein the system further comprises a search request receiver and a search result provider, the search request receiver being adapted to:
(a) receive a profile information search request from a requestor, wherein the search request specifies at least one consumer profile criterion; and
(b) search the consumer profile records in the consumer database to identify selected consumer profile records containing consumer profile information which match the consumer profile criterion in order to obtain a search result,
and wherein the search result provider is adapted to provide the search result to the requestor,
wherein the search result does not include any consumer-identifying information.

104. The system of claim 103 wherein the consumer profile criterion comprises a keyword criterion.

105. A method for permission-based information exchange using a consumer database and a promotional information database,
the consumer database storing both consumer-identifying information and consumer profile information about a plurality of consumers,
the promotional information database storing a plurality of sets of consumer profile criteria, each set having a corresponding item of promotional information, the criteria being indicative of the types of consumers to whom each item of promotional information should be sent,
the method comprising the steps of:
in the consumer database:
(a) receiving updated consumer profile information about a particular consumer, and
(b) storing the particular consumer's updated consumer profile information;
in the promotional information database:
(c) searching the sets of consumer profile criteria, and, if a particular set of consumer profile criteria matches the profile information of the particular consumer, then the method comprises the additional steps of:
(d) providing the item of promotional information corresponding to the particular consumer profile criteria to the particular consumer.

106. The method of claim 105 further comprising the steps of:
(i) receiving consumer response information corresponding to the item of promotional information via a consumer response receiver in order to obtain a response result; and
(j) providing the response result to the promoter via a response result provider, and wherein the response result does not contain any consumer-identifying information.

107. The method of claim 105 wherein each promoter has a promoter financial account and wherein the step of receiving consumer response information corresponding to the item of promotional information further comprises the steps of:
(i) identifying a promoter financial account corresponding to the promotional information; and
(ii) debiting the promoter financial account by a promotion response fee.

108. The method of claim 105 wherein each promoter has a promoter financial account and wherein the step of providing the item of promotional information corresponding to the particular consumer profile criteria to the particular consumer further comprises the steps of:
(i) identifying a promoter financial account corresponding to the item of promotional information; and
(ii) debiting the promoter financial account by a promotion fee.

109. The method of claim 105 wherein the updated consumer profile information comprises one or more of:
(i) a keyword entered by a consumer into a search engine;
(ii) an answer to a consumer profile question;
(iii) consumer response information corresponding to an item of promotional information; and
(iv) third-party-supplied profile information.

110. The method of claim 109 wherein the third-party-supplied profile information comprises information relating to one or more of a consumer's:
(a) credit score;
(b) credit card purchases;
(c) number of frequent flyer miles or redemptions;
(d) travel tickets purchased;
(e) web surfing activities;
(f) television watching habits;
(g) radio watching habits;
(h) newspaper reading habits;
(i) magazine watching habits;
(j) mobile phone usage;
(k) internet transactions;
(l) point of sale purchases;
(m) received and paid bills;
(n) retail point of sale (POS) transactions;
(o) loyalty card purchases;
(p) bank account information;
(q) share trading activities;
(r) superannuation fund information;
(s) mobile phone location;
(t) intelligence quotient (IQ) test results;
(u) personality test results;
(v) newsletters;
(w) resume information;
(x) internet purchasing behaviour; and
(y) keyword searches.

111. The method of claim 105 wherein the step of providing the item of promotional information corresponding to the particular consumer profile criteria to the particular consumer comprises providing the item of promotional information via one or more of:
(i) a digital consumer interface (computer);
(ii) an email program;
(iii) a short message service (SMS) program;
(iv) a multimedia message service (mms) system;
(v) world wide web;
(vi) postal mail;
(vii) digital/interactive television;
(viii) digital/interactive billboards;
(ix) public terminal kiosks;
(x) pay phones;
(xi) an electronic data interchange (EDI) program;
(xii) a wireless application protocol (WAP) program; or
(xiii) other information transmission means.

112. A method for permission-based information exchange, the method comprising the steps of:
(a) capturing consumer information corresponding to a plurality of individual consumers, the consumer information comprising both consumer-identifying information and consumer-descriptive information for each consumer;
(b) storing the consumer-identifying information in consumer-identifying records in a consumer database;
(c) storing the consumer-descriptive information in consumer description records in the consumer database;
(d) receiving a descriptive information search request from a requestor via a search request receiver, wherein the search request specifies at least one consumer description criterion;
(e) searching the consumer database to identify selected consumer description records containing consumer-descriptive information which match the consumer description criterion in order to obtain a search result; and
(f) providing the search result to the requestor via a search result provider, wherein the search result does not include any consumer-identifying information.

113. The method of claim 112 wherein the step of capturing consumer information comprises capturing the consumer information from an existing database.

114. The method of claim 112 wherein the selected consumer description records each correspond to an individual selected consumer, and wherein the method further comprises the steps of:
(g) receiving promotional information from a promoter via a promotional information receiver; and
(h) providing the promotional information to the selected consumers via a promotional information provider;
wherein consumer-identifying information is not provided to the promoter.

115. The method of claim 114 further comprising the steps of:
(i) receiving consumer response information corresponding to the promotional information via a consumer response receiver in order to obtain a response result; and
(j) providing the response result to the promoter via a response result provider, and wherein the response result does not contain any consumer-identifying information.

116. The method of claim 115 further comprising the step of updating the consumer-descriptive information in the consumer database with consumer response information received from individual consumers.
